(19) United States
(12) Patent Application Publication
(10) Pub. No.: US 2020/0294344 A1
(43) Pub. Date: Sep. 17, 2020

(54) ITEM DISPENSING ASSEMBLY SYSTEMS AND METHODS

(71) Applicant: APPLESTONE MEAT COMPANY LLC, Stone Ridge, NY (US)

(72) Inventors: Douglas R. Adams, Pepperell, MA (US); Nicholas E. Holsman, Waltham, MA (US)

(21) Appl. No.: 16/656,722

(22) Filed: Oct. 18, 2019

Related U.S. Application Data
(60) Provisional application No. 62/747,330, filed on Oct. 18, 2018.
(60) Provisional application No. 62/747,334, filed on Oct. 18, 2018.
(60) Provisional application No. 62/747,336, filed on Oct. 18, 2018.
(60) Provisional application No. 62/747,338, filed on Oct. 18, 2018.
(60) Provisional application No. 62/747,340, filed on Oct. 18, 2018.
(60) Provisional application No. 62/747,347, filed on Oct. 18, 2018.

(51) Int. Cl. G07F 11/00; B65G 11/02; G07F 9/00; G07F 9/10

(52) U.S. Cl. CPC G07F 11/00; G07F 9/105; G07F 9/002; B65G 11/023

(57) ABSTRACT

Apparatus and methods for vending an item. The apparatus may include an insulated enclosure. The insulated enclosure may include a first elongated member supporting a first coupling mechanism. The insulated enclosure may include a second elongated member, opposite the first elongated member, supporting a second coupling mechanism. The apparatus may include a storage frame positioned within the insulated enclosure. A top face of the storage frame may include a ridge. The ridge may be slidingly and removably coupled to the first coupling mechanism and the second coupling mechanism.

### CROSS REFERENCE TO RELATED APPLICATIONS

This application is a nonprovisional of U.S. Provisional Application No. 62/747,330, filed Oct. 18, 2018, and U.S. Provisional Application No. 62/747,334, filed Oct. 18, 2018, and U.S. Provisional Application No. 62/747,336, filed on Oct. 18, 2018, and U.S. Provisional Application No. 62/747,338, filed on Oct. 18, 2018, and U.S. Provisional Application No. 62/747,340, filed on Oct. 18, 2018, and U.S. Provisional Application No. 62/747,347, filed on Oct. 18, 2018, all of which are hereby incorporated herein by reference in their entireties.

### BACKGROUND

Vending machines typically perform unmanned retail sales operations. Performance of such a machine has typically been predicated on the conformance of vended products and packaging to a small number of product categories for which the machine is designed. For example, some machines vend only small individual snack bags. Some machines vend only individual canned beverages. Some machines vend individual candy bars. When machines vend different product categories, different vend mechanisms might be required to handle different form factors in the different categories, so a typical strategy is to include at most a small number of different vend mechanisms in the machine.

Typical vending machines do not vend items of different characteristics, cannot manage items having expiration dates, and are not reliable enough to provide prompt 24/7 service.

It would be desirable to provide apparatus and methods for a vending machine that dispenses items of various weights, sizes and prices.

It would be further desirable to provide apparatus and methods for a vending machine that stores the items in a temperature-controlled environment.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIG. 1 shows illustrative apparatus and methods in accordance with principles of the invention.

FIG. 2 shows illustrative apparatus in accordance with principles of the invention.

FIG. 3 shows illustrative apparatus in accordance with principles of the invention.

FIG. 4 shows illustrative apparatus and methods in accordance with principles of the invention.

FIG. 5 shows illustrative apparatus and methods in accordance with principles of the invention.

FIG. 6 shows illustrative apparatus and methods in accordance with principles of the invention.

FIG. 7 shows illustrative apparatus in accordance with principles of the invention.

FIG. 8 shows illustrative apparatus in accordance with principles of the invention.

FIG. 9 shows illustrative apparatus in accordance with principles of the invention.

FIG. 10 shows illustrative apparatus in accordance with principles of the invention.

FIG. 11 shows illustrative apparatus in accordance with principles of the invention.

FIG. 12 shows illustrative apparatus and methods in accordance with principles of the invention.

FIG. 13 shows illustrative apparatus in accordance with principles of the invention.

FIG. 14 shows illustrative apparatus in accordance with principles of the invention.

FIG. 15 shows illustrative apparatus in accordance with principles of the invention.

FIG. 16 shows illustrative apparatus in accordance with principles of the invention.

FIG. 17 shows illustrative apparatus in accordance with principles of the invention.

FIG. 18 shows illustrative apparatus in accordance with principles of the invention.

FIG. 19 shows illustrative apparatus in accordance with principles of the invention.

FIG. 20 shows illustrative apparatus in accordance with principles of the invention.

FIG. 21 shows illustrative apparatus in accordance with principles of the invention.

FIG. 22 shows illustrative apparatus in accordance with principles of the invention.

FIG. 23 shows illustrative apparatus in accordance with principles of the invention.

FIG. 24 shows illustrative apparatus in accordance with principles of the invention.

FIG. 25 shows illustrative apparatus in accordance with principles of the invention.

FIG. 26 shows illustrative apparatus in accordance with principles of the invention.

FIG. 27 shows illustrative apparatus in accordance with principles of the invention.

FIG. 28 shows illustrative apparatus in accordance with principles of the invention.

FIG. 29 shows illustrative apparatus in accordance with principles of the invention.

FIG. 30 shows illustrative apparatus in accordance with principles of the invention.

FIG. 31 shows illustrative apparatus in accordance with principles of the invention.

FIG. 32 shows illustrative apparatus and methods in accordance with principles of the invention.

FIG. 33 shows illustrative apparatus and methods in accordance with principles of the invention.

FIG. 34 shows illustrative apparatus and methods in accordance with principles of the invention.

FIG. 35 shows illustrative apparatus and methods in accordance with principles of the invention.

FIG. 36 shows illustrative apparatus and methods in accordance with principles of the invention.

FIG. 37 shows illustrative apparatus and methods in accordance with principles of the invention.

FIG. 38 shows illustrative apparatus in accordance with principles of the invention.

FIG. 39 shows illustrative apparatus in accordance with principles of the invention.

FIG. 40 shows illustrative apparatus in accordance with principles of the invention.

FIG. 41 shows illustrative apparatus in accordance with principles of the invention.

FIG. 42 shows illustrative apparatus in accordance with principles of the invention.

FIG. 43 shows illustrative apparatus in accordance with principles of the invention.

FIG. 44 shows illustrative apparatus in accordance with principles of the invention.

FIG. 44A shows illustrative apparatus in accordance with principles of the invention.

FIG. 44B shows illustrative apparatus in accordance with principles of the invention.

FIG. 45 shows illustrative apparatus and methods in accordance with principles of the invention.

FIG. 46 shows illustrative apparatus and methods in accordance with principles of the invention.

FIG. 47 shows illustrative apparatus and methods in accordance with principles of the invention.

FIG. 48 shows illustrative apparatus and methods in accordance with principles of the invention.

FIG. 49 shows illustrative apparatus and methods in accordance with principles of the invention.

FIG. 50 shows illustrative apparatus and methods in accordance with principles of the invention.

FIG. 51 shows illustrative apparatus in accordance with principles of the invention.

FIG. 52 shows illustrative apparatus and methods in accordance with principles of the invention.

FIG. 53 shows illustrative apparatus in accordance with principles of the invention.

FIG. 54 shows illustrative apparatus in accordance with principles of the invention.

FIG. 55 shows illustrative apparatus in accordance with principles of the invention.

FIG. 56 shows illustrative apparatus in accordance with principles of the invention.

FIG. 57 shows illustrative apparatus in accordance with principles of the invention.

FIG. 57A shows illustrative apparatus in accordance with principles of the invention.

FIG. 58 shows illustrative apparatus in accordance with principles of the invention.

FIG. 58A shows illustrative apparatus in accordance with principles of the invention.

FIG. 59 shows illustrative apparatus in accordance with principles of the invention.

FIG. 60 shows illustrative apparatus in accordance with principles of the invention.

FIG. 61 shows illustrative apparatus and methods in accordance with principles of the invention.

FIG. 62 shows illustrative apparatus and methods in accordance with principles of the invention.

FIG. 63 shows illustrative apparatus and methods in accordance with principles of the invention.

FIG. 64 shows illustrative apparatus and methods in accordance with principles of the invention.

FIG. 65 shows illustrative apparatus in accordance with principles of the invention.

FIG. 66 shows illustrative apparatus in accordance with principles of the invention.

FIG. 67 shows illustrative apparatus in accordance with principles of the invention.

FIG. 68 shows illustrative apparatus in accordance with principles of the invention.

FIG. 69 shows illustrative apparatus and methods in accordance with principles of the invention.

FIG. 70 shows illustrative apparatus and methods in accordance with principles of the invention.

FIG. 71 shows illustrative apparatus in accordance with principles of the invention.

FIG. 72 shows illustrative apparatus in accordance with principles of the invention.

FIG. 73 shows illustrative apparatus in accordance with principles of the invention.

FIG. 74 shows illustrative apparatus in accordance with principles of the invention.

FIG. 75 shows illustrative apparatus and methods in accordance with principles of the invention.

FIG. 76 shows illustrative apparatus that may be used in accordance with principles of the invention.

FIG. 77 shows illustrative apparatus that may be used in accordance with principles of the invention.

### DETAILED DESCRIPTION

Apparatus and methods for vending items may include a cloud-based inventory controller that tracks items, item carriers, vending machine stock, and customer interactions. The cloud-based controller may track items from production to distribution to vending at a vending assembly, to purchase by a user, and pick-up by the user from the vending assembly. The vending assembly may include a storage frame including platforms for storing items until vending. The storage frame may be easily installable in, and removable from, the vending assembly for installation and servicing. The storage frame may be enclosed in an insulated enclosure with temperature controlled fluid circulation and a roll-up cover that may provide access to an item that is to be dispensed, while covering other items that are not being dispensed. This may reduce an energy load required to maintain conditions in the insulated enclosure. Vend items may be held in item carriers that are configured to mechanically interact with the storage frame for storage and dispensing of the items. The items may therefore be items that do not require packaging designed to engage directly with the vending assembly, other than by being placed in a carrier.

The vending assembly may have separate entryways for loading items and for vending. Both of the entryways may be arranged in a front partition within the vending assembly to avoid the need to encumber real estate behind the assembly for loading.

The item carriers may be reused. Items in the vending assembly may be tracked by the inventory controller based solely on an item carrier ID after an initial registration of an item's characteristics to the carrier in which the item is to be loaded.

An item carrier may include a lock. The lock may be actuated wirelessly. The lock may be actuated mechanically. The vending assembly may activate the lock. The vending assembly may deactivate the lock. A user may deactivate the lock. The user may activate the lock. The user may actuate the lock from a user's mobile phone. The user may actuate the lock by direct wireless communication with the lock. The user may actuate the lock by wireless instruction to the vending assembly.

The storage frame may include a plurality of modular components. The storage frame may be constructed and deconstructed around a central segmented conduit that provides structural support to the storage frame and a passageway for circulation of environmental fluid. The central segmented conduit may include a plurality of conduits. The passageway may extend along a longitudinal axis of the storage frame. The passageway may be an empty space extending along the storage frame's longitudinal axis. The passageway may include two or more threaded rods extending through the passageway.

The inventory controller may provide to the vending assembly specific item data that is used for the wireless and mechanical identification, processing and vending of the items in the vending assembly.

Apparatus and methods for an item dispensing assembly are provided. The item dispensing assembly may be referred to alternately herein as a “vending assembly.” The vending assembly may include the storage frame positioned in a storage cabinet. The storage cabinet may be an insulated enclosure. The vending assembly may include an access cabinet. The vending assembly may include a housing defining the exterior of the vending assembly. A façade may be positioned on a face of the housing that faces a customer. The vending assembly may include a partition separating the storage cabinet from the access cabinet. The vending assembly may include an elevator, gripper, platform, rotation mechanism, and additional apparatus described herein to store, retrieve, and vend items in the vending assembly. The vending assembly may include a vending assembly computing unit.

The vending assembly computing unit may store locally data pertaining to items stored in the vending assembly. The vending assembly computing unit may be in electronic communication with a cloud-based inventory controller. The cloud-based inventory controller may transmit data to, and receive data from, the vending assembly computing unit.

Apparatus and methods for an item carrier are provided. The item carrier may include an inner shell and an outer shell.

The apparatus may include the inner shell. The inner shell may define an inner orifice. The inner orifice may be sized to receive an item. The item may be packaged meat. The item may be any suitable item. Exemplary items are listed at Table 5 below. The inner shell may define an inner orifice plane. The inner orifice plane may be defined by a perimeter of the inner shell.

The apparatus may include the outer shell. The outer shell may define an outer orifice. The outer orifice may be sized to receive the inner shell. The outer orifice may be defined by a perimeter of the outer shell. The outer shell may define an outer orifice plane. The outer orifice plane may be defined by a perimeter of the outer shell.

The inner shell may be configured to be nested within the outer shell. The inner shell may be configured to be nested within the outer shell such that the inner orifice plane is positioned substantially perpendicular to the outer orifice plane. For the purposes of the application, the term “substantially” may be understood to refer to +/−5% of a value. The inner shell may be configured to be nested within the outer shell such that the inner orifice plane is positioned perpendicular to the outer orifice plane. The inner shell may be configured to be nested within the outer shell such that the inner orifice plane is positioned oblique to the outer orifice plane.

The outer shell may include an outer extension. The outer extension may protrude from an exterior surface of the outer shell. The outer extension may include two or more outer extension segments. Each outer extension segment may be positioned on a different side of the outer shell. The outer shell may include six sides. The orifice may be positioned on one of the sides. Outer extension segments may extend along three sides of the outer shell. The three sides may, together, define a plane. The plane may bisect the outer shell across a width of the outer shell.

The outer extension may be configured to mate with a platform channel. For example, a channel in a platform may be wider than the extension of the outer shell. The extension of the outer shell may be configured to fit into the channel of the platform.

The outer shell may define an outer channel. The outer channel may support the outer extension. The outer channel may be accessible from an interior of the outer shell. The outer channel may be configured to receive an inner extension protruding from the inner shell. The outer shell may include a guide segment. The guide segment may be configured to direct the inner extension into the outer channel.

The guide segment may include a mouth. The mouth may be wider than the outer channel. The guide segment may include an exit. The exit may have a width that is the same as the width of the outer channel. The guide segment may include a tapered section. The tapered section provides a transitional section that bridges between the mouth and the exit. The mouth may also be wider than the inner extension.

The width of the mouth may provide a wider opening to receive the inner extension. After the inner extension is inserted into the mouth, the tapered section may guide the inner extension through the exit and into the outer channel. For example, during a vending process, the inner shell may be displaced relative to the outer shell. In some embodiment, the inner shell may be separated from the outer shell. Displacing or separating the inner shell may allow an item within the inner shell to be removed from the inner shell.

The item may be removed from the inner shell by gravity. For example, after the inner shell is displaced relative to the outer shell, gravity may cause the item to fall out of the inner shell via the inner orifice. In some embodiments, the item may be removed from the inner shell via the inner orifice by a human or robot.

After the item is removed from the inner shell, the inner shell may be nested within the outer shell. The guide segment may facilitate positioning the inner extension of the inner shell within the outer channel when nesting the inner shell within the outer shell. While the item is being removed, the outer shell may stay on the platform. Nesting the inner shell within the outer shell may include pushing the inner shell into the outer shell which is positioned on the platform. Nesting the inner shell within the outer shell may include positioning the inner shell back on the platform.

The outer channel may include a first length. The first length may extend along a first side of the outer shell. The outer channel may include a second length. The second length may extend along a second side of the outer shell. The first side may be perpendicular to the second side. The first side may be substantially perpendicular to the second side. The first side may be oblique to the second side.

The first side may be parallel to the second side. The first length may be configured to be inserted into a first platform channel. A platform channel may be referred to alternately herein as a “channel.” When the platform is circular, a platform channel may be angled radially inward toward a midpoint of the platform. A platform channel may extend along some or all of a radius of the platform. A platform may include a plurality of channels, all of the channels having the same length. A platform may include a plurality of channels, a first group of the channels having a first length and a second group of the channels having a second length different from the first length. A channel having the first length may be positioned between two channels having the second length. A channel having the second length may be positioned between two channels having the first length. Channels may be spaced radially apart from each other about the platform.

The second length may be configured to be inserted into a second platform channel. The first platform channel may be included in a first platform. The second platform channel may be included in a second platform. When the first and second lengths are positioned in the first and second platform channels, the outer shell may be held in a position between the first and second platforms.

The inner shell may include the inner extension. The inner extension may protrude from at least one side of the inner shell. The inner extension may be configured to mate with the outer channel. The inner extension may protrude from at least two sides of the inner shell.

The outer shell may include five walls. The inner shell may include five walls. When the inner shell is nested within the outer shell, a wall of the outer shell may cover the inner orifice. When the inner shell is nested within the outer shell, a wall of the inner shell may cover the outer orifice.

The outer shell may define a height, a length and a width. The outer orifice may be defined by the height and the width.

The outer shell may include an outer tapered section. The outer tapered section may include a mouth. The mouth of the tapered section may define a mouth plane that is parallel to the outer orifice plane. The mouth may be equal to the width of the outer shell. The tapered section may extend along a segment of the length. The tapered section may terminate at a segment of the outer channel. The segment of the outer channel may be configured to receive a segment of the inner channel.

The inner shell may include an inner tapered section. The inner tapered section may be configured to mate with the outer tapered section. The inner tapered section may be configured to mate with the outer tapered section when the inner shell is nested within the outer shell.

The outer shell may include a first wall and a second wall. The first and second walls may define a height of the outer shell. The first and second walls may each be configured to flex. When the first and second walls flex, the width of the outer shell may increase or decrease relative to the default width. Flexibility of the first and second walls may allow the item carrier to receive an item wider than the default width. Flexibility may enable the outer shell to receive the inner shell when the inner shell has a width that is larger than the outer shell's default width.

The outer shell may include a third wall and a fourth wall. The third and the fourth walls may, in a default orientation, be perpendicular to the first and second walls. When the first and second walls flex, the third and the fourth walls may be oblique to the first and second walls.

The third and fourth walls may be substantially perpendicular, or oblique, to the first and second walls, in a default orientation. The third and fourth walls may be slightly rounded in a default orientation. The first and second walls may be slightly rounded, in a default orientation. When the third and fourth walls are not perpendicular to the first and second walls, flexing of the first and second walls may increase a distance between the first and second walls, and the third and fourth walls.

The third and fourth walls may define a default width of the outer shell. The outer extension may protrude from the third wall. The outer extension may protrude from the fourth wall. Segments of the outer extension may protrude from the third and fourth walls. The outer shell may include a fifth wall. A segment of the outer extension may protrude from the fifth wall. The fifth wall may be perpendicular to the third and fourth walls. The fifth wall may be substantially perpendicular to, or oblique to, the third and fourth walls.

The first and second walls may include ribs. The ribs may be configured to provide stiffness to the first and second walls. The ribs may support the default (e.g., non-flexed) orientation of the first and second walls.

The inner shell may include a depression. The outer shell may include a protrusion. The protrusion may extend into an interior of the outer shell. The protrusion may be configured to be seated in the depression when the inner shell nested within the outer shell. In some embodiments, the inner shell may include the protrusion and the outer shell may include depression.

The inner shell may include a first wall and a second wall. The first and second walls of the inner shell may define a default width of the inner shell.

The inner shell may comprise a third wall. The third wall may have a width that is greater than a width of the outer shell. The third wall may have a length that is greater than a height of the outer shell. When the inner shell is nested within the outer shell, the third wall may be configured to be seated on a perimeter of the outer orifice. The inner shell may include an extension that protrudes from the third wall. The extension that protrudes from the third wall may be grasped, by a human or robot, to move the inner shell relative to the outer shell.

The first and second walls of the inner shell may each be configured to flex. When the first and second walls of the inner shell flex, the default width of inner shell may change. Flexibility of the inner shell may allow the inner shell to hold an irregularly shaped item. For example, packaged meat may be irregularly shaped. Flexibility of the inner shell may allow the inner shell to receive an item having a width that is larger than the inner shell's default width.

Flexibility of the outer shell may allow the inner shell to be nested within the outer shell when the inner shell contains an irregularly shaped item.

The inner shell may include a third wall. The third wall may be positioned perpendicular to the first and second walls of the inner shell. The third wall may be positioned oblique to the first and second walls of the inner shell. The inner extension may protrude from the third wall.

The first and second walls of the inner shell may include ribs. The ribs may be configured to extend into an interior of the inner shell. The ribs may be configured to space the first and second walls apart from an item contained within the inner shell. The ribs may prevent the item from adhering to the first and second walls of the inner shell. The ribs may allow the item to be fall out of the inner shell when the inner shell is displaced relative to the outer shell.

The inner shell may include a pair of channels. The pair of channels may be configured to receive a divider. When the divider is seated in the pair of channels, the divider may divide an interior of the inner shell into a first holding area and a second holding area. The first holding area may contain a first item. The second holding area may contain a second item.

The inner shell may be displaced a first distance relative to the outer shell. When the inner shell is displaced the first distance, the first item may be removed from the first holding area. When the inner shell is displaced the first distance, a part of the inner orifice corresponding to the second holding area may not be exposed. When the inner shell is displaced the first distance, the second item may be retained in the inner shell by a wall of the outer shell.

The inner shell may be displaced a second distance relative to the outer shell. When the inner shell is displaced the second distance, the part of the orifice corresponding to the second holding area may be exposed. When the inner shell is displaced the second distance, the second item contained in the second holding area may be removed.

The inner shell may include a first plurality of ventilation holes. The outer shell may include a second plurality of ventilation holes. When the inner shell is nested within the outer shell, the first plurality of ventilation holes and the second plurality of ventilation holes may allow air to circulate between an interior of the inner shell and an environment outside an exterior of the outer shell.

The inner shell may be constructed of plastic. The outer shell may be constructed of plastic. A radio frequency identification (“RFID”) tag may be mounted inside the inner shell. The RFID tag may be positioned on the third wall of the inner shell. The inner and outer shell may be constructed of a material that allows an RFID reader to read data on the RFID tag positioned within the inner shell.

The item carrier may be retained on the platform after dispensing.

During dispensing, the complete item carrier (including the inner shell and the outer shell) may be dispensed and provided to the customer.

Apparatus and methods for a storage frame is provided. The storage frame may hold one or more of the item carriers. The storage frame may include a first platform. The storage frame may include a second platform. The storage frame may include a conduit. The conduit may space the first platform apart from the second platform.

The storage frame may include two, three, four, five, six, seven, eight, nine, ten, or any other suitable number of platforms. A conduit may be positioned between each of the platforms.

The storage frame, when assembled, may be sized to fit through a 36-inch doorway. The storage frame may be sized to fit through any other doorway size, such as 32-inch, 34-inch, 38 inches, or 40 inches.

The storage frame may be brought to a vending location fully assembled. The storage frame may be assembled at the vending location. The remainder of the vending assembly may be assembled on-site at the vending location.

The storage frame may include any suitable number of platforms. Each platform may include any suitable number of channels. An exemplary storage frame may include 8 shelves and have 26 channels per shelf. A total machine capacity of such a storage frame may be 208 item carriers. If the larger-sized item carriers each include a partition, and a different item in each partition, the total machine capacity may be 312 items. These values are illustrative only. Any suitable number of platforms and channels may be included in the storage frame.

A platform on a storage frame may be circular. A platform on a storage frame may be square, rectangular, oval, or any other suitable shape. A first platform may have a shape and/or an outer circumference different from a shape and/or outer circumference of a second platform.

A platform may be formed from plastic, such as plastic sheet material that is machined, formed, molded or cast. A platform may be formed from stamped or formed metal. A platform may be formed from any other suitable material known to those skilled in the art.

The conduit may be hollow. The conduit may be tubular. The conduit may be cylindrical. The conduit may include a first end. The first end may define a first aperture. The first end may be configured to mate with the first platform. For example, the first platform may include a platform channel that is configured to receive the first end.

The conduit may include a second end. The second end may define a second aperture. The second end may be configured to mate with the second platform. For example, the second platform may include a platform channel that is configured to receive the second end.

The conduit may include a body. The conduit may be constructed from polyvinyl chloride (“PVC”). The conduit may be constructed from Schedule 40 PVC pipe or any other suitable pipe or tube. The conduit may be formed from any other plastic material, metal, or any other suitable material.

The body may extend between the first end and the second end. The conduit may be configured to space the first platform apart from the second platform by at least a height of an item carrier.

The conduit may space the first platform apart from the second platform such that when a first segment of an outer extension of an outer shell is positioned in the first channel, and a second segment of the outer extension is positioned in the second channel, the item carrier may be inserted or removed from a receptacle formed by the first and second channels. A receptacle may include only one channel. The first channel may extend along the first platform. The second channel may extend along the second platform. The conduit may space the first platform apart from the second platform such that when a first segment of an outer extension of an outer shell is positioned in the first channel, and a second segment of the outer extension is positioned in the second channel, the first and second platforms do not contact walls of the outer shell.

The body of the conduit may include a third aperture. The body of the conduit may include fourth, fifth and sixth apertures. The third, fourth, fifth and sixth apertures may be defined by a sidewall of the conduit. In some embodiments, the third, fourth, fifth and sixth apertures may be distributed proportionally along a circumference of the conduit.

Each of the third, fourth, fifth and sixth may be positioned between the first platform and the second platform when the conduit spaces the first platform apart from the second platform.

In some embodiments, the body of the conduit may also include a seventh aperture. In some embodiments, the body of the conduit may include only a third, only a third and fourth, or only a third, fourth and fifth aperture.

The conduit may be configured to carry fluid, such as air. One or more of the apertures in the conduit may allow the fluid to circulate between the first and second platforms. Apertures in the conduit may allow the fluid to circulate within a vending assembly.

The conduit may define a longitudinal axis. The body of the conduit may circumscribe an area about the longitudinal axis. The area may be empty. The area may include two, three, four or more of the threaded rods. The area may define a passageway. When the storage frame is assembled, the conduits, together, may define a passageway extending along a longitudinal axis of the storage frame. The longitudinal axis of the storage frame may be coaxial with the longitudinal axis of each of the conduits. The passageway extending along the storage frame's longitudinal axis may be empty. Air may be pulled up the passageway by a fan positioned above the storage frame.

The storage frame may include a dowel. The dowel may extend parallel to the body of the conduit. The dowel may be configured to support the spacing of the first platform apart from the second platform. A first end of the dowel may fit into a depression in the first platform. A second end of the dowel may fit into a depression in the second platform.

The dowel may include a threaded end. A platform may include a threaded depression. The threaded end of the dowel may be configured to threadedly engage the threaded depression. Threaded engagement of the dowel and depression may secure the dowel to the platform.

A storage frame may include a plurality of dowels. Each platform on the storage frame may support two, three, four, five, six, seven, or more dowels. A position of a first set of dowels on a first platform may be the same as a position of a second set of dowels on a second platform.

Each platform on the storage frame may have the same number of dowels. Each first dowel on a first platform may be above a second dowel on a second platform, the second platform being below the first platform, and below a third dowel on a third platform, the third platform being above the first platform. This may allow a group of dowels, each dowel in the group being on a different platform and vertically aligned with the dowels in the group along a height of the storage frame, to distribute weight supported by the storage frame down to a bottom of the storage cabinet on which the storage frame is positioned.

A platform may include two or more depressions, each depression being configured to receive a dowel. The depressions may be distributed such that the dowels, when positioned in the depressions, provide support to the spacing of the first platform apart from the second platform. The dowels/depression may be positioned closer to an outer perimeter of each platform than to a center of each platform. The dowels may support a load on the outer perimeter of the platform.

The first platform may include a first channel. The second platform may include a second channel. The first channel and the second channel may form a receptacle for receiving an item carrier. For example, the receptacle may be configured to receive extensions protruding from an outer shell of an item carrier.

The receptacle may be a first receptacle. The first platform may include a third channel. The second platform may include a fourth channel. The third channel and the fourth channel form a second receptacle. The second receptacle may have a length that is less than a length of the first receptacle. The first receptacle may be configured to receive an item carrier having a longer length than item carriers received by the first receptacle.

The storage frame may include a rubber stopper. A platform may include features for securing the rubber stoppers. The features may position the rubber stopper such that it extends into a channel. The rubber stopper may reduce a width of a channel. The rubber stopper may partially obstruct a channel. For example, the rubber stopper may extend into the second channel. The rubber stopper may be configured to compress when an extension, moving along the channel, passes the rubber stopper. The rubber stopper may be configured to create a friction fit that holds the extension in the channel. The friction fit may hold an item carrier in a receptacle. The friction fit may hold an item carrier that contains an item in a receptacle as the first and second platform rotate.

A platform may include features for positioning two or more rubber stoppers. A first rubber stopper may be positioned to secure an item carrier having a first length. A second rubber stopper may be positioned to secure an item carrier having a second length.

A channel may include a guide segment. The guide segment may be configured to direct an extension into the channel. The guide segment may include a mouth. The mouth may be wider than the channel. The guide segment may include an exit. The exit may be the same width as the channel. The guide segment may include a tapered section. The tapered section may transition between the mouth and the exit. The width of the mouth may provide a wider opening to receive an extension. After the extension is inserted into the mouth, the tapered section may guide the extension through the exit and into the channel.

The first platform may be circular. The second platform may be circular. For example, the first and second platforms may be disks.

The first platform may include a first central aperture. The central aperture may be positioned in a center of the first platform. The second platform may include a second central aperture. The second central aperture may be positioned in a center of the second platform. The first end of the conduit may mate with the first platform such that fluid carried by the conduit may flow through the first central aperture. The second end of the conduit may mate with the second platform such that fluid carried by the conduit may flow through the second central aperture.

The first platform may include a ridge. The first platform may be a top-most platform of the storage frame. The ridge may be positioned on a top face of the storage frame. The ridge may be positioned on a top face of the first platform.

The ridge may surround the first aperture. The ridge may have a circumference. The ridge may have a width. The storage frame may define a longitudinal axis. The storage frame may rotate about the longitudinal axis. The longitudinal axis may extend through a body of the conduit, through the first aperture in the first platform and through the second aperture in the second platform. The storage frame may be configured to rotate about the longitudinal axis.

The storage frame may include a first coupling mechanism. The first coupling mechanism may be a first wheel assembly. The first wheel assembly may be configured to contact the width of the ridge. The first wheel assembly may include two or more wheels. The storage frame may include a second coupling mechanism. The second coupling mechanism may include a second wheel assembly. The second wheel assembly may be spaced circumferentially apart, along the ridge, from the first wheel assembly. The second wheel assembly may include two or more wheels. Each of the wheels included in the second wheel assembly may be spaced circumferentially apart, along the ridge, from each other. The wheel assemblies may maintain a position of the ridge and the first platform relative to the longitudinal axis of the storage frame.

The wheel assemblies may maintain a position of the first platform, the conduit and the second platform during rotation about the longitudinal axis. The wheel assemblies may maintain a position of the first platform, the conduit and the second platform during rotation about the longitudinal axis without obstructing the flow of fluid through the conduit and first aperture of the first platform. The wheel assemblies may maintain a position of the storage frame during rotation of the storage frame about the longitudinal axis. The storage frame may include at least the first and second platform, and, optionally, additional platforms.

The storage frame may include a first set of bearings. The first set of bearing may include bearing surfaces. The first set bearings may interface between the conduit and the first platform. The storage frame may include a second set of bearings. The second set of bearings may interface between the conduit and the second platform. The first set of bearing may allow the first platform to rotate about the conduit. The first set of bearing may allow the first platform to rotate about the conduit independently of the second platform. The second set of bearing may allow the second platform to rotate about the conduit. The second set of bearing may allow the second platform to rotate about the conduit independently of the first platform.

For example, the first set of bearings may allow the first platform to be rotated in a first direction about the longitudinal axis of the storage frame. The second set of bearings may allow the second platform to be rotated in a second direction about the longitudinal axis. The first and second set of bearings may allow the first platform to be rotated in the first direction and simultaneously, allow the second platform to be rotated in the second direction.

A central aperture in the first platform may be aligned with the first aperture of the conduit. The first aperture of the conduit and the central aperture of the first platform may be aligned when the first end of the conduit is mated to the first platform. Alignment of the apertures of the first platform and the conduit may allow fluid to flow through the conduit to pass through the central aperture in the first platform.

The storage frame may include a plate. The plate may be configured to couple the second platform to a rotation mechanism. The rotation mechanism may rotate the storage frame about the longitudinal axis.

The storage frame may include a rod. The rod may extend through the second platform, through the conduit and through the first platform. The rod may extend through a passageway a passageway defined by the second platform, the conduit and the first platform. The rod may be secured to the plate. The rod may include a first rod end that is secured to the plate. The rod may include a second rod end that is secured to a bracket. The bracket may be ring-shaped. A second end of the conduit may mate with a first face of the second platform. The plate may be braced against a second face of the second platform.

The rod may be a first rod. The storage frame may include a second rod. The second rod may extend through the second platform, through the conduit and through the first platform. The second rod may extend through a passageway defined by the second platform, the conduit and the first platform. The storage frame may include a third rod. The third rod may extend through the second platform, through the conduit and through the first platform. The third rod may extend through a passageway defined by the second platform, the conduit and the first platform. The first, second and third rods may each be secured to the plate.

The storage frame may include a fourth rod. The fourth rod may extend through the second platform, through the conduit and through the first platform. The first, second, third and fourth rods may each be secured to the plate. The fourth rod may extend through a passageway defined by the second platform, the conduit and the first platform.

The first platform, the second platform and the conduit may form a frame segment. The storage frame may include a plurality of frame segments. The storage frame may have a bottom platform and a top-most platform. Each of the plurality of frame segments may be secured to each other by a rod that extends through each of the frame segments. The rod may be secured to the bottom platform. The rod may be secured to the top-most platform.

The storage frame may include a plurality of platforms and a plurality of conduits. Each conduit may be spaced between two platforms. Each platform-conduit-platform ‘frame segment’ may be assembled as detailed above.

For example, the rod may be secured to a ring-shaped bracket. The ring-shaped bracket may be braced by the top-most platform. Securing the rod to the bracket may apply compression to the frame segments. The rod may be secured to the bracket by tightening a nut. The nut may threadedly engage the rod and be braced by the bracket and the top-most platform. The compression may provide axial force and prevent slippage. The compression may maintain a shape of the storage frame.

The first platform may include an outer perimeter. The first platform may include a central aperture. The first end of the conduit may be configured to mate with the first platform such that the first aperture surrounds the central aperture.

The first platform may include a plurality of holes. The holes may extend through a thickness of the first platform. The plurality of holes may be distributed between the outer perimeter and the central aperture. The plurality of holes may allow a fluid, such as air, to pass through the thickness of the first platform.

The first platform may include a plurality of channels. The plurality of channels may be positioned between the outer perimeter and the central aperture. The first platform may include an outer perimeter. The first platform may include a central aperture. The first platform may include a first face. The first face may include a first plurality of channels. The first plurality of channels may extend between the outer perimeter and the central aperture.

The first platform may include a second face. The second face may include a second plurality of channels. The second plurality of channels may extend between the outer perimeter and the central aperture.

A rubber stopper may extend into a width of each of the first plurality of channels. The rubber stopper may partially obstruct each of the first plurality of channels. In some embodiments, none of the second plurality of channels may be obstructed by a rubber stopper. The first plurality of channels may be configured to receive a first segment of an outer extension of an outer shell. The second plurality of channels may be configured to receive a second segment of an outer extension of the outer shell.

Apparatus and methods for a storage frame is provided. The apparatus may include the storage frame. The storage frame may hold one or more item carriers in the vending assembly. The storage frame may include the first platform. The first platform may include a first central aperture. The storage frame may include a second platform. The second platform may include a second central aperture. The storage frame may include the conduit. The conduit may be a first conduit. The first conduit may space the first platform apart from the second platform

The first conduit may include a first conduit end. The first conduit end may be configured to mate with the first platform. The first conduit end may be configured to surround the first central aperture.

The first conduit may include a second conduit end. The second conduit end may be configured to mate with the second platform. The second conduit end may be configured to surround the second central aperture. The first conduit may include a body. The body may extend between the first conduit end and the second conduit end.

The first platform, the second platform and the first conduit may form a frame segment. The storage frame may include a plurality of frame segments. Each of the fame segments may be spaced apart from each other by a second conduit. The second conduit may include one or more features of the first conduit. The second conduit may be identical to the first conduit. For example, the second platform of a first frame segment, a second conduit and the first platform of a second frame segment form a third frame segment.

The storage frame may include a rod. The rod may be positioned within the first and second conduits. The rod may be positioned within the passageway defined by inner faces of the first and second conduits. Tensioning the rod may apply compression to frame segments of the frame assembly.

The rod may include a first rod end. The first rod end may be secured to a plate. The rod may include a second rod end. The second rod end may be secured to a bracket. The bracket may be ring-shaped. The plate may be braced by the second platform of a first frame segment. The bracket may be supported by the first platform of a second frame segment. The second rod end may be threaded. The bracket may be configured to support a nut that threadedly engages the second rod end. Tightening the nut may apply compression to the frame segments positioned between the plate and the bracket.

Apparatus and methods for a storage frame is provided. The apparatus may include the storage frame. The storage frame may hold one or more item carriers in the vending assembly. The storage frame may include a stack of platforms. The stack may define a longitudinal axis. The stack may include a top platform. The stack may include a bottom platform. The bottom platform may be supported by a base. The top and bottom platforms may each rotate about the longitudinal axis.

The top platform may include an aperture. The aperture may be traversed by the longitudinal axis of the stack. A passageway may extend along the longitudinal axis of the stack.

The aperture may be a central aperture of the top platform. The top platform may include a ridge. The ridge may support the top platform during rotation about the longitudinal axis. The ridge may support the top platform during rotation without obstructing the aperture.

The stack may include a plurality of conduits positioned between the top platform and the bottom platform. The stack may include a plurality of intermediary platforms. The intermediary platforms may be positioned between the top platform and the bottom platform. The storage frame may include a conduit between each intermediary platform.

The storage frame may include a rod. The rod may include a first end. The first end may be coupled to the bottom plate. The rod may include a second end. The second end may be secured to the top platform. Securing the second end to the top platform may apply compression to the conduits and the intermediary platforms positioned between the top platform and the bottom platform. The rod may be secured to the top platform using a bracket. A plate may secure the rod to the bottom platform.

Each intermediary platform may include a plurality of channels. The bottom platform may be coupled to a drive mechanism. The drive mechanism may rotate the stack about the longitudinal axis.

Apparatus and methods for a storage frame is provided. The apparatus may include the storage frame. The storage frame may hold one or more item carriers in a vending assembly. The storage frame may include the first platform. The first platform may include a first channel. The storage frame may include the second platform. The second platform may include a second channel. The second channel may be aligned with the first channel. An item carrier may include a first extension. The first extension may be configured to be positioned in the first channel. The item carrier may include a second extension. The second extension may be configured to be positioned in the second channel.

The storage frame may include the conduit. The conduit may space the first platform apart from the second platform. The conduit may space the first platform apart from the second platform such that walls of the item carrier are positioned between the first platform and the second platform when the first extension is positioned in the first channel and the second extension is positioned in the second channel. The conduit may space the first platform apart from the second platform such that an item contained within the item carrier is positioned between the first platform and the second platform when the first extension is positioned in the first channel and the second extension is positioned in the second channel.

Apparatus and methods for a storage frame is provided. The storage frame may include a first platform that includes a first channel. The storage frame may include a second platform that includes a second channel. Apparatus may include an item carrier positioned in the first and second channels and between the first and second platforms.

The apparatus and methods may include apparatus for vending an item. The vending assembly may include the apparatus for vending the item.

The apparatus may include the housing. The housing may be formed from metal, plastic, or any other suitable material. The housing may form the exterior of the vending assembly. A front of the housing viewable to a customer may include a façade. The façade may include a user interface, a card reader, a credit card processor, a bar code scanner, a delivery port, a vend port, a card reader, bag hooks, and any other features of the façade described herein.

The apparatus may include a storage cabinet. The storage cabinet may be insulated. When the storage cabinet is insulated, cooling or heating apparatus may be provided to maintaining the storage cabinet at a cold, frozen, warm, or hot temperature. When the storage cabinet is insulated, it may be referred to alternately herein as an “insulated enclosure.” Any feature described herein of the storage cabinet, when it is insulated and referred to as an insulated enclosure, may also be a feature of the storage cabinet when it is not insulated.

An exemplary insulated enclosure may have 3-4 cm of closed cell polyurethane (“PU”) foam. The foam may be formed in place between a wall of the insulated enclosure and a wall of the housing. The insulated enclosure may define an inner wall. The inner wall be formed from sheet polyvinyl chloride (“PVC”). The housing may define an outer wall. The foam may be between the inner and outer walls. Exemplary thermal conductivity of the PU foam may be 0.03 Watts/(meter*Kelvin), or any other suitable thermal conductivity.

The storage cabinet may have any suitable width, such as 35 inches, 33 inches, 37 inches, 39 inches, 41 inches, or any other suitable width.

A partition may extend between, and separate, the storage cabinet from an access cabinet.

The housing may include the storage cabinet. The housing may include an access cabinet. The housing may surround the storage cabinet. The housing may surround the access cabinet.

The apparatus may include the storage frame. The storage frame may be positioned in the insulated enclosure. The insulated enclosure may be shaped to provide clearance for rotation of the storage cabinet within the storage frame. Exemplary clearance may be 3 mm, 5 mm, 7 mm, 8 mm, 10 mm, or any other suitable clearance.

The insulated enclosure may include a first elongated member. The first elongated member may support a first coupling mechanism. The insulated enclosure may include a second elongated member. The second elongated member may be opposite the first elongated member. The second elongated member may support a second coupling mechanism.

The first elongated member may extend along a first side of the insulated enclosure. The second elongated member may extend along a second side of the insulated enclosure. The second side may be opposite the first side.

The apparatus may include the storage frame positioned within the insulated enclosure. A top face of the storage frame may include the ridge. The ridge may be circular. The ridge may extend around a top platform of the storage frame. The ridge may protrude above the top platform.

The ridge may be slidingly and removably coupled to the first coupling mechanism. The ridge may be slidingly and removably coupled to the second coupling mechanism. The first coupling mechanism may exert a radially inward force on the ridge. The second coupling mechanism may exert a radially inward force on the ridge. The radially inward forces may apply tension to the ridge so that it is in constant contact with the first and second coupling mechanisms.

The stabilizing may include providing radially outward force from the vending assembly against a ridge that runs along the outer perimeter. The first and second coupling mechanisms may be positioned within a space circumscribed by the ridge.

The ridge may be coupled to the first coupling mechanism only via the exerted force. The ridge may be coupled to the second coupling mechanism only via the exerted force.

The only direct point of contact between the top face of the storage frame and the insulated enclosure may be between the ridge and the first and second coupling mechanisms. Thus, the only stabilizing force exerted on the top portion of the storage frame may be the forces exerted on the ridge by the first and second coupling mechanisms. Other than the ridge, the top face of the storage frame may not be subject to any stabilizing forces.

The ridge may circumscribe a space. The space may be empty.

The first coupling mechanism may include a first wheel. The second coupling mechanism may include a second wheel. The ridge may be slidingly engaged with the first and second wheels. The wheels may be disposed diametrically opposite each other relative to a longitudinal axis of the storage frame.

The second coupling mechanism may include a third wheel. The ridge may be slidingly engaged with the third wheel. The first, second and third wheels may be spaced apart from one another along the ridge at about 120 degrees equal lengths of arc along the ridge.

The first coupling mechanism may include two or more wheels. The second coupling mechanism may include two or more wheels. The ridge may be slidingly engaged with the wheels included in the first and second coupling mechanisms.

To perform maintenance on the storage frame or a heating/cooling mechanism positioned in the plenum (described below), a rear wall of the housing may need be opened or removed. To remove the storage frame from the vending assembly, the first coupling mechanism must be decoupled from the insulated enclosure and removed. Then, a bottom platform of the storage frame may be de-coupled from the rotation mechanism. Once the bottom platform is de-coupled from the rotation mechanism, the storage frame can be slid out of the storage cabinet.

The apparatus may include the plenum. A top of the plenum may be coupled to a roof of the insulated enclosure.

A fan and a cooling mechanism positioned inside the plenum. A fan and a heating mechanism may be positioned in the plenum. The fan may be an axial fan. An air purifier may be positioned in the plenum. One or more temperature sensors may be positioned in the plenum.

Sensors may be positioned in the plenum to monitor fan current, such as magnitude amperage, refrigerant temperatures, and heat exchange/air temperature differences, such as inlet-outlet. Methods may include monitoring the data measured by the sensors in the plenum and modeling the data over time to identify trends. Such trends may identify characteristics necessary for proper equipment health and may assist in proactive failure/problem detection prior to hard failures. By monitoring a vending assembly's data to identify machine-specific trends, customized preventive maintenance may be superior to general best practices maintenance and/or waiting till equipment breaks.

The fan may be configured to pull air up from the passageway extending along the longitudinal axis of the storage frame. The passageway may be the hollow opening extending along the longitudinal axis of the storage frame. The fan may push air out from the plenum and between an outer radius of the frame and the enclosure toward a bottom of the enclosure. The fan may pull the air up from the passageway and then push the pulled-up air down toward the bottom of the enclosure.

A bottom of the plenum may define an opening. The bottom of the plenum may be positioned above, and spaced apart from, the top face of the storage frame. The opening may be positioned above the passageway.

The bottom of the plenum may not abut the top face of the storage frame.

The bottom of the plenum may be coupled to the storage frame. A bearing collar may couple the bottom of the plenum to the top face of the storage frame. The bearing collar may be fixed to the plenum. The bearing collar may be fixed to the storage frame. The opening in the bottom of the plenum may be positioned above the passageway. The bearing collar may allow for rotation of the storage frame when a position of the plenum is fixed.

The plenum may include a first opening. The first opening may be positioned on a first side of the plenum. The plenum may include a second opening. The second opening may be positioned opposite the first opening. The second opening may be positioned on a second side of the plenum. The first and second sides may extend between the top of the plenum and the bottom of the plenum. The fan may push air out from the first and second sides of the plenum and between an outer radius of the frame and the enclosure toward a bottom of the enclosure.

A bottom of the plenum may include a fixed conduit. The fixed conduit may be fixed to the bottom of the plenum. The fixed conduit may extend from the bottom of the plenum toward the top face of the storage frame. The fixed conduit may not abut the storage frame. The fixed conduit may be fixed in space and may not move.

A top face of the storage frame may include a rotating conduit. The rotating conduit may be fixed to top face of the storage frame. The rotating conduit may extend from the top face of the storage frame toward the plenum. The rotating conduit may not abut the plenum. In operation, the rotating conduit may rotate together with the storage frame.

A length of the first conduit may be positioned adjacent a length of the rotating conduit. Space between the first and second conduits may define a tortuous passageway. The tortuous passageway may be such that, for air outside the fixed and rotating conduits, a flow resistance along the tortuous pathway is greater than a flow resistance down towards a bottom of the insulated enclosure. The difference in flow resistance may be obtained when, in operation, the fan is pulling air up from the passageway and pushing the air through sides of the plenum.

The first conduit may be a first fixed conduit. The bottom of the plenum may include a second fixed conduit. The second fixed conduit may be fixed to the bottom of the plenum. The second fixed conduit may be positioned within the first fixed conduit. The second fixed conduit may extend from the bottom of the plenum towards the top of the storage frame. The second fixed conduit may not abut the storage frame. The rotating conduit may be positioned between the first fixed conduit and the second fixed conduit. Space between the first and second fixed conduits and the rotating conduit may define a tortuous passageway. The tortuous passageway may be such that, for air outside the fixed and rotating conduits, a flow resistance along the tortuous pathway is greater than a flow resistance down towards a bottom of the insulated enclosure. The difference in flow resistance may be obtained when, in operation, the fan is pulling air up from the passageway and pushing the air through sides of the plenum.

The apparatus may include bearing surfaces. The bearing surfaces may be positioned between the fixed conduit and the rotating conduit.

The bearing surfaces may be positioned between the rotating conduit and the second fixed conduit.

A space extending between the fixed conduit and the rotating conduit may be empty.

A space extending between the rotating conduit and the second fixed conduit may be empty.

The fixed conduit may be tubular. The rotating conduit may be tubular. The fixed conduit may be concentric with the rotating conduit.

The first and second fixed conduits may be tubular. The first and second fixed conduits may be concentric with the rotating conduit.

A thermal standoff area may extend between a roof of the housing and a top of the insulated enclosure. This area may be a substantially empty area transected by mounting blocks. The mounting blocks may extend between the top of the insulated enclosure and the roof of the housing. Each mounting block may be fixed to a metal bar that extends along, and is bolted to, a bottom face of the roof of the housing. Two or more mounting blocks may be fixed to one of the bars. Two or more bars may extend across the bottom face of the roof of the housing. Each mounting block may extend through the roof of the insulated enclosure. A top of the plenum may be coupled to the mounting blocks.

The apparatus may include a rotation mechanism. The rotation mechanism may be positioned underneath the insulated enclosure. The apparatus may include a plate to couple the storage frame to the rotation mechanism. Bolts may be driven through the bottom-most platform of the storage frame, through the plate coupled to the bottom-most platform, and into the rotation mechanism.

The housing may include the insulated enclosure. The housing may include a façade. The façade may include a customer interface and a vend depot for pick-up of a dispensed item. In operation, opening the façade may turn off the rotation mechanism.

The apparatus may include a partition. The partition may be positioned in the housing. The partition may separate the insulated enclosure from the access cabinet. The partition may define a first entryway and a second entryway.

A door may be coupled to the partition. When the door is in a closed state, the door may cover the first entryway. When the door is in a closed state, the door may reduce air flow between the insulated enclosure and the access cabinet. When the door is in a closed state, the door may seal the first entryway such that air cannot flow between the insulated enclosure and the access cabinet.

When the storage frame needs to be stocked with item carriers, a service person may open the façade. Opening the façade may automatically turn off a drive mechanism that drives the storage frame. After opening the façade, the service person may then open the door to access the item carriers.

The apparatus may include an item dispensing mechanism. The item dispensing mechanism may include an elevator and a gripper (detailed below). The item dispensing mechanism may be coupled to the partition. The item dispensing mechanism may be coupled to the partition adjacent the second entryway. The item dispensing mechanism may be configured to dispense an item from the storage frame. The item dispensing mechanism may include moving the item from the storage frame into the access cabinet. Dispensing of an item via the item dispensing mechanism is described in greater detail below. The dispensing may include the elevator, the gripper, a platform, and associated apparatus described herein.

The partition may define a partition first face and a partition second face. A thickness of the partition may extend between the partition first face and the partition second face.

The partition first face may be positioned in the access cabinet. The partition first face may include the door. Hinges of the door may be coupled to the partition first face. The partition first face may support the item dispensing mechanism. The item dispensing mechanism may be coupled to the partition first face.

The partition second face may be positioned in the insulated enclosure.

The storage frame may include the platforms. Each of the platforms may support one or more of the item carriers. Each of the platforms may support the item carriers.

The partition may include struts. Each strut may extend across a width of the second entryway. Each strut may be positioned adjacent an outer circumference of one of the platforms. The strut may be positioned adjacent the platform such that the strut restricts withdrawal of an outer shell of the item carrier, positioned adjacent the strut, from the platform. The strut may be positioned so that it is aligns with an outer extension of the outer shell of the item carrier. When an item carrier positioned on a platform is advanced away from the platform toward a strut, the outer extension of the outer shell may abut the platform. Abutment of the outer extension against the platform may disallow any additional movement of the outer shell away from the platform. The segment of the outer extension that abuts the platform may be positioned on a bottom of the outer shell.

The struts may be first struts. The partition may include second struts.

The second entryway may not include the first struts and the first entryway may include the second struts. The first entryway may include the second struts and the second entryway may include the first struts. Neither of the entryways may include struts.

The second struts may extend across a width of the first entryway. Each of the second struts may be positioned adjacent an outer circumference of one of the platforms. The second struts may each define an angled opening. The angled opening may provide clearance for an outer extension of an outer shell of an item carrier. The angled opening may extend across a width of a second strut. This clearance may permit withdrawal of an item carrier, including both the inner and outer shells, from the platform. The item carrier may be positioned on the platform adjacent the second strut.

The angled opening may be a first angled opening. The item carrier may be a first item carrier. Some of the second struts may define a second angled opening. The second angled opening may be positioned above the first angled opening. The second angled opening may provide clearance for an outer extension of an outer shell of a second item carrier. The second angled opening may extend across the width of the second strut.

The outer extension of the first item carrier may be positioned on a bottom of the outer shell. The outer extension of the second item carrier may be positioned on the top of the outer shell.

A second strut may include a first elongated member and a second elongated member. A second strut may include a third elongated member extending between a first side of the first elongated member and a second side of the second elongated member. A second strut may define a passageway extending between the first and second elongated members.

A block may be positioned in the passageway. The block may be inserted into the passageway. The block may be of monolithic construction with the first, second and third elongated members.

A temperature sensor and/or a through-beam sensor may be positioned on the block. The angled opening may be positioned on the block. When the angled opening is a first angled opening, the second angled opening may also be positioned on the block.

The block may include a printed circuit board (“PCB”). The PCB may be positioned on the block inside the insulated enclosure. The PCB may include a temperature sensor.

The through-beam sensor may be positioned at an end of the angled opening proximal to the platform. The through-beam sensor may detect removal of an item carrier from the platform and onto the second strut. The through-beam sensor may include a transmitter and a receiver spaced apart from the transmitter across the angled opening. A beam maintained between the transmitter and the receiver may be cut when an outer extension of an item carrier is advanced into the angled opening.

One or more of the second struts may include the PCB and/or the temperature sensor. One or more of the second struts may include the through-beam sensor. Some of the second struts may not include the PCB and/or the temperature sensor.

The apparatus may include an elevator. The item dispensing mechanism may include the elevator. The apparatus may include a roll-up panel. The roll-up panel may be formed from plastic, such as polyvinyl chloride (“PVC”), polyurethane (“PU”), polyethylene (“PE”) or any other suitable flexible, cleanable plastic or other material.

The roll-up panel may have a working end fixed at the elevator to the elevator. In operation, the roll-up panel may to seal the second entryway when the elevator is not in use. Sealing the second entryway may disallow air flow between the insulated enclosure and the access cabinet.

The partition may define a first U-shaped channel. The first U-shaped channel may extend along a first length of the second entryway. The partition may define a second U-shaped channel. The second U-shaped channel may extend along a second length of the second entryway. A first edge of the roll-up panel may extend along the first U-shaped channel. A second edge of the roll-up panel may extend along the second U-shaped channel.

The roll-up panel may include a vinyl material. The U-shaped channel may include an ultra-high molecular weight polymer. Edge of the panel may slot into the channel to form a tortuous or labyrinthine path to provide flow resistance between the panel and the channel.

The storage frame may include two or more of the platforms. Each platform may support the item carriers. The partition may include two or more status displays. The status displays may be positioned at intervals along a length of the first entryway. Each status display may be adjacent one of the platforms. Each status display may be associated with the adjacent one of the platforms in a database. One or two indexing buttons may be positioned adjacent each status display.

When the door is opened, each status display may be configured to display data identifying a status of one of the items carrier positioned on a platform adjacent the corresponding status display. Exemplary status data is listed in Table 7 below. The item carriers for which data is displayed on the status displays may be positioned on the platform such that they are removable from the storage frame through the first entryway.

The item carriers for which data is displayed may be the item carriers that are positioned for removal through the second struts. Only one item carrier at a time may be positioned for removal through a second strut.

The apparatus and methods may include apparatus for vending an item. The apparatus may include the housing. The housing may include the partition. The partition may be positioned in the housing. The partition may extend between the housing first side and the housing second side. The second side may be opposite the first side. The partition may separate the storage cabinet from the access cabinet. The partition may define the first entryway and the second entryway. The storage cabinet may be insulated.

The apparatus may include the storage frame. The storage frame may be positioned in the storage cabinet.

The apparatus may include the door. When the door is in a closed state, the door may cover the first entryway. When the door is in a closed state, the door may reduce air flow between the storage cabinet and the access cabinet. When the door is in a closed state, the door may seal the first entryway such that air cannot flow between the storage cabinet and the access cabinet. When the door is in a closed state, the door may not seal the first entryway.

The apparatus may include the item dispensing mechanism. The item dispensing mechanism may include the elevator, gripper, platform, and additional apparatus detailed herein. The item dispensing mechanism may be coupled to the partition. The item dispensing mechanism may be coupled to the partition adjacent the second entryway. The item dispensing mechanism may be configured to dispense an item from the storage frame. The dispensing may include moving the item from the storage frame into the access cabinet.

The partition may define the partition first face and the partition second face. The thickness of the partition may extend between the partition first face and the partition second face.

The partition first face may be positioned in the access cabinet. The partition first face may include the door. Hinges of the door may be coupled to the partition first face. The partition first face may include the item dispensing mechanism. The item dispensing mechanism may be coupled to the partition first face.

The partition second face may be positioned in the storage cabinet.

The apparatus may include the elevator. The item dispensing mechanism may include the elevator. The apparatus may include the roll-up panel. The roll-up panel may have a working end fixed at the elevator to the elevator. In operation, the roll-up panel may be configured to seal the second entryway when the elevator is not in use.

The storage frame may include the platforms. The partition may include the struts. Each strut may extend across a width of the second entryway

The partition may include the struts. Each strut may extend across a width of the second entryway. Each strut may be positioned adjacent an outer circumference of one of the platforms. The strut may be positioned adjacent the platform such that the strut restricts withdrawal of an outer shell of the item carrier, positioned adjacent the strut, from the platform. The strut may be positioned so that it is aligns with an outer extension of the outer shell of the item carrier. When an item carrier positioned on a platform is advanced away from the platform toward a strut, the outer extension of the outer shell may abut the platform. Abutment of the outer extension against the platform may disallow any additional movement of the outer shell away from the platform. The segment of the outer extension that abuts the platform may be positioned on a bottom of the outer shell.

The struts may be first struts. The partition may include second struts.

The second entryway may not include the first struts and the first entryway may include the second struts. The first entryway may include the second struts and the second entryway may include the first struts. Neither of the entryways may include struts.

The second struts may extend across a width of the first entryway. Each of the second struts may be positioned adjacent an outer circumference of one of the platforms. The second struts may each define an angled opening. The angled opening may provide clearance for an outer extension of an outer shell of an item carrier. The angled opening may extend across a width of a second strut. This clearance may permit withdrawal of an item carrier, including both the inner and outer shells, from the platform. The item carrier may be positioned on the platform adjacent the second strut.

The angled opening may be a first angled opening. The item carrier may be a first item carrier. Some of the second struts may define a second angled opening. The second angled opening may be positioned above the first angled opening. The second angled opening may provide clearance for an outer extension of an outer shell of a second item carrier. The second angled opening may extend across the width of the second strut.

The outer extension of the first item carrier may be positioned on a bottom of the outer shell. The outer extension of the second item carrier may be positioned on the top of the outer shell.

A second strut may include a first elongated member and a second elongated member. A second strut may include a third elongated member extending between a first side of the first elongated member and a second side of the second elongated member. A second strut may define a passageway extending between the first and second elongated members.

A block may be positioned in the passageway. The block may be inserted into the passageway. The block may be of monolithic construction with the first, second and third elongated members.

A temperature sensor and/or a through-beam sensor may be positioned on the block. The angled opening may be positioned on the block. When the angled opening is a first angled opening, the second angled opening may also be positioned on the block.

The block may include a printed circuit board (“PCB”). The PCB may be positioned on the block inside the insulated enclosure. The PCB may include a temperature sensor.

The through-beam sensor may be positioned at an end of the angled opening proximal to the platform. The through-beam sensor may detect removal of an item carrier from the platform and onto the second strut. The through-beam sensor may include a transmitter and a receiver spaced apart from the transmitter across the angled opening. A beam maintained between the transmitter and the receiver may be cut when an outer extension of an item carrier is advanced into the angled opening.

One or more of the second struts may include the PCB and/or the temperature sensor. One or more of the second struts may include the through-beam sensor. Some of the second struts may not include the PCB and/or the temperature sensor.

The partition may define a first U-shaped channel. The first U-shaped channel may extend along a first length of the second entryway. The partition may define a second U-shaped channel. The second U-shaped channel may extend along a second length of the second entryway. A first edge of the roll-up panel may extend along the first U-shaped channel. A second edge of the roll-up panel may extend along the second U-shaped channel.

The storage frame may include two or more of the platforms. Each platform may support the item carriers. The partition may include two or more status displays. The status displays may be positioned at intervals along a length of the first entryway. Each status display may be adjacent one of the platforms. Each status display may be associated with the adjacent one of the platforms in a database. One or two indexing buttons may be positioned adjacent each status display.

When the door is opened, each status display may be configured to display data identifying a status of one of the items carrier positioned on a platform adjacent the corresponding status display. Exemplary status data is listed in Table 7 below. The item carriers for which data is displayed on the status displays may be positioned on the platform such that they are removable from the storage frame through the first entryway.

The item carriers for which data is displayed may be the item carriers that are positioned for removal through the second struts. Only one item carrier at a time may be positioned for removal through a second strut.

The apparatus may include a plenum. A top of the plenum may be coupled to a roof of the storage cabinet. A fan and a cooling mechanism positioned inside the plenum. A fan and a heating mechanism may be positioned in the plenum. An air purifier may be positioned in the plenum. One or more temperature sensors may be positioned in the plenum.

The fan may be configured to pull air up from a passageway extending along a longitudinal axis of the storage frame. The passageway may be a hollow opening extending along the longitudinal axis of the storage frame. The fan may push air between an outer radius of the frame and the enclosure toward a bottom of the enclosure. The fan may pull the air up from the passageway and then push the pulled-up air down toward the bottom of the enclosure.

A bottom of the plenum may define an opening. The bottom of the plenum may be positioned above, and spaced apart from, the top face of the storage frame. The opening may be positioned above the passageway.

A bottom of the plenum may include a fixed conduit. The fixed conduit may be fixed to the bottom of the plenum. The fixed conduit may extend from the bottom of the plenum toward the top face of the storage frame. The fixed conduit may not abut the storage frame. The fixed conduit may be fixed in space and may not move.

A top face of the storage frame may include a rotating conduit. The rotating conduit may be fixed to top face of the storage frame. The rotating conduit may extend from the top face of the storage frame toward the plenum. The rotating conduit may not abut the plenum. In operation, the rotating conduit may rotate together with the storage frame.

A length of the first conduit may be positioned adjacent a length of the rotating conduit. Space between the first and second conduits may define a tortuous passageway. The tortuous passageway may be such that, for air outside the fixed and rotating conduits, a flow resistance along the tortuous pathway is greater than a flow resistance down towards a bottom of the insulated enclosure. The difference in flow resistance may be obtained when, in operation, the fan is pulling air up from the passageway and pushing the air through sides of the plenum.

The first conduit may be a first fixed conduit. The bottom of the plenum may include a second fixed conduit. The second fixed conduit may be fixed to the bottom of the plenum. The second fixed conduit may be positioned within the first fixed conduit. The second fixed conduit may extend from the bottom of the plenum towards the top of the storage frame. The second fixed conduit may not abut the storage frame. The rotating conduit may be positioned between the first fixed conduit and the second fixed conduit. Space between the first and second fixed conduits and the rotating conduit may define a tortuous passageway. The tortuous passageway may be such that, for air outside the fixed and rotating conduits, a flow resistance along the tortuous pathway is greater than a flow resistance down towards a bottom of the insulated enclosure. The difference in flow resistance may be obtained when, in operation, the fan is pulling air up from the passageway and pushing the air through sides of the plenum.

The apparatus may include bearings. The bearings may be positioned between the fixed conduit and the rotating conduit.

The bearings may be positioned between the rotating conduit and the second fixed conduit.

A space extending between the fixed conduit and the rotating conduit may be empty.

A space extending between the rotating conduit and the second fixed conduit may be empty.

The fixed conduit may be tubular. The rotating conduit may be tubular. The fixed conduit may be concentric with the rotating conduit.

The first and second fixed conduits may be tubular. The first and second fixed conduits may be concentric with the rotating conduit.

A thermal standoff area may extend between a roof of the housing and a top of the insulated enclosure. This area may be a substantially empty area transected by mounting blocks. The mounting blocks may extend between the top of the insulated enclosure and the roof of the housing. Each mounting block may be fixed to a metal bar that extends along, and is bolted to, a bottom face of the roof of the housing. Two or more mounting blocks may be fixed to one of the bars. Two or more bars may extend across the bottom face of the roof of the housing. Each mounting block may extend through the roof of the insulated enclosure. A top of the plenum may be coupled to the mounting blocks.

The bottom of the plenum may be coupled to the storage frame. A bearing collar may couple the bottom of the plenum to the top face of the storage frame. The bearing collar may be fixed to the plenum. The bearing collar may be fixed to the storage frame. The opening may be positioned above the passageway. The bearing collar may allow for rotation of the storage frame when a position of the plenum is fixed.

The plenum may include a first opening. The first opening may be positioned on a first side of the plenum. The plenum may include a second opening. The second opening may be opposite the first opening. The second opening may be positioned on a second side of the plenum. The first and second sides may extend between the top of the plenum and the bottom of the plenum. The fan may push air between an outer radius of the frame and the enclosure toward a bottom of the enclosure.

The apparatus may include a storage frame positioned within the insulated enclosure. A top face of the storage frame may include a ridge. The ridge may be circular. The ridge may extend around a top platform of the storage frame. The ridge may protrude above the top platform.

The storage cabinet may include the first elongated member. The first elongated member may support the first coupling mechanism. The storage cabinet may include the second elongated member. The second elongated member may support the second coupling mechanism. The second elongated member may be positioned opposite the first elongated member.

The first elongated member may extend along a first side of the storage cabinet. The second elongated member may extend along a second side of the storage cabinet. The second side may be opposite the first side.

The ridge may be slidingly and removably coupled to the first coupling mechanism. The ridge may be slidingly and removably coupled to the second coupling mechanism.

The ridge may be slidingly and removably coupled to the first coupling mechanism. The ridge may be slidingly and removably coupled to the second coupling mechanism. The first coupling mechanism may exert a radially inward force on the ridge. The second coupling mechanism may exert a radially inward force on the ridge. The ridge may be coupled to the first coupling mechanism only via the exerted force. The ridge may be coupled to the second coupling mechanism only via the exerted force.

The only direct point of contact between the top face of the storage frame and the insulated enclosure may be between the ridge and the first and second coupling mechanisms. Thus, the only stabilizing force exerted on the top portion of the storage frame may be the forces exerted on the ridge by the first and second coupling mechanisms. Other than the ridge, the top face of the storage frame may not be subject to any stabilizing forces.

The ridge may circumscribe a space. The space may be empty.

The first coupling mechanism may include a first wheel. The second coupling mechanism may include a second wheel. The ridge may be slidingly engaged with the first and second wheels. The wheels may be disposed diametrically opposite each other relative to a longitudinal axis of the storage frame.

The second coupling mechanism may include a third wheel. The ridge may be slidingly engaged with the third wheel. The first, second and third wheels may be spaced apart from one another along the ridge at about 120 degrees equal lengths of arc along the ridge.

The first coupling mechanism may include two or more wheels. The second coupling mechanism may include two or more wheels. The ridge may be slidingly engaged with the wheels included in the first and second coupling mechanisms.

The apparatus may include a rotation mechanism. The rotation mechanism may be positioned underneath the storage cabinet. The apparatus may include a plate to couple the storage frame to the rotation mechanism. The apparatus may include any other suitable item to couple the storage frame to the rotation mechanism.

The housing may include a façade. The façade may include a customer interface and a vend depot for pick-up of a dispensed item. In operation, opening the façade may turn off the rotation mechanism.

The apparatus and methods may include apparatus for dispensing an item. The apparatus may include an elevator. The elevator may be configured to vertically translate adjacent a storage frame. The apparatus may include an insulated enclosure. The insulated enclosure may be disposed about the storage frame. The insulated enclosure may include a roll-up panel. The roll-up panel may include a panel traveling end that travels with the elevator.

The panel traveling end may be fixed at the elevator to the elevator.

The apparatus may include tensioning rigging. The tensioning rigging may be configured to maintain tension in the roll-up panel between a roll of the panel and the panel traveling end as the elevator translates.

The apparatus may include a roller. The roller may be configured to turn the roll. The rigging may include a cable. The cable may have a cable traveling end that travels with the panel traveling end. The cable may have a cable fixed end that is fixed at the roller.

The apparatus may include a rigging direction controller. The controller may be vertically fixed relative to a base of the storage frame. The controller may be vertically fixed at a position below the base of the storage frame. The controller may include a pulley that is configured to redirect the rigging.

The roll may be led to the roller in a first rotational direction around the roller. The rigging may be led to the roller in a second rotational direction around the roller. The second direction may be opposite the first direction.

Rotation of the roller may pay out one of the roll-up panel and the rigging. The rotation may take up the other one of the roll-up panel and the rigging.

The tensioning rigging may include a spring disposed in series with the roll-up panel.

The roller may include a cylindrical spool for rolling the roll.

A sum of a first length, of the panel, and a second length, of the rigging, may define a working length. The first length may extend along the panel between the roll and the panel traveling end. The second length may extend along the rigging between the rigging traveling end and the tapered spool. When the elevator translates from a parked position below the bottom platform of the storage frame to a service position at a top platform of the storage frame, the working length may exhibit a stretch. The stretch may be a stretch that is no more than 5%. Table 1 lists illustrative maximum stretches.

```
TABLE 1
Illustrative maximum stretches.
Illustrative maximum stretches
  5%
  4%
  3%
  2%
  1%
0.5%
0.4%
0.3%
0.2%
0.1%
<0.1%
Other suitable illustrative
maximum stretches
```

When the elevator translates from a parked position below the bottom platform of the storage frame to a carrier station. of the storage frame, the rigging may exhibit a change in tensile stress. The change may be a change that is no more than 5%.

Table 2 lists illustrative maximum changes.

```
TABLE 2
Illustrative maximum changes.
Illustrative maximum changes
  5%
  4%
  3%
  2%
  1%
0.5%
0.4%
0.3%
0.2%
0.1%
<0.1%
Other suitable illustrative
maximum changes
```

The roller may include a tapered spool. The tapered spool may be configured to receive the rigging.

The roller may define a rolling axis. The tapered spool may define a taper. The taper may be coaxial with, and rotationally fixed to, the rolling axis.

As the roller rolls, the roll may change in diameter. As the roller rolls, an active diameter of the tapered spool may change to maintain the working length. As the roller rolls, the active diameter of the tapered spool may change to maintain the tensile stress.

The tapered spool may define a helical groove that moves the active diameter along the tapered spool as the roller turns.

The enclosure may include a vertical track along a translation path of the elevator. The enclosure may include a vertical track alongside the translation path. The vertical track may guide an edge of the roll-up panel as the elevator translates.

The vertical track may be a first vertical track. The edge may be a first edge. The enclosure may include a second vertical track along the translation path of the elevator. The second vertical track may guide a second edge of the roll-up panel as the elevator translates.

The enclosure may define a vertically elongated opening. The translation of the elevator may cause the panel to change the size of the opening.

The storage frame may include a vertical linear array of stocking stations defined between adjacent platforms. A stocking station may include a receptacle station. The elevator may be configured to move the panel traveling end to expose a selected stocking station while covering stocking stations between the roll and the selected stocking station.

The elevator may be configured to move the panel traveling end to cover all of the stocking stations.

The roll-up panel may be a first roll-up panel. The apparatus may include a second roll-up panel. The second roll-up panel may extend away from the elevator in a direction away from the first roll-up panel. When the elevator translates, the first roll-up panel may cover stocking stations in a first direction away from the elevator. When the elevator translates, the second roll-up panel may cover stocking stations in a second direction away from the elevator. While the elevator is translating, the first and second roll-up panels may define a gap. The gap may translate with the elevator. The gap may be sized to provide access to a stocking station for service by the elevator. The second direction may be opposite the first direction.

The apparatus and methods may include a method for vending an item. The method may include gripping an item carrier supported by a storage frame. An inner shell of the item carrier may be gripped. The method may include extending the item carrier to uncover an orifice on a bottom of the carrier. The method may include releasing the item through the orifice onto an elevator platform. The inner shell of the item carrier may be extended. The outer shell of the item carrier may remain on the platform.

The gripping may include clamping a jaw onto the item carrier. The jaw may include parallel bars that are actuated to come together. A motor may be configured to drive the jaws together to cover a span of 1, 2, 3, 4, 5, 6, 7, 8, 9, 10, 12, 20 or more mm linear motion. The span may correspond to a few degrees of angular motion of the motor rotor relative to the motor stator. The motor may be a stepper motor. The motor may be used in a fully energized state. Pole rotation at higher or maximum angular velocity may provide maximum holding torque. The motor holding torque may be sufficient to maintain a grip on the carrier. The jaw may clamp on to the inner shell of the item carrier. The jaws may have opposing recesses or tapers to receive a flange on the carrier shell and hold onto it while drawing the carrier shell away from the storage frame. Table 3 lists illustrative gripping mechanisms

TABLE 3
Illustrative gripping mechanisms.
Illustrative gripping mechanisms
Mechanical jaw
Magnetic attraction
Toggled electromagnetic attraction
Vacuum
Other suitable gripping mechanisms

The extending may include drawing the gripper away from the storage frame. The extending may include holding the item carrier with the storage frame.

The holding may include retaining a shell of the item carrier using the storage frame. The shell may be an outer shell.

The gripping may include seizing a shell of the item carrier. The shell may include an inner shell of the item carrier.

The method may include sensing a weight of the item on the platform.

The method may include, in response to the weight reaching a threshold weight, moving the gripper toward the platform to advance the inner shell toward the outer shell. The threshold weight may be a fraction of the item weight.

The method may include, after the releasing, contracting the item carrier. The contracting may include advancing the gripper toward the storage frame. The contracting may include advancing the inner shell into the outer shell, the outer shell being positioned on the platform.

The method may include, during vending, not removing the outer shell from the storage frame.

The contracting may include resisting the item carrier with the storage frame. The resisting may include detaining a shell of the item carrier using the storage frame. The resisting may include contacting the shell against an end of a channel defined by the storage frame. The resisting may include contacting the shell against an abutment disposed within a channel defined by the storage frame. The resisting may be applied to an outer shell.

The contracting may include covering an orifice. The orifice may be the orifice of the inner shell. The contracting may also include covering the orifice of the outer shell.

The method may include updating a status indicator on the storage frame in response to the releasing.

The method may include, in response to the weight reaching a threshold weight, positioning the platform adjacent a delivery port. The method may include moving the item off the platform through the port. The moving may include tilting the platform. The method may include directing the item down a chute. The chute may be integral to the delivery port. The chute may include a tortuous path such that the item can reach a vend depot adjacent a user access door, but a user cannot reach the top of the chute.

The apparatus and methods may include a method for vending an item. The method may include accepting in a storage frame an item carrier. The item carrier may have a wirelessly readable carrier data record. The carrier data record may be over-writable. The carrier data record may include information about the carrier. Table 4 lists illustrative information about the carrier.

TABLE 4
Illustrative information about the carrier.
Illustrative information about the carrier
Height
Width
Length
Volume
Number of bays
Unique carrier identification number
Number of dispense events
Other suitable information

The carrier may bear an item. Table 5 lists illustrative categories of items.

TABLE 5
Illustrative categories of items.
Illustrative attributes
Consumer goods
Perishable items
Pharmaceutical products
Medical devices
Medical device—pharmaceutical
combinations
Jewelry
Weapons
Currency
Electronics
Automobile keys
Residential, commercial rental property keys
Legal document pickup (deeds, titles, etc.)
Objects of art
Other suitable categories

The method may include obtaining wirelessly the carrier data record at a receiver supported by a vending assembly that includes the storage frame. The receiver may be positioned on the elevator. The method may include, after dispensing the item, reaccepting in the storage frame the item carrier. The receiver may be in electronic communication with the vending assembly computing unit. The item carrier may be reaccepted when the item carrier is removed from the storage frame, loaded with a new product, and then returned to the storage frame.

After carriers are loaded onto the storage frame, the receiver may scan the carrier to identify which carriers are present in the frame, and in which receptacles the carriers are present. The receiver may systematically scan all the carriers in the storage frame. The receiver may scan only the carriers that were accessed since a previous scan. In the scan, the receiver may be held at a given level on the storage frame while the storage frame rotates to expose all of the carriers on a platform to the receiver. The receiver may translate vertically through one or more of the levels which the storage frame is still. The computing unit may then index the storage frame angularly to a next set of receptacles for scanning of corresponding carriers by the receiver. After the scanning, the computing unit may transmit to the remote server an inventory of carriers, a partial inventory of carriers, or an updated inventory of carriers. The remote server may provide inventory information to the user. The computing unit may be a computing unit that is not configured to provide the inventory information or item data records directly to the user.

Wireless data may be transmitted using hardware and protocols of one or more technologies such as RFID, NFC, Bluetooth, Infrared, Wi-Fi, UHF, Zigbee or any other technology.

A service person may use a scanner to scan a wirelessly readable carrier data record. The data record may be a RFID tag or any other suitable data record described herein. The scanner may then display text such as ‘now load your product.’ The service person may then select an item and scan a wirelessly readable item data record. The data record may be a 1-D bar code, a 2-D barcode, or any other suitable data record. The service person may then place the item into the carrier. If the carrier has a partition, the scanner may then display text such as ‘now load a second product.’ If the carrier does not have a partition, the scanner may then display text such as ‘now select another carrier to load.’

The item may bear a wirelessly readable item data record. The data record may be a 2-dimensional bar code, a 3-dimensional bar code, or any other suitable data record. Table 6 lists illustrative elements that may be present in an item data record.

TABLE 6
Illustrative elements that may be present in an item data record.
Illustrative elements
Item type (e.g., hair brush, vaccine needle, raw meat)
Item price
Item weight
Item price per unit weight
Item length
Item price per unit length
Item size
Item diameter
Item volume
Item dosage
Item brand
Item date
Manufacture date
Shipped from factory date
Stocked on storage frame date
Expiration date
“Best if used by” date
Illustrative elements
Item country of origin
Item value (for pre-paid items)
Other suitable elements

The vending assembly may be a vending assembly that is not configured to read the item data record. The vending assembly may rely entirely on a server that is remote from the vending machine to provide data other than data in the item carrier data record. The server may be in “the Cloud.”

The item may be a first item. In the reaccepting, the item carrier may bear a second item; and the wirelessly readable carrier data record may be changed.

The method may include providing the carrier data record to a remote server. “Server” may include a one server, two servers, or any number of servers. The method may include receiving, in response to the providing, the item data record.

The method may include storing the data record in machine-readable memory supported by the assembly. The accepting may include receiving the carrier through the first entryway. The method may include changing a status display adjacent the first entryway in response to a change inside the item carrier. Table 7 lists illustrative statuses that may be communicated by the display. The illustrative statuses may be status data.

TABLE 7
Illustrative statuses.
Illustrative statuses
Empty
Replace item carrier
Salable stock
Replace stock now
Replace stock within n days (wherein n is a number)
Recalled
Remove for transfer to different vending assembly
Other suitable statuses

The change may correspond to placement of the first item in the item carrier. The change may correspond to removal of the first item in the item carrier. The change may correspond to a date of the first item. The change may correspond to surpassing of a limit by the date.

The dispensing may include dispensing the first item through the second entryway.

The method may include, between the accepting and the dispensing, shifting a receptacle of the frame from the first entryway to the second entryway.

The method may include receiving from the server the item data record of the item.

The method may include generating a signal, at the entryway, indicating performance of the accepting.

The method may include mapping the carrier data record to a location coordinate of the storage frame.

The method may include providing the carrier data record to a remote server. The method may include receiving, in response to the providing, the item data record.

The method may include logically merging the location coordinate and the item data record. “Logically merging” may include combining data into a combined record, adding data from one record to another record, establishing a link between the two records, or any other suitable logical merging.

The method may include storing the location coordinate and the item data record in machine-readable memory designated for the vending assembly.

The machine-readable memory may be local to the vending assembly. The machine-readable memory may be structurally attached at the vending assembly to the vending assembly.

The vending assembly may be one of a plurality of vending assemblies. The one vending assembly may store in memory a logical merging of the storage location and the item data record. Of the plurality of vending assemblies, the one vending assembly may be the only one that stores in local memory the merging of the storage location and the item data record.

The location coordinate may correspond to a height dimension of the frame. The location coordinate may correspond to an angular dimension of the frame.

The method may include updating a dispense counter in the item data record.

The method may include applying to the item the item data record. Table 8 lists illustrative technologies for applying the item data record to the item.

TABLE 8
Illustrative technologies.
Illustrative technologies
Barcode (sticker)
Barcode (print)
2D barcode (sticker)
2D barcode (print)
Near field communication (“NFC”) chip
Illustrative technologies
Radio Frequency Identification (“RFID”) circuit
Ultra-High Frequency communication
Other suitable technologies

The method may include logically merging the item data record with the carrier data record. The method may include transmitting, to the remote server from the vending assembly, a logical merging of the item data record and the carrier data record.

The method may omit recording the logical merging in machine-readable memory that is local to the vending assembly.

The method may include receiving, at the vending assembly, from the remote server, an instruction to dispense contents of the item carrier. The instruction may identify the item carrier. The instruction may be an instruction that does not identify the item. The instruction may be an instruction that does not include information that is present in the item data record of the item.

The method may include, based on the mapping, shifting the storage frame to align the item carrier with an item dispense station in the vending assembly. The method may include, based on the mapping, translating the elevator to align with the item carrier.

The method may include, based on one or more of the mapping, item weights and sensed mechanical parameters, shifting the storage frame and the elevator along paths that dispense one or more items in a desirable manner. The desirable manner may be an energy efficiency. The desirable manner may be an order fulfillment speed.

A processor onboard may use the mapping and item weights to calculate theoretical power requirements to angularly shift the storage frame to bring an item carrier to the elevator entryway. The processor onboard may use the mapping and item weights to calculate theoretical power requirements to vertically shift the elevator to the receptacle at which the item carrier is disposed. The processor onboard may be included in the vending assembly computing unit.

A processor onboard may use the mapping and item weights to calculate theoretical top speeds for angularly shifting the storage frame to bring an item carrier to the elevator entryway. The processor onboard may use the mapping and item weights to calculate theoretical top speeds to vertically shift the elevator to the receptacle at which the item carrier is disposed.

A sensor onboard the storage frame may sense electrical current required to angularly shift the storage frame to bring an item carrier to the elevator entryway. A sensor onboard the storage frame may sense electrical current required to vertically shift the elevator to the receptacle at which the item carrier is disposed.

A processor onboard the storage frame may select between a least cost path and a highest speed path. The selection may be made based on a time-between orders from users. When the time-between orders is low, demand may be high, so highest speed path may be selected to provide prompt customer service.

The desirable manners may be applied to a single order for one item. The processor may select a most efficient or a speediest delivery item location when more than one item satisfies the order and is in inventory. The desirable manners may be applied to an order for more than one item. The processor may select shifting paths is a most efficient or a speediest overall sequence between different locations of the items to fulfill the order. Paths to each item in the order may be selected similarly to when an order is placed for one item.

The apparatus and methods may include a method for vending an item. The methods may include ranking the item, relative to other items in a mapping of the storage frame, based on a dispense cost for the item. The dispense cost may be calculated based on an angular displacement from a current location of the item to dispensing entryway. The dispense cost may be calculated based on a distribution of item weights in the mapping, their moment, and angular speeds and accelerations associated with the paths. The dispense cost may be calculated based on a height displacement of the elevator from a current location of the elevator to the platform where the item is located.

The cost may be calculated as dispense time based on path length, frame velocity, and elevator velocity.

The method may include releasing the item from the container onto the elevator. The method may include sensing a weight of the item on the elevator. The method may include comparing the weight from the sensing to an item weight from the item data record. The weight may be received by the vending assembly computing unit from the remote data center. The weight may be stored at the vending assembly computing unit. The method may include, in response to the weight from the sensing reaching a threshold weight, moving the elevator to a dispense chute.

The threshold weight may be a fraction of the item weight. Table 9 lists illustrative fractions.

TABLE 9
Illustrative fractions
Illustrative fractions

0.1
0.15
0.2
0.25
0.3
0.35
0.4
0.45
0.5
0.55
0.6
0.65
0.7
0.75
0.8
0.85
0.9
0.95
0.96
0.97
0.98
0.99
1
Other
suitable
fractions

The accepting may include guiding an extension of the item container using a channel defined by the frame. The extension may be a first extension. The channel may be a first channel. The accepting may include guiding a second extension of the item container using a second channel defined by the frame.

The method may include pressing the extension against a wall of the channel to retain the item carrier in the receptacle.

The accepting may include providing in the channel a detent to prevent the item carrier from entering a length of the channel.

The shifting may include rotating the frame about a vertical axis of the frame. The shifting may include retaining in fixed position relative to the vertical axis the first entryway. The shifting may include retaining in fixed position relative to the vertical axis the second entryway.

The apparatus and methods may include a method for vending an item. The method may include receiving at the remote server, from an item deployment process, an item data record and a corresponding item carrier data record. The item deployment process may include a manufacturing process. The item deployment process may include an item distribution process. The item deployment process may include scanning the item data record and the carrier data record with a mobile scanner. The item deployment process may include wirelessly transmitting the records from the scanner to the server.

The method may include receiving at the remote server, from the vending assembly, the carrier data record. The method may include transmitting, from the server to the vending assembly, the item data record.

The item data record may include an item weight.

The method may include receiving at the server, from a user, an order for an item. The method may include identifying at the server a candidate item carrier at the vending assembly that corresponds to the order.

The method may include, when the candidate item carrier is a first candidate item carrier, identifying at the server a second candidate item carrier that corresponds to the order. Each of the first and second candidate item carriers may include a respective item data record including an item date. The method may include selecting at the server from the first and second candidate item carriers one having the earliest item date of the carriers. The method may include transmitting from the server to the vending assembly an instruction to dispense content from the carrier having the earliest item date.

The instruction may be an instruction that does not include information from the item data record.

The method may include transmitting from the server to the vending assembly an instruction to dispense content from the item carrier. The instruction may be an instruction that does not include information from the item data record.

The apparatus and methods may include a method for vending the item. The method may include stocking at least two items. Each of the items may have a different value of a sale term. The sale term may include an item weight. Table 10 lists illustrative sale terms.

TABLE 10
Illustrative sale terms.
Illustrative sale terms
Item type (e.g., hair brush, vaccine needle, raw meat)
Item price
Item weight
Item price per unit weight
Item length
Illustrative sale terms
Item price per unit length
Item size
Item diameter
Item dosage
Item brand
Item date
Manufacture date
Shipped from factory date
Stocked on storage frame date
Expiration date
“Best if used by” date
Item country of origin
Item volume
Item value (for pre-paid items)
Other suitable sale terms

The items may be stocked, in a storage frame defining a two-dimensional orthogonal array of receptacles, along a dimension of the array. The method may include receiving an electronic order for a selected item of the items. The method may include converging an elevator with a receptacle corresponding to the item.

The stocking may be a stocking that does not include a precondition requiring that a receptacle be reserved for an item having a predetermined sale term value, provided that the receptacle be sized to accommodate the item.

The stocking may be a stocking that does not include a precondition requiring that a receptacle be reserved for an item having a predetermined sale term value range, provided that the receptacle be sized to accommodate the item.

The dimension may be a first dimension. The method may include stocking at least two items, each having a different value of a sale term, in the storage frame, along a second dimension of the array.

A dimension of the dimensions may be a circumferential dimension. A dimension of the dimensions may be an axial dimension.

The method may include deriving a sale term from a product of other sale terms. The derived sale term may include a product of item volume and item price per unit volume. The derived sale term may include a product of item length and item price per unit length. The derived sale term may include a product of item strength and item price per unit strength.

The apparatus and methods may include a method for distributing a fluid to the item carriers lodged in the storage frame defining an axial direction and a radial direction. Table 11 lists illustrative fluids.

TABLE 11
Illustrative fluids.
Illustrative fluids
Air
Water
Nitrogen
Oxygen
Helium
Other suitable illustrative fluids

The method may include distributing the carriers outside of a conduit that circumscribes a vertical axis of the storage frame. The method may include flowing the fluid past the carriers and through the conduit. The fluid may flow through the passageway extending through the conduit along the longitudinal axis of the storage frame. The method may include adjusting a temperature of the fluid. The method may include returning the fluid to the carriers through a clearance space between the storage frame and an insulated enclosure enclosing the storage frame.

The flowing may include advecting the fluid in the axial direction through a tubular section of the conduit. The tubular section may extend along the passageway. The section may hold apart adjacent platforms between which item carriers are lodged. The advecting may be an advecting that does not include passing the fluid between an interior wall of the sections and an exterior surface of an axially disposed spindle around which the storage frame rotates.

The advecting may include passing the fluid between an interior wall of the sections and an exterior surface of an axially disposed spindle around with the storage frame rotates.

The section may be of a plurality of tubular sections of the conduit. Each section of the plurality may hold apart adjacent platforms between which carriers are lodged. The flowing may include advecting the fluid in the axial direction through all sections of the plurality. The advecting may be an advecting that does not include passing the fluid between an interior wall of the sections and an exterior surface of an axially disposed spindle around which the storage frame rotates. The advecting may include passing the fluid between an interior wall of the sections and an exterior surface of an axially disposed spindle around which the storage frame rotates.

Table 12 lists illustrative numbers of sections in the plurality.

TABLE 12
Illustrative numbers of sections in the plurality.
Illustrative numbers

2
3
4
5
6
7
8
9
10
11
12
13
14
15
16
17
18
19
20
21
22
23
24
>24
Other
suitable
numbers

The flowing may include passing the fluid through an aperture in a wall of the section.

The method may include regulating a rate of flow through the aperture by reducing a size of the aperture. The reducing may include shifting a tube that is concentric with the section and includes a fluid flow region and a fluid obstruction region corresponding to the aperture. The tube may function as a static damper. The fluid obstruction region may reduce a cross-sectional area of the aperture that is available to conduct the fluid.

The shift may include a rotational shift about the vertical axis. The tube may be internal the section. The tube may be external the section.

The method may include, using the tube, setting for each of the sections an area available to conduct fluid through an aperture in the section.

The setting may include establishing a sequence of the areas that increases from a first of the sections to a second of the sections. The setting may include establishing a sequence of the areas that increases monotonically from a first of the sections to a second of the sections. The first section may be a bottommost section of the plurality. The second section may be a topmost section of the plurality. The first section may be a topmost section of the plurality. The second section may be a bottommost section of the plurality.

The method may include rotating the conduit about the vertical axis. The rotating may turn the storage frame about the axis. The method may include, circulating the fluid with the item containers lodged in the frame by rotating the frame.

The method may include driving rotation of the storage frame adjacent a first vertical end of the storage frame. The method may include stabilizing the storage frame, at an outer perimeter of a vertically opposite end of the storage frame, against wobbling about the axis during the rotation. The stabilizing may include contacting a ridge positioned on top face of the storage frame against the first coupling mechanism and the second coupling mechanism.

The stabilizing may include providing radially inward force from the vending assembly against a ridge that runs along the outer perimeter.

The returning may include flowing the fluid from an end of the conduit and past the ridge.

The method may include flowing the fluid through a chiller. The chiller may include an evaporative coil. The method may include flowing the fluid through a heater. The method may include flowing the fluid through a dehumidifier. The method may include irradiating the fluid. The irradiating may be performed with an antibacterial wavelength of light. The fluid may flow through the plenum. The treatment of the fluid may occur within the plenum.

Illustrative embodiments of apparatus and methods in accordance with the principles of the invention will now be described with reference to the accompanying drawings, which form a part hereof. It is to be understood that other embodiments maybe utilized and that structural, functional and procedural modifications or omissions may be made without departing from the scope and spirit of the present invention.

Some embodiments may omit features shown and/or described in connection with the illustrative apparatus. Some embodiments may include features that are neither shown nor described in connection with the illustrative apparatus. Features of illustrative apparatus may be combined. For example, one illustrative embodiment may include features shown in connection with another illustrative embodiment.

Embodiments may involve some or all of the features of the illustrative apparatus and/or some or all of the steps of the illustrative methods.

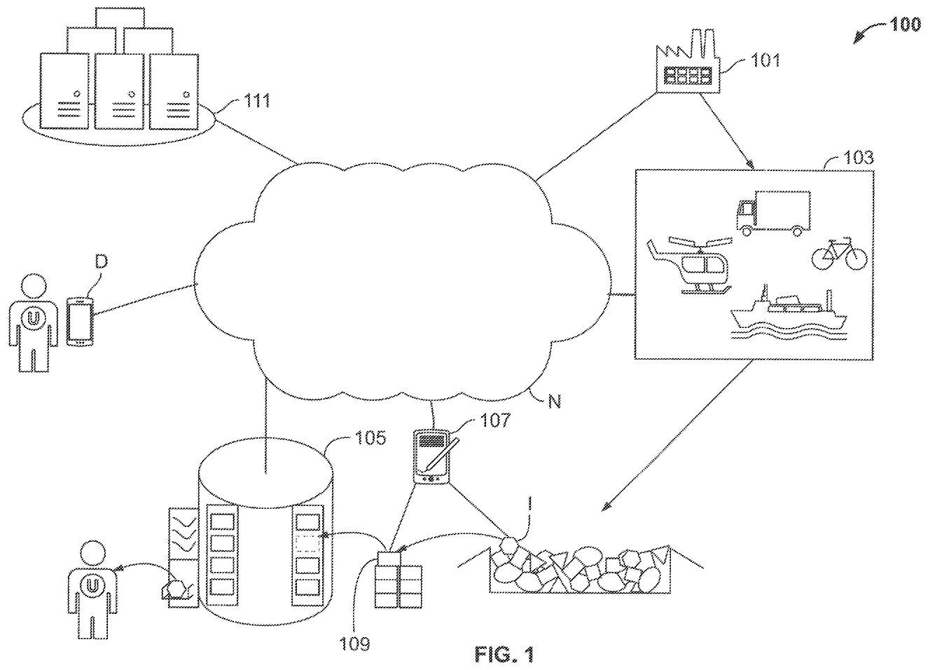

FIG. 1 shows illustrative arrangement 100 for vending an item such as item T to a user such as user U. Arrangement 100 may include plant 101, distribution channel 103, data record scanner 107, item carrier 109, vending assembly 105 and remote data center 111. In FIG. 1, arrows indicate illustrative material transfer channels, and line segments indicate illustrative information transfer channels.

Vending assembly 105 may include the vending assembly computing unit. The vending assembly computing unit may include a processor with memory. The computing unit may store item carrier data, mapping data, temperature data read by the temperature probes, and any other data described herein as being generated locally within the vending assembly. The vending assembly computing unit may provide functionality to the kiosk customer interface positioned on the façade of the housing.

Plant 101, distribution channel 103, data record scanner 107, vending assembly 105, remote data center 111 and user U may be in communication with communication network N. Network N may include any wide area network, local area network, cell telephone network, radio frequency network, optical network or any other suitable wired or wireless network.

Plant 101 may include one or more plants. The plants may be collocated or distributed geographically. The plants may manufacture or prepare item I for distribution. Distribution channel 103 may include any suitable form of transportation. Distribution channel 103 may transport item Ito vending assembly 105. Vending assembly 105 may be a vending assembly included in a plurality of vending assemblies. Some of the vending assemblies may be collocated. Some of the vending assemblies may be geographically distributed. Data record scanner 107 may read an item data record from item I and a carrier data record from an item carrier such as item carrier 109, and transmit them to data center 111. Item I may be placed in item carrier 109. Item carrier 109 may then be loaded into vending assembly 105.

User U may query inventory of the vending assemblies. User U may reserve, with data center 111, item I in any one of the plurality of vending assemblies, for later pickup. User U may place an order with data center 111 for item I. User U may place the order via user U's communication device D. User U may place the order via a user interface at vending assembly 105. If communication between vending assembly 105 and network N is unavailable, user U may place the order at vending assembly 105 with vending assembly 105.

Data center 107 may include one or more servers. The servers may be collocated or distributed geographically.

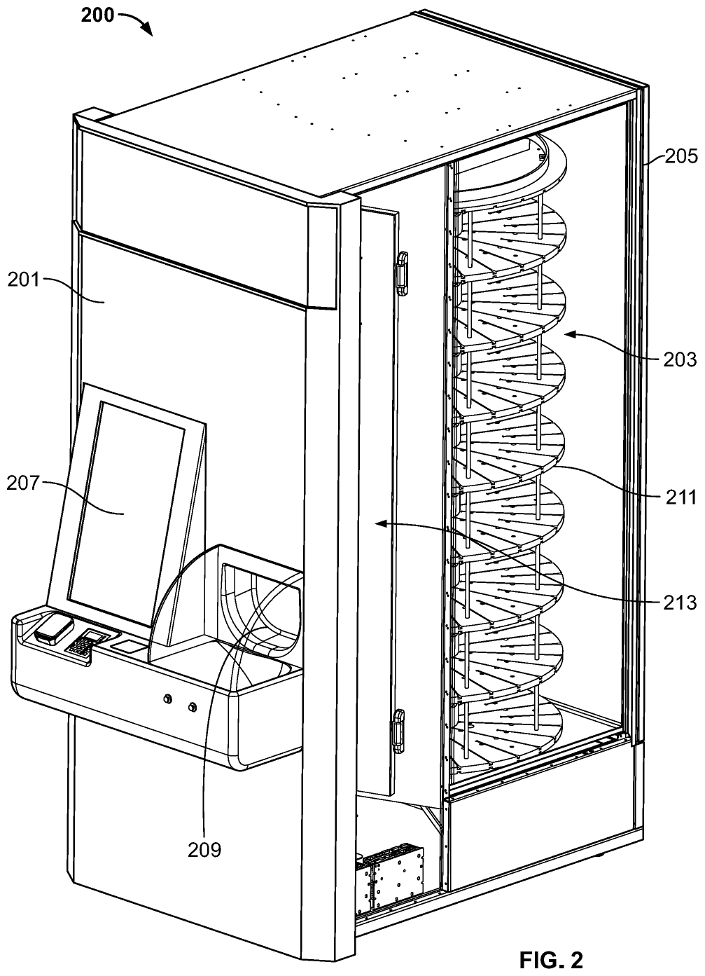

FIG. 2 shows apparatus for vending an item. The apparatus may include vending assembly 200. The apparatus may include housing 205. Housing 205 may define the exterior of the apparatus. Storage cabinet 211 and access cabinet 213 may be positioned inside housing 205. Housing 205 may surround storage cabinet 211 and access cabinet 213.

Storage cabinet 211 may be temperature controlled. Air inside storage cabinet 211, when it is temperature controlled, may be cool, frozen, warm, or hot. When storage cabinet 211 is temperature controlled, storage cabinet 211 may be referred to alternately herein as an ‘insulated enclosure.’ Storage cabinet 211 may not be temperature controlled.

Storage frame 203 may be positioned in storage cabinet 211. Storage frame 203 may store item carriers. Each item carrier may store one or more items.

Housing 205 may include façade 201. Façade 201 may couple to housing 205 to form part of housing 205. Façade 201 may include branding that identifies a company whose items are stored in the housing.

The façade may include customer interface 207. Customer interface 207 may interface with a customer and/or a customer's mobile device. Customer interface may be in communication with remote data center 111 via communication network N. The façade may include vend depot 209. Vend depot 209 may receive an item dispensed from an item carrier stored in storage frame 203. The dispensing of item I from an item carrier may include removing item I from within storage cabinet 203, passing item I through access cabinet 213, and dispensing item I into vend depot 209. A customer may retrieve item I by lifting a door positioned on vend depot 209. When item I is dispensed to the customer, the item carrier supporting item I in the storage frame may remain in the vending assembly.

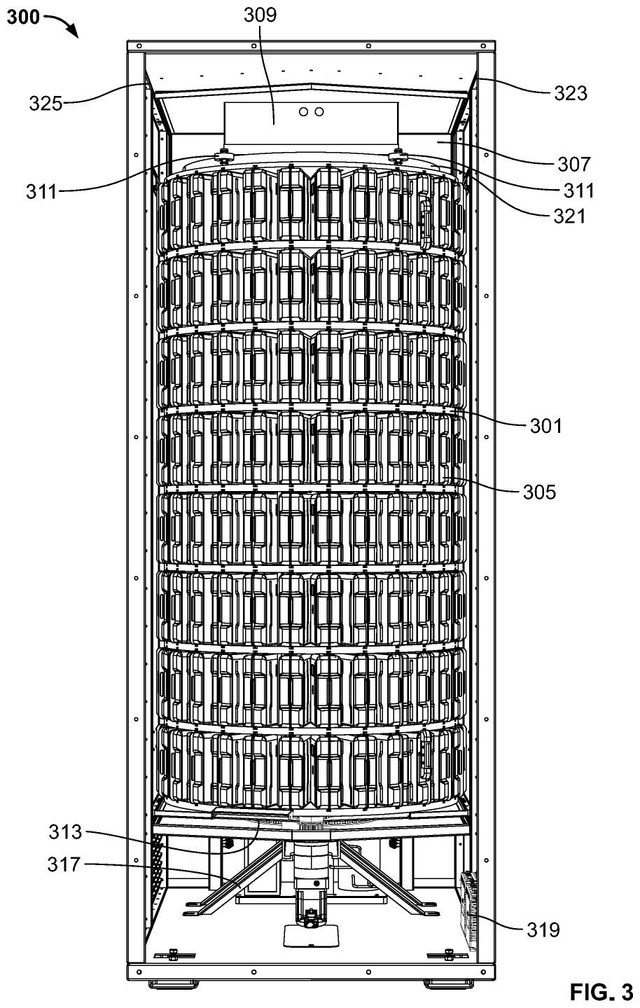

FIG. 3 shows storage frame 301 positioned in storage cabinet 307. Storage frame 301 is illustrated supporting multiple item carriers 305. Each item carrier 305 may store one or more items.

Storage frame 301 may be mounted on rotation mechanism 313. Rotation mechanism 313 may rotate storage frame 301 clockwise and counterclockwise. Angled legs 317 positioned adjacent rotation mechanism 313 may support the weight of storage frame.

Plenum 309 may be positioned above storage frame 301. Plenum 309 may pull air up from a passageway extending along a longitudinal axis of storage frame 301. Plenum 309 may include an evaporator coil. Plenum 309 may include a heating element. Plenum 309 may include a fan. The fan in the plenum may blow air down the exterior of storage frame 301 to a bottom of storage cabinet 307. Plenum may pull air up along the passageway by creating a low-pressure environment within the passageway. The low-pressure environment may be created by blowing air out of the plenum. As air passes through the plenum, the plenum may change the temperature of the air.

A top face of storage frame 301 may include ridge 312. Wheels 311 may engage ridge 321. Wheels 311 may slidingly engage ridge 312. Wheels 311 may define the second coupling mechanism. Wheels 311 may be fixed to the second elongated member (not shown). The second elongated member may extend between first side 323 of the storage cabinet and second side 325 of the storage cabinet.

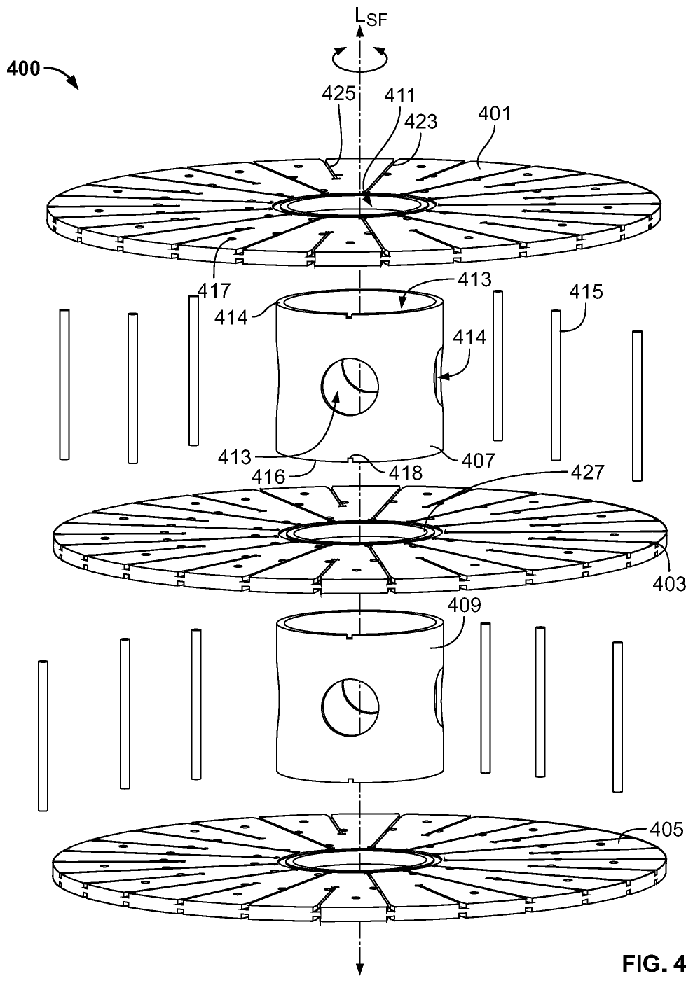

FIG. 4 shows illustrative components 400 of a frame assembly. The frame assembly may be configured to rotate about longitudinal axis L_{SF}. When the components of the frame assembly are assembled, they may define a passageway. The passageway may extend along longitudinal axis L_{SF}. An inner face of conduits may define the passageway. An inner face of the conduits and an inner face of the platforms may define the passageway. An inner face of a platform may be defined by a central aperture, such as central aperture 411. The passageway may be circumscribed by the assembled conduits and passageways.

Components 400 include first platform 401. First platform 401 may be constructed from high density polyethylene or any other suitable material. First platform 401 includes channel 423. Channel 423 extends between central aperture 411 and a perimeter of first platform 401. First platform 401 may include a plurality of channels 423. First platform 401 includes channel 425. Channel 425 extends between central aperture 411 and a perimeter of first platform 401. Channel 425 is shorter than channel 423. First platform 401 may include a plurality of channels 425.

Rotation about axis L_{SF} may move any one of channels 425 or 423 to a desired position. For example, rotation may align channel 423 with a gripper such that an inner shell of an item carrier seated in channel 423 may be moved to release item I contained within the inner shell.

First platform 401 includes depression 417. Depression 417 may receive a dowel, such as dowel 415.

Components 400 include conduit 407. Conduit 407 may be constructed from commercial Schedule-40 PVC pipe or any other suitable schedule pipe or material.

Conduit 407 includes first aperture 413. First aperture 413 may be aligned with central aperture 411 such that fluid carried by conduit 407 may flow through central aperture 411.

A body of conduit 407 includes second aperture 413 and third aperture 414. Conduit 407 may include any suitable number of apertures. Apertures in conduit 407 may facilitate circulation of a fluid, such as air, between components 400.

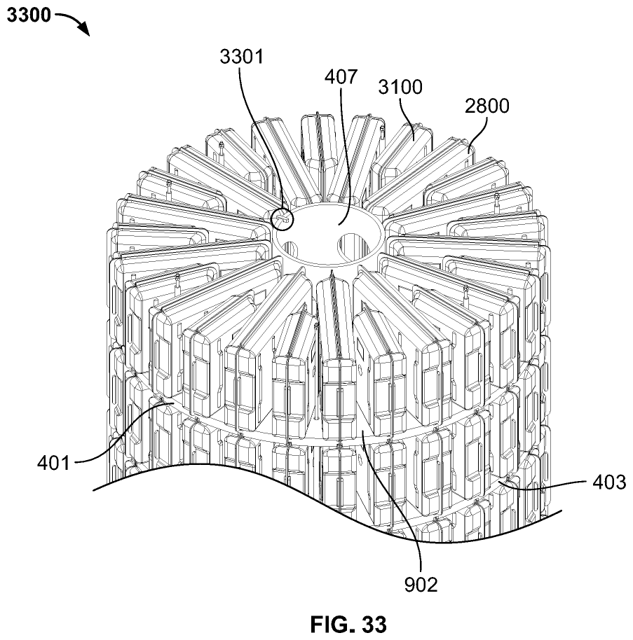

Components 400 include second platform 403. Second platform 403 includes groove 427. Second end 416 of conduit 407 may mate with groove 427. Conduit 407 includes cut out 418. Cut out 418 may be configured to mate with a protrusion 3301 (shown in FIG. 33) in second platform 403. Mating of the protrusion and cut out 418 may prevent rotation of conduit 407 about longitudinal axis L_{SF} when second end 416 is positioned in groove 427. Mating of the protrusion and cut out 418 may ensure proper placement and alignment of the platforms during assembly.

Components 400 include third platform 405. Each of platforms 401, 403 and 405 may include one or more features shown in connection with one of platforms 401, 403 and/or 405. For example, first platform 401, second platform 403 and third platform 405 may each be identical.

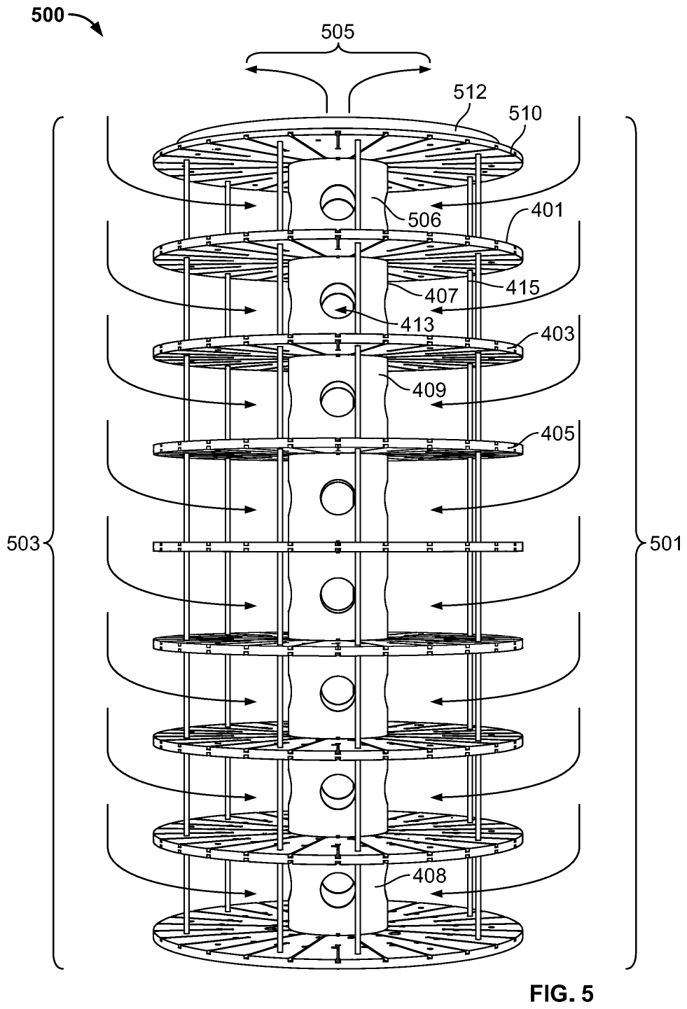

FIG. 5 shows components 400 assembled in frame assembly 500. FIG. 5 shows platforms 401 and 403 spaced apart from each other by conduit 407. Platforms 403 and 405 are spaced apart from each other by conduit 409.

FIG. 5 also shows dowel 415 providing support to the spacing apart of platform 401 from platform 403.

FIG. 5 also shows illustrative fluid flows 501 and 503. Fluid flows 501 and 503 shows that fluid surrounding frame assembly 500 may be drawn into the conduits via the apertures in the conduits. Fluid surrounding frame assembly 500 may be drawn into the conduits by an axial fan that pulls fluid up through the passageway extending through an assembly of stacked conduits (e.g., 506, 407 and 409). The passageway may extend through a center of the stacked conduits.

Conduits may include a shutter (not shown). The shutter may be constructed from PVC material. The shutter may change a size of apertures in each conduit. For example, shutters may adjust the size of apertures such that conduit 506 has the smallest size apertures and conduit 408 has the largest size apertures. The shutters may be passive shutters that are not adjustable.

Fluid flow 505 shows that fluid drawn into the conduits may flow through the platforms and out of a central aperture in top-most platform 510. FIG. 5 also shows ridge 512. Ridge 512 may be used to support frame assembly 500 without obstructing fluid flow 505.

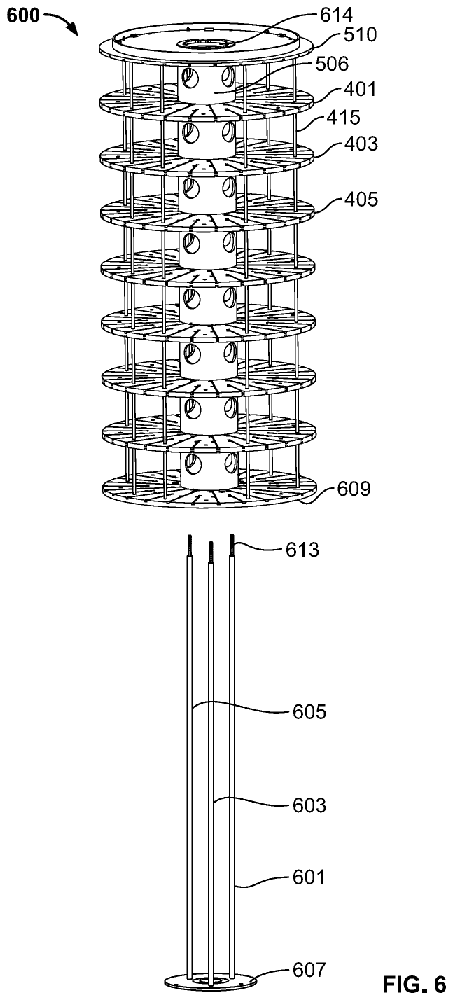

FIG. 6 shows illustrative components 600 of a storage frame. Components 600 include bottom-most platform 609. Components 600 include rods 605, 603 and 601. Other embodiments may include one, two, four, five or any suitable number of rods.

FIG. 6 shows that first end of rods 605, 603 and 601 may be secured to plate 607. Rods 605, 603 and 601 may extend through the conduits and between the platforms. Rods 605, 603 and 601 may extend through the passageway extending through, and circumscribed by, the conduits and the platforms. Rods 605, 603 and 601 may be any suitable length. An illustrative length may be five feet, five and a half feet, six-feet, six and a half feet, seven feet, or any other suitable length. Plate 607 may be braced by bottom-most platform 609. A second end of rods 605, 603 and 601 may extend through central aperture 614 of top-most platform 410.

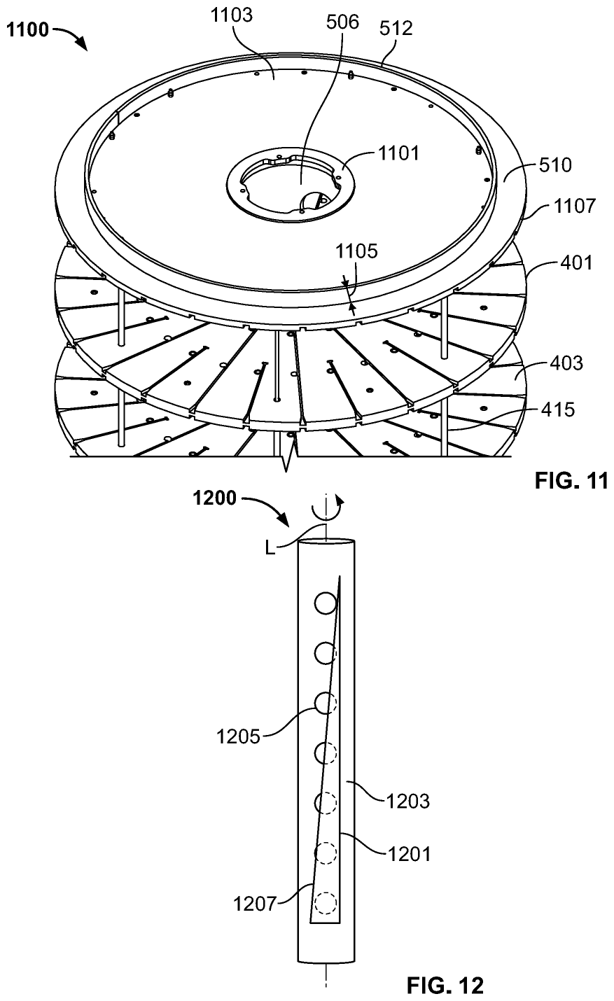

FIG. 6 shows that a second end of rods 605, 603 and 601 may each include threaded segment 613. Bracket 1101 (illustrated in FIG. 11) may fit around central aperture 614 of top-most platform 510. Bracket 1101 may include an opening for each of the ends of the rods. The bracket may not obstruct central aperture 614. A nut (not shown) may be threaded onto each of threaded segments 613 until it abuts bracket 1101. Two nuts may be used (see description of FIG. 11 below). Tightening the nuts may apply tension to rods 605, 603 and 601 and compression to the platforms and conduits between top-most platform 510 and bottom-most platform 609. Tightening the nuts may apply tension to rods 605, 603 and 601 and compression to the platforms and conduits between plate 607 and bracket 1101.

The compression may maintain a shape of a storage frame, such as storage frame 500 (shown in FIG. 5). The compression may provide an axial force to prevent slippage and de-coupling of the components. The compression may secure a position of first platform 401, conduit 407, second platform 403, conduit 409 and third platform 405 as shown in FIG. 5.

A conduit may be constructed from Schedule-40 PVC pipe which provides strength that may withstand the axial compression due to the tensioning of rods 605, 603 and 601. Schedule-40 PVC pipe may also be typically dimensionally controlled in the manufacturing process on the outside diameter. A mating feature, such as a groove, may be formed in a platform that allows off-the-shelf Schedule-40 PVC pipe to be cut to desired length. The cutting may be controlled such that the cuts in the Schedule-40 PVC pipe are substantially perpendicular to a length the piping. Such cuts may allow platforms and conduits to be stacked. Such cuts may allow compression to be applied in a direction substantially parallel to axis L_{SF} (shown in FIG. 4). After tightening rods 605, 603 and 601, stacked platforms and conduits may form a monolithic structure.

It is to be understood that although FIG. 6 shows three rods 605, 603, 601, a fourth rod may also be positioned on plate 607 such that each of the rods are circumferentially spaced about a midpoint of plate 607. All features discussed above to three rods are applicable to embodiments with four, or more, rods as well.

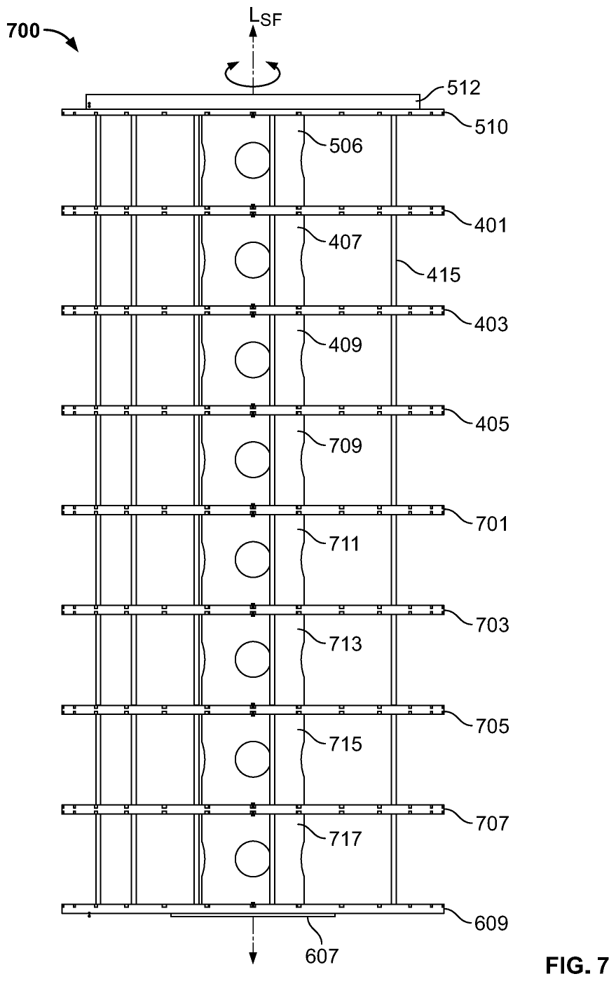

FIG. 7 shows illustrative storage frame 700. Storage frame 700 includes ridge 512. Ridge 512 may act as a brace for controlling a position of the upper part of storage frame during rotation about axis L_{SF}. Bottom platform 609 may be coupled to a drive mechanism that rotates storage frame 700. As shown in FIG. 5, air or other fluid may flow through conduits (e.g., 407 and 409) along axis L_{SF}. Ridge 512 allows for bracing without obstructing fluid flow through the conduits.

As storage frame 700 rotates, ridge 512 provide a surface for bracing storage frame 700 and preventing wobbling or other imbalance due to a load carried by storage frame 700.

Storage frame 700 also includes platforms 701, 703, 705 and 707. Storage frame 700 includes conduits 709, 711, 713, 715 and 717 that space platforms apart from each other. Each of conduits 506, 709, 711, 713, 715 and 717 may include one or more features of conduit 407. Collectively, conduits 506, 407, 409, 709, 711, 713, 715 and 717 may allow a fluid, such as air, to flow from bottom-most platform 609, up a passageway extending along L_{SF}, and out of a central aperture of platform 510. A storage frame may include any suitable number of platforms and conduits.

FIG. 8 shows illustrative features of platform 401. Platform 401 includes a plurality of channels 423. Platform 401 includes a plurality of channels 425. Features 800 show that platform 401 includes depressions 809 and 807 adjacent to channels 423. Depressions 809 and 807 are configured to receive a rubber stopper.

FIG. 8 shows central aperture 411. Central aperture 411 may allow fluid carried by a conduit to flow through platform 401. Central aperture 411 may circumscribe the passageway. Platform 401 includes groove 811. A tubular conduit, such as conduit 506 (shown in FIG. 5) may fit into groove 811. Platform 401 also includes mating feature 813. A conduit may include a corresponding feature configured to fit into mating feature 813. Mating feature 813 may be configured to prevent a conduit from rotating within groove 811. Tensioning rods 601, 603 and 605 (shown in FIG. 6) may apply compression that keeps a conduit in groove 811.

Channels 423 include guide segments 801. Guide segments 801 may include a mouth that is wider than a width of channels 423. Guide segments 801 include an exit that is the same width as the width of channels 423. Guide segments 801 also include a tapered section that transitions between the mouth and the exit.

Guide segments 801 may provide a wider opening to receive an extension of an item carrier. After the extension is inserted into the mouth, the tapered section may guide the extension through the exit and into a channel 423. Channels 425 also include guide segments 803. Guide segments 803 may include one or more features of guide segments 801.

Platform 401 includes depressions 417. Depressions 417 may be configured to receive a dowel, such as dowel 415 (shown in FIG. 4). Depressions 417 may provide a friction fit for dowel 415.

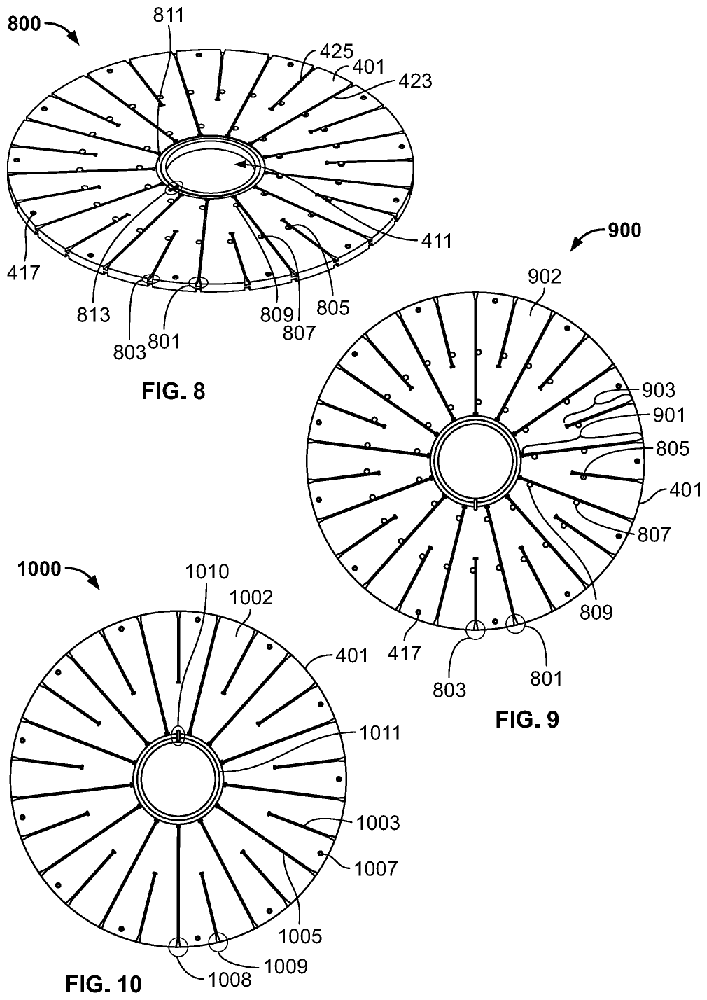

FIG. 9 shows illustrative features 900 of face 902 of platform 401. FIG. 9 shows that channels 425 have length 903. FIG. 9 shows that channels 423 have length 901. Length 901 may be greater than length 903. Face 902 may be an upper face of platform 401.

FIG. 10 shows illustrative features of face 1002 of platform 401. Faces 902 and 1002 may be parallel to each other. A thickness of platform 401 may extend between faces 902 and 1002. A vector normal to face 902 may point in an opposite (e.g., rotated 180°) direction to a vector normal to face 1002. FIG. 10 shows that face 1002 includes channels 1003. Channels 1003 have length 903. Face 1002 includes channels 1005. Channels 1005 have length 901. Face 1002 may be a lower face of platform 401.

Channels 423 or 425 in face 902 may be configured to receive a first extension segment of an item carrier. The first extension segment may be positioned on a bottom of the item carrier. Channels 1003 or 1005 in face 1002 may be configured to receive a second extension segment of the item carrier. The second extension segment may be positioned on a top of the item carrier. FIG. 10 shows that face 1002 may not include depressions 805, 807 or 809 for receiving rubber stoppers.

FIG. 10 also shows that channels 1005 include guide segments 1008. Channels 1003 include guide segments 1009. Guide segments 1008 and 1009 may include one or more features of guide segment 801. For example, guide segments 1008 and 1009 may each include a mouth, exit and a tapered section.

Face 1002 also includes depressions 1007. Depressions 1007 may be configured to receive a dowel, such as dowel 415 (shown in FIG. 4). Depressions 1007 may provide a friction fit for dowel 415.

Face 1002 includes groove 1011. A tubular conduit, such as conduit 407 (shown in FIG. 4) may fit into groove 1011. Face 1002 also includes mating feature 1010. A conduit may include a corresponding feature configured to fit into mating feature 1010. Mating feature 1010 may be configured to prevent a conduit from rotating within groove 1011. Tensioning rods 601, 603 and 605 (shown in FIG. 6) may apply compression that keeps a conduit in groove 1011.

FIG. 11 shows illustrative top portion of platform 510. Platform 510 may be a top-most platform of the illustrated storage frame. A top face of platform 510 may not include channels. A bottom face of platform 510 may include channels 1107 for receiving an outer extension of an item carrier supported by platform 401.

Platform 510 may include ridge 512. Ridge 512 may be positioned on platform 510. Ridge 512 may be positioned on the top face of platform 510. Ridge 512 may have height 1105. Ridge 512 circumscribe area 1103 on platform 510. Area 1103 may not be supported by any support mechanism in the vending assembly. Area 1103 may not be in direct physical contact with any apparatus included in the vending assembly.

Ring-shaped bracket 1101 may be positioned on the top face of platform 510. Ring-shaped bracket 1101 may receive threaded-portions of rods (such as rods 601, 603 and 605 and, optionally, a fourth rod) that extend through the passageway. The threaded tips of the rods may pass through four holes defined by bracket 1101.

A set of two nuts may be screwed onto the threaded tips of the four rods protruding above bracket 1101. The first nut may be used to control the axial clamping force by being tightened to certain torque spec. The second nut may buck up the first nut up to stop it from loosening over time. The second nut may be a jam nut.

Ring-shaped bracket 1101 may be a clamping plate. Plate 607 may also be a clamping plate. During assembly, force may be applied between ring-shaped bracket 1101 and plate 607, for example, by screwing a nut into each of the tips of threaded rods extending through the conduits of the storage frame (such as rods 601, 603 and 605). This clamping force may supply each platform with sufficient friction to provide angular alignment of the platforms and the conduits and to withstand slippage of the platforms and the conduits away from the longitudinal axis of the storage frame.

The apparatus may include a fourth threaded rod. The fourth threaded rod may be spaced circumferentially apart from each other about a midpoint of plate 607. The fourth threaded rod may extend through the passageway.

FIG. 12 shows illustrative choke tube 1200. Choke tube 1200 may be disposed inside a passageway extending through conduits 1205 (e.g. conduits 506, 407 and 409). Choke tube 1200 may be rotatable about axis L_{SF} inside the conduits. The passageway may run inside choke tube 1200. Choke tube 1200 may include fluid flow region 1201. Choke tube 1200 may include fluid obstruction region 1203. Positions of apertures are shown in broken line. Positions of occluded regions of the apertures are shown in solid black to signify occlusion by obstruction region 1203. Positions of open regions of the apertures are shown in white to signify openness for flow. Edge 1207 of fluid flow region 1201 is shown on a (cylindrical) slant relative to axis L. The slant may establish a flow distribution among the apertures. Apertures further away from the fan positioned in the plenum may be provided with more open area to balance against drag from structures along the flow path, which is longer than the path to the apertures closer to the fan.

Fluid flow region 1201 may have parallel edges instead of a slanted edge.

Choke 1200 may be segmented into separate bands. Each band may correspond to a conduit (e.g., 506, 407, and 409). Each band may correspond to a section of a conduit.

A conduit (e.g., 506, 407, and 409) may include more than one aperture (see, for example, apertures 413 and 411 of conduit 407). A choke may include a fluid flow region for each of the apertures. A choke may include a fluid obstruction region for each of the apertures.

A “hollow” conduit may include a choke.

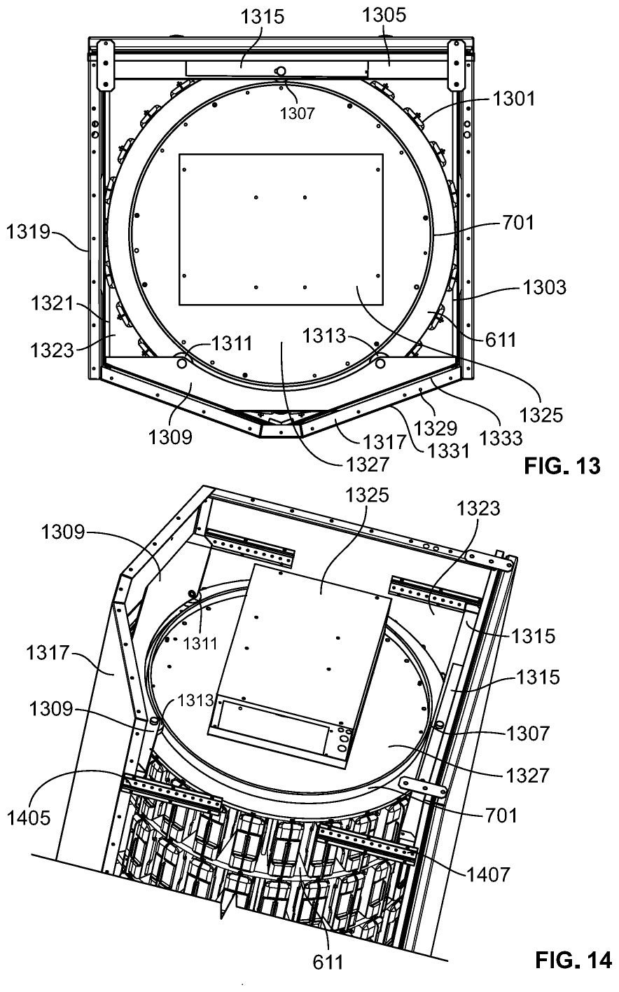

FIG. 13 shows storage cabinet 1323. Storage cabinet 1323 may be positioned in housing 1319. Storage cabinet may surround storage frame 611. Storage frame 611 may support a plurality of item carriers 1301.

Partition 1317 may extend across housing 1319 to separate storage cabinet 1323 from access cabinet (not shown). Partition 1317 may define partition first face 1331 and partition second face 1333. Partition first face 1331 may be positioned in the access cabinet. Partition second face 1333 may be positioned in the storage cabinet. Thickness 1329 may extend between partition first face 1331 and partition second face 1333.

Storage frame 611 may be positioned in storage cabinet 1323. A top face 1327 of storage frame 611 may include ridge 701. Ridge 701 may be slidingly and removably coupled to the first coupling mechanism and the second coupling mechanism.

Elongated member 1309 may extend between first side 1321 of storage cabinet 1323 and second side 1303 of storage cabinet 1323. First side 1321 may be opposite second side 1303. Elongated member 1309 may include a coupling mechanism for supporting top face 1327 of storage frame 611. The coupling mechanism may be wheels 1311 and 1313. Wheels 1311 and 1311 may be slidingly engaged with ridge 701 and provide to ridge 701 an inward radial force to support storage frame 611.

Elongated member 1305 may extend between first side 1321 of storage cabinet 1323 and second side 1303 of storage cabinet 1323. Elongated member 1305 may include a coupling mechanism for supporting top face 1327 of storage frame 611. The coupling mechanism may be wheel 1307. Member 1315 may be removably coupled to elongated member 1305. Member 1315 may support wheel 1307. Wheel 13071 may be slidingly engaged with ridge 701 and provide to ridge 701 an inward radial force to support storage frame 611.

Plenum 1325 may be positioned above storage cabinet 1323. A bottom of plenum 1325 may be spaced apart from top face 1327 of storage cabinet 1323. A bottom of plenum 1325 may not be in direct physical contact with top face 1327. An empty space may extend between bottom of plenum 1325 and top face 1327 of storage frame 611.

A bottom of plenum 1325 may be coupled to top face 1327 via a bearing collar.

Plenum 1325 may circulate a fluid, such as air, in storage cabinet 1323. Plenum 1325 may regulate the temperature of the air in storage cabinet 1323, as described herein.

FIG. 14 shows a different view of apparatus illustrated in FIG. 13. FIG. 14 shows storage cabinet 1323 with side 1303 not shown. In FIG. 14, rails 1405 and 1407 are illustrated. Rails 1405 and 1407 may be structural mounting surfaces for 1309 and 1305.

A thermal standoff area may exist between the roof of the insulated enclosure and a roof of the housing. A top of the plenum may be connected to the roof of the insulated enclosure by mounting blocks that extend through the thermal standoff area and are bolted into the roof of the insulated enclosure.

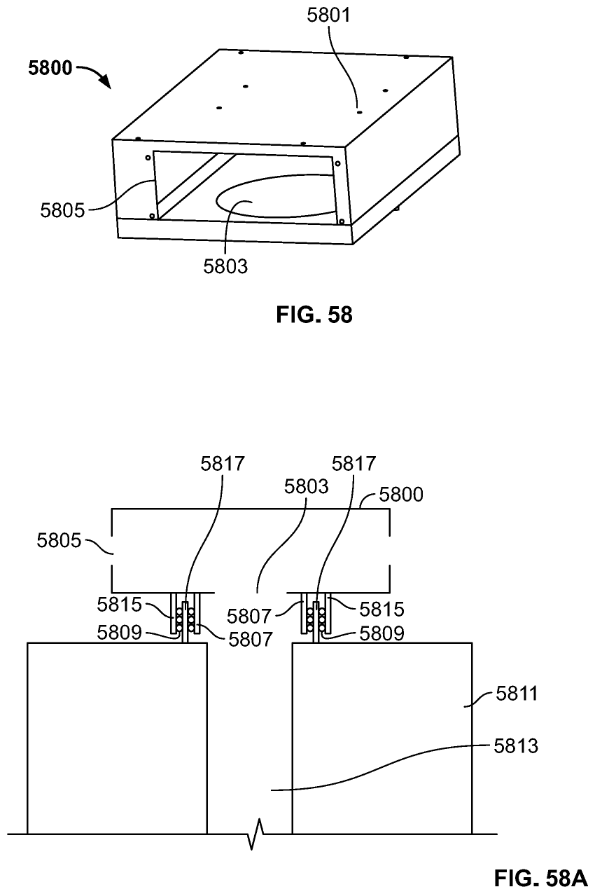

The bottom of plenum 1325 may not be in direct contact with top face 1327 of storage cabinet 1323. A bottom face of plenum 1325 may include a fixed conduit (see, for example, FIG. 58A below). The fixed conduit may be a rotary coupling conduit. The fixed conduit may be circular, or any other suitable shape. The fixed conduit may be fixed in space and may not move.

The top face of 1327 may include a rotating conduit. The rotating conduit may rotate together with storage frame 611. The rotating conduit may be circular, or any other suitable shape. The fixed conduit may not be in direct contact with the rotating conduit. A tortuous pathway may extend between the fixed and rotating conduits. The tortuous pathway may create a fluid seal path by limiting or preventing air from being sucked in from a perimeter of the top face of storage cabinet 1323 towards plenum 1325. Concentric positioning of the fixed and rotating conduits may provide a non-contact configuration, with no weight-bearing properties, low rotational friction, and a highly flow restrictive boundary for air-flow leakage through the rotary conduit boundary walls. This configuration may force a preferred ducting path from the fan inlet to the rotating storage frame.

Bearings may be positioned between the rotating conduit and the fixed conduit.

The space between the rotating conduit and the fixed conduit may be empty.

The bottom of the plenum may include a second fixed conduit (see FIG. 58A).

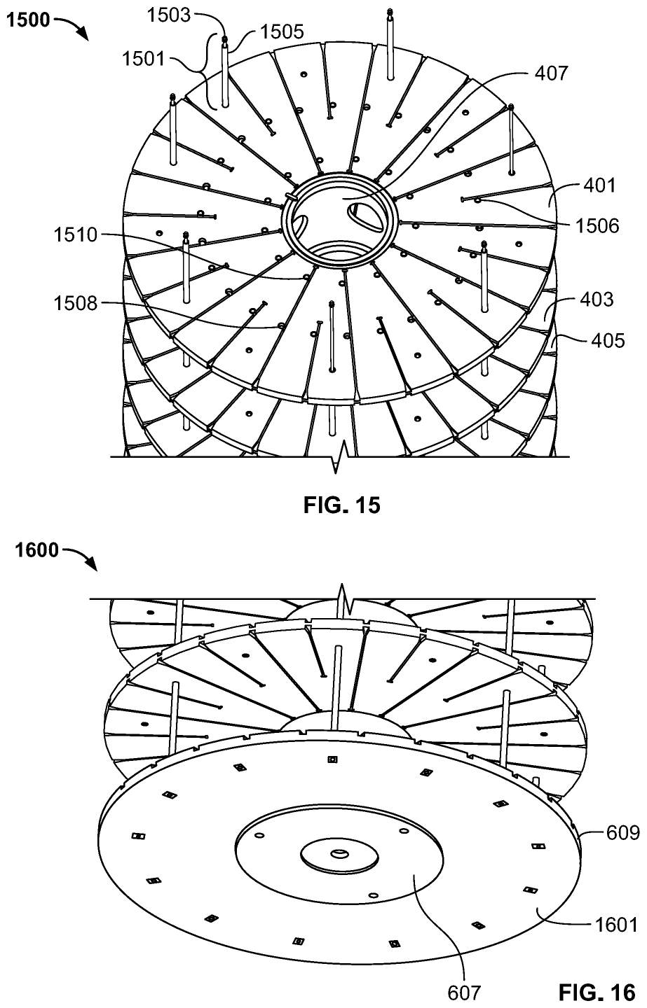

FIG. 15 shows illustrative segment 1500 of a storage frame. Segment 1500 includes platform 401. Conduit 407 is positioned in groove 1011 (shown in FIG. 10). Conduit 407 spaces platform 401 apart from platform 403. Conduit 407 may be positioned in a groove in platform 403. The groove may include one or more features of groove 811 (shown in FIG. 8)

FIG. 15 shows dowels 1501 positioned in depressions 417. Dowels 1501 include end 1503. End 1503 includes a first section that is configured to fit into a depression in platform 510. Dowel 1501 includes shaft segment 1505. Shaft segment 1505 may have a greater diameter than a diameter of a depression in platform 510. Shaft segment 1505 may not fit into the depression and thereby support platform 510.

In some embodiments, platform 510 may include an aperture for receiving end 1503. Shaft segment 1505 may not fit through the aperture and thereby support platform 510. In some embodiments, end 1503 may protrude through an aperture in platform 510. A nut may be affixed to the protruding end 1503. The nut may fix dowel 1501 to platform 510.

FIG. 15 also shows rubber stopper 1510 positioned in one of depressions 809. FIG. 15 shows that depressions 1508 do not include a rubber stopper. FIG. 15 shows that depressions 805 include rubber stoppers 1506.

An item carrier may be inserted into a channel. Without rubber stoppers 1510 and 1506, there would be nothing to prevent the item carrier from sliding out of the channel (e.g., via guide segments 801 or 803) when the storage frame rotates about axis LSF. Rubber stoppers 1510 may protrude into channels 423 and interfere with an extension of an item carrier when the extension is inserted into channels 423. Rubber stoppers 1506 may protrude into channels 425 to interfere directly with the item carrier when it is inserted into channels 425. Rubber stoppers 1510 and 1506 may be polyurethane tubbing, hard rubber or any other suitable material.

When an extension of the item carrier meets rubber stoppers 1510 or 1506, the rubber stoppers push the extension of the item carrier to one side of channel 423 or 425. By pushing the extension to one side of a channel, the rubber stopper provides friction that keeps the item carrier in place while the storage frame rotates. The amount of interference and associated friction needed may depend on one or more of a maximum rotational speed of the storage frame, estimated mass of the item carrier and the item it contains.

FIG. 16 shows illustrative view 1600 of bottom-most platform 609. View 1600 shows that a face of platform 609 may not include channels. View 1600 shows that platform 609 may include brace plate 607. Brace plate 607 may be fixed to platform 609 via three bolts, or any other suitable number of bolts. The bolts may pass through platform 609, through plate 607, and into the drive mechanism.

Plate 607 may be secured to rods 601, 603 and 605 (shown in FIG. 6). Rods 601, 603 and 605 may extend through the passageway circumscribed by the multiple platforms and conduits. Ends 613 of rods 601, 603 and 605 may be secured to bracket 1101 braced by a top-most platform 510 (shown in FIG. 11).

Rods 601, 603 and 605 may be tensioned (e.g., by screwing nuts on ends 613). Top-most platform 510 may brace bracket 1101. View 1600 shows that bottom-most platform 609 may brace the plate. By tensioning the rods and bracing the bracket and plate, the multiple platforms and conduits may be held in compression. The compression may hold the multiple platforms and conduits together a unified structure.

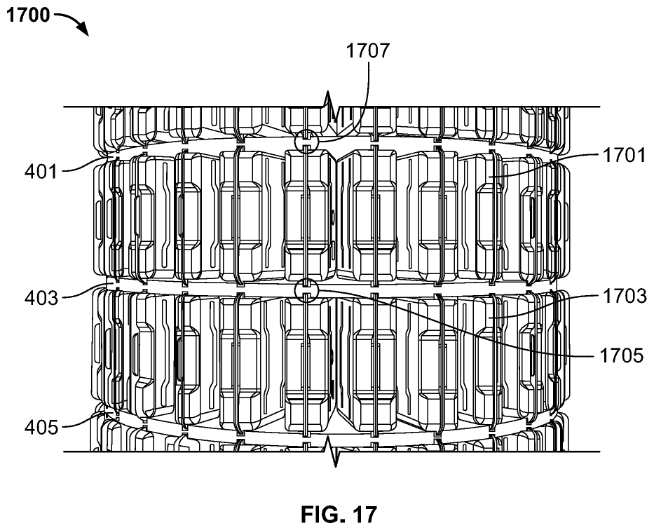

FIG. 17 shows an illustrative segment 1700 of a storage frame loaded with item carriers. FIG. 17 shows item carriers 1701 positioned in channels 1707 of platform 401. FIG. 17 shows item carriers 1703 positioned in channels 1705 of platform 403.

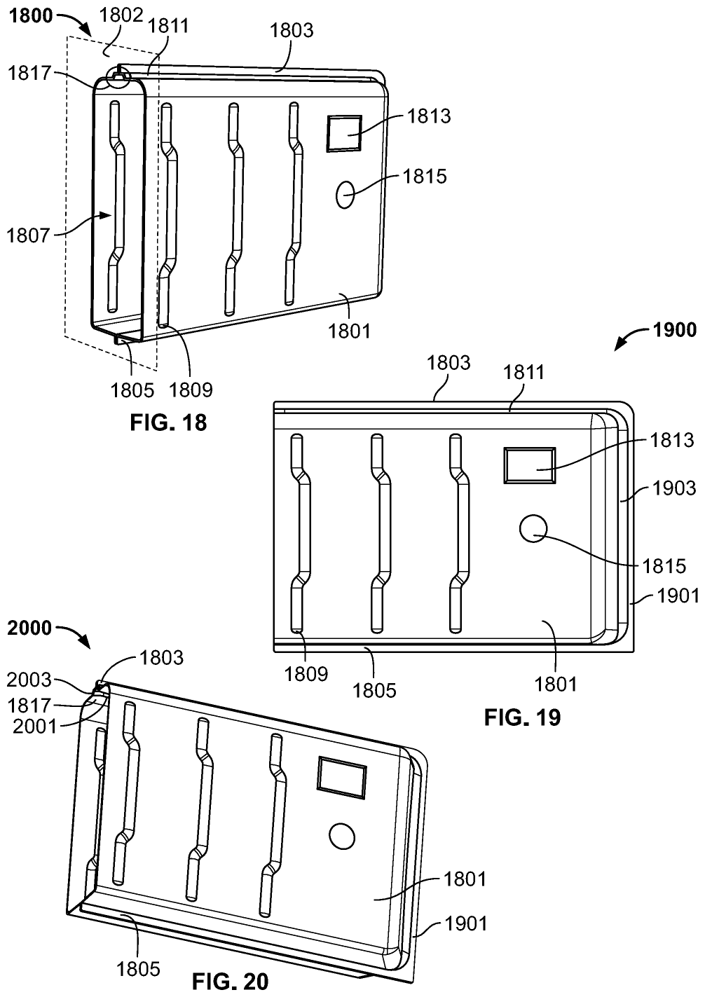

FIG. 18 shows illustrative outer shell 1800 of an item carrier. Outer shell 1800 includes housing 1801. Housing 1801 may be constructed from flexible plastic. Housing 1801 includes ribs 1809. Ribs 1809 may provide stiffness to housing 1801. Housing 1801 defines outer orifice 1807. Outer orifice 1807 may be configured to receive an inner shell. Outer shell 1800 defines orifice plane 1802.

Outer shell 1800 includes extension segment 1803. Extension segment 1803 may be configured to fit into a channel in a platform. Extension segment 1803 may fit into a channel in a first platform. Outer shell 1800 includes extension segment 1805. Extensions segment 1805 may be configured to fit into a channel in a platform. Extension segment 1805 may fit into a channel in a second platform. The first platform may be spaced apart from the second platform by a conduit. The channel of the first platform and the channel of the second platform may form a receptacle. Extension segments 1803 and 1805 may fit into a receptacle. Outer shell 1800 includes channel 1811. Channel 1811 may be configured to receive an extension segment of an inner shell. Channel 1811 may include mouth 1817 for receiving the extension segment of the inner shell. Mouth 1817 may be wider than channel 1811.

Outer shell 1800 includes location 1813. Location 1813 may be configured to display branding information associated with items contained in an item carrier.

Outer shell 1800 includes depression 1805. Depression 1805 may form a protrusion inside outer shell 1800. The protrusion formed by depression 1805 may be configured to mate with a corresponding depression of an inner shell, when the inner shell is nested within outer shell 1800. Mating of protrusion formed by depression 1805 and the corresponding depression of the inner shell may retain the inner shell within outer shell 1800.

FIG. 19 shows view 1900 of outer shell 1800. View 1900 shows channel 1903. Channel 1903 may be configured to receive an extension segment of an inner shell. View 1900 shows that outer shell 1800 includes extension segment 1901. Extension segment 1901 may bridge between extension segments 1803 and 1805. Extension segment 1901 may provide support (e.g., stiffness or rigidity) to extension segments 1803 and 1805.

Extension segment 1803 may be a top extension segment of outer shell 1800. Extension segment 1805 may be a bottom extension segment of outer shell 1800. Extension segment 1901 may be a side extension segment of outer shell 1800. Extension segment 1901 may extend between extension segments 1803 and 1805.

FIG. 20 shows view 2000 of outer shell 1800. View 2000 shows inside 2001 of channel 1811.

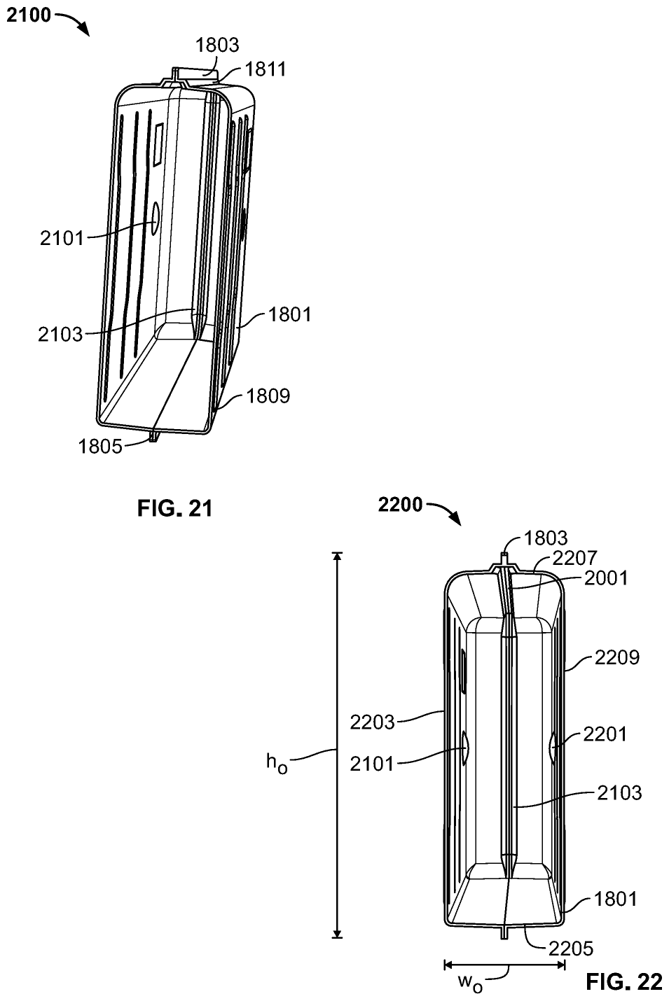

FIG. 21 shows illustrative view 2100 of an interior of outer shell 1800. View 2100 shows protrusion 2101. Protrusion 2101 extends into an interior of outer shell 1800. Protrusion corresponds to what would be a depression, such as depression 1815, when viewed from an interior of outer shell 1800. FIG. 21 shows inside 2103 of channel 1903. Inside 2103 may be configured to receive an extension segment of an inner shell.

FIG. 22 shows another view 2200 of an interior of outer shell 1800. View 2200 shows first protrusion 2101. View 2200 shows second protrusion 2201. Protrusion 2201, when viewed from an outside of housing 1801, corresponds to depression 1815.

FIG. 22 shows that housing 1801 includes walls 2209, 2203, 2205 and 2207. Walls 2209 and 2203, in a default position may be parallel to each other. Walls 2209 and 2203, in a default position may be substantially parallel to each other. Walls 2209 and 2203 may be flexible. Walls 2203 and 2209 may flex such that they are spaced further apart from each other. Walls 2203 and 2209 may flex such that at least one point along height h₀ is wider than width w₀. Walls 2203 and 2209 may flex such that at least one point along height h is narrower than width w₀.

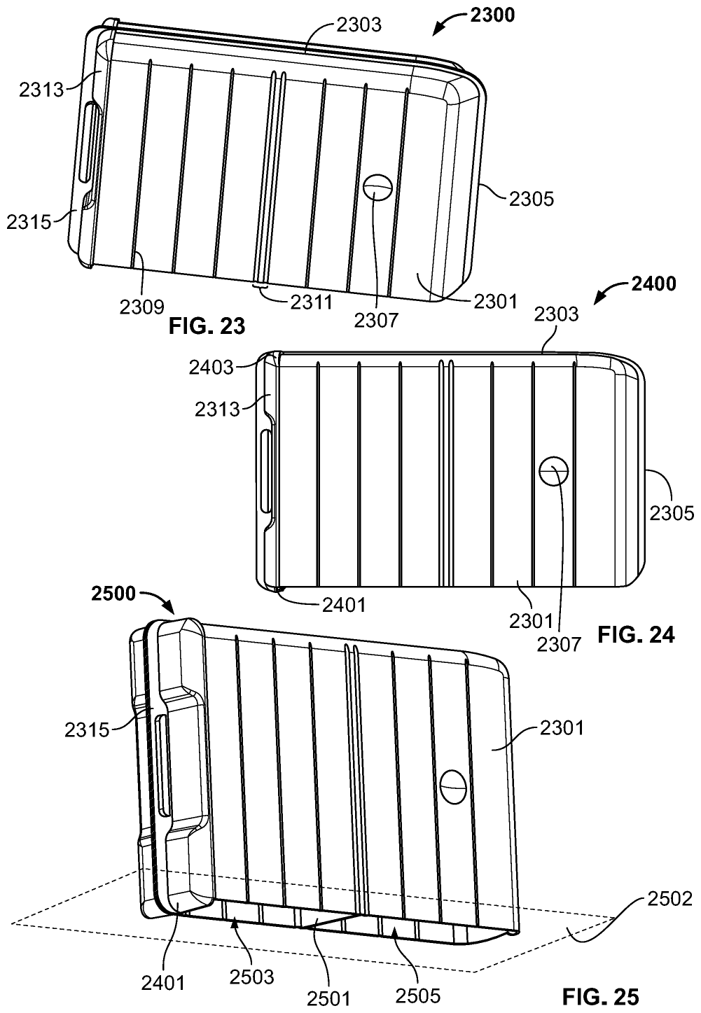

FIG. 23 shows illustrative inner shell 2300. Inner shell 2300 may contain item I offered for sale in a vending assembly. Inner shell 2300 includes wall 2301. Inner shell 2300 includes depression 2307. Depression 2307 may be configured to receive a protrusion, such as protrusion 2101 or 2201 of outer shell 1800. When inner shell 2300 is nested within outer shell 1800, depression 2307 may receive protrusion 2201. When depression 2307 is mated protrusion 2201, additional force may be required to separate protrusion 2201 from depression 2307. Mating depression 2307 with protrusion 2201 may prevent unintentional separation of inner shell 2300 from outer shell 1800.

Inner shell includes extension segment 2303. Extension 2303 may be configured to fit into channel 1811 of outer shell 1800. Inner shell includes extension segment 2305. Extension segment 2305 may be configured to fit into channel 1903 of outer shell 1800. Extension segments 2305 and 2303 may maintain a position of inner shell 2300 when nested within outer shell 1800.

Inner shell 2300 includes extension segment 2315. Extension segment 2315 may be used by the grabber to grab onto inner shell 2300 when separating a nested inner shell 2300 from outer shell 1800. The grabber may grab onto any location located along extension segment 2315. Extension segment 2315 may include an additional protrusion located at a middle portion of extension segment 2315. The grabber may brag onto the additional protrusion located at the middle portion of the extension segment 2315.

Inner shell 2300 includes wall 2313. Wall 2313 includes protruding and recessed surfaces. An RFID tag may be inserted within one or more of the protruding surfaces. The RFID tag may be read by reader positioned outside wall 2301.

Inner shell 2300 includes ribs 2309. Ribs 2309 protrude into an interior of inner shell 2300. Wall 2301 may be constructed from a flexible material, such as plastic. Flexibility of wall 2301 may allow inner shell 2300 to contain items larger than a default width w₁ of inner shell 2300. Ribs 2309 may extend along a height h₁ of inner shell 2300. Ribs 2309 may provide strength to wall 2301.

Ribs 2309 may provide a channel for air to escape if items contained within inner shell 2300 take up the entire space within inner shell 2300. Ribs 2309 may prevent the creation of a vacuum within inner shell 2300. A vacuum may prevent item I from being removed from within inner shell 2300. Ribs 2309 may also break up the otherwise flat surface on an interior of wall 2301. Ribs 2309 may prevent a flat or smooth surface of item I from sticking to an interior of wall 2301 when the item is damp or wet.

Inner shell 2300 includes rib pair 2311. Rib pair 2311 provides a channel, inside wall 2301 for holding a divider. The divider splits and interior of inner shell 2300 into two chambers. In some embodiments, an inner shell may include two or more dividers. A different item may be contained in each chamber. Release of item I stored in a particular chamber may be controlled by controlling how far a nested inner shell 2300 is pulled apart from outer shell 1800.

FIG. 24 shows illustrative view 2400 of inner shell 2300. View 2400 also shows that wall 2313 includes extensions 2403 and 2401 that extend beyond a height of wall 2301. Extensions 2403 and 2401 may be configured to touch walls 2207 and 2205 of outer shell 1800. Wall 2313 may also include extensions configured to touch walls 2203 and 2209 of outer shell 1800. When extensions of wall 2313 touch walls 2207, 2205, 2203 and 2209 of outer shell 1800, inner shell 2300 may be fully seated within outer shell 1800.

FIG. 25 shows illustrative view 2500 of inner shell 2300. View shows inner orifice plane 2502. Inner orifice plane 2502 is defined by walls that define orifice 2503 and orifice 2505. Inner orifice plane 2502 is configured to be oriented perpendicular to outer orifice plane 1802 (shown in FIG. 18) when inner shell 2300 is nested within outer shell 1800.

View 2500 shows divider 2501 positioned within rib pair 2311. Divider 2501 separates orifice 2503 from orifice 2505. Divider 2501 may create two distinct holding chambers within inner shell 2300.

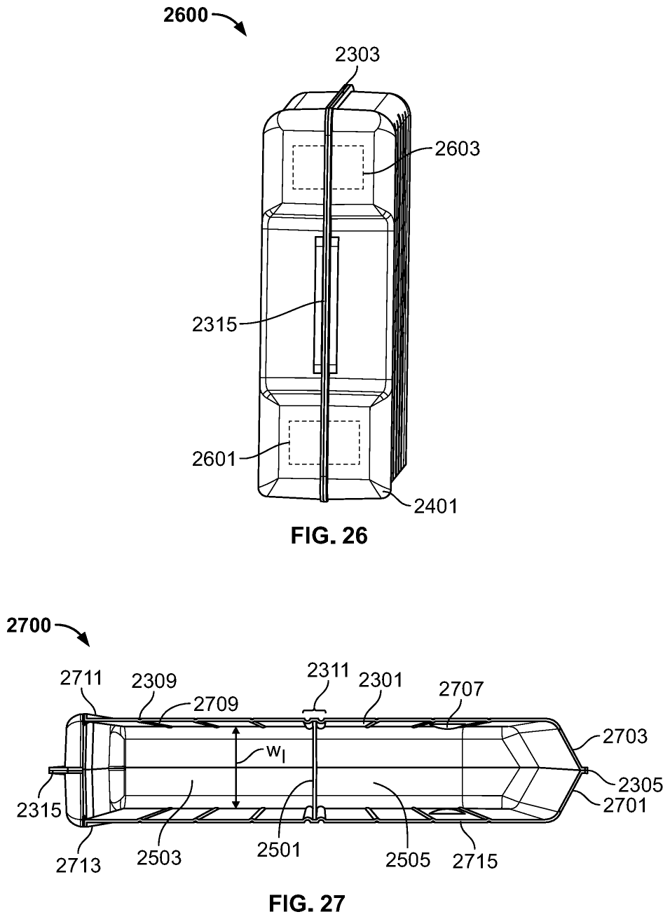

FIG. 26 shows illustrative view 2600. View 2600 shows a data record 2603 positioned underneath a first protruding surface of wall 2313. View 2600 shows data record 2601 positioned underneath a second protruding surface of wall 2313. Data records 2601 and 2603 may be RFID tags. Data records 2601 and 2603 may be any suitable data records described herein.

An inner shell may include one data records 2603 and 2601. An inner shell may include both of data records 2603 and 2601. Data records 2603 and 2601 may be the same. Data records 2603 and 2601 may be different.

View 2600 shows extension segment 2315 positioned along a center line of inner shell 2300. Extension segment 2315 may be referred to as a front extension segment.

Each inner shell may include a front extension segment positioned along the inner shell's center line. Uniform positioning of the front extension segments on different sized item carriers may allow the gripper to be configured to grasp each item carrier's front extension segment at the same position despite variations in item carrier depth and/or width (see, for example, FIGS. 33-37). Uniform positioning of the front extension segments on different sized carriers may result in constant alignment between receptacles defined by the platforms and item carrier's front extension segments, despite variations in item carrier depth and/or width (see, for example, FIGS. 33-37).

FIG. 27 shows illustrative view 2700 of inner shell 2300. View 2700 shows rib pair 2311 protruding into an interior of inner shell 2300. View 2700 shows rib pair 2311 holding divider 2501 in position between first orifice 2503 and second orifice 2505.

View 2700 shows ribs 2309 protruding (2709) into an interior of inner shell 2300. View 2700 shows extensions 2711 and 2713 of wall 2314. Extensions 2711 and 2713 may be configured to touch walls 2203 and 2209 of outer shell 1800 when inner shell 2300 is fully nested within outer shell 1800.

View 2700 shows default width w₁ of inner shell 2300. Default width w₁ may increase or decrease due to a flexibility of walls 2301 and 2715. Default width w₁ may increase when walls 2301 and 2715 are flexible and an item I is positioned inside inner shell 2300 having a width greater than default width

View 2700 shows tapered segments 2703 and 2701. After a nested inner carrier 2300 is pulled all the way out of outer shell 1800 for dispensing of an item I retained in inner carrier 2300, inner shell 2300 may need to be reinserted into outer shell 1800. Tapered segments 2701 and 2703 act as a rough alignment guide for inserting inner carrier 2300 into outer shell 1800 after being completely removed. Inner carrier 2300 includes extension segment 2305 that is configured to fit into channel 1903 of outer shell 1800. Mating of extension segment 2305 and channel 1903 may secure inner shell 2300 when it is nested within outer shell 1800.

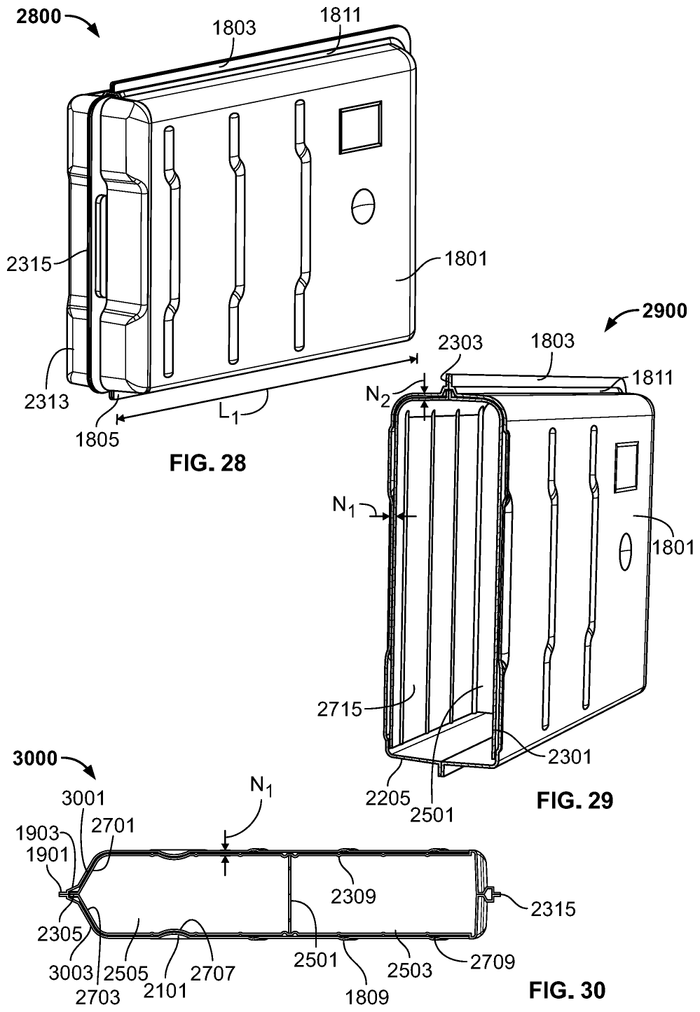

FIG. 28 shows illustrative item carrier 2800. Item carrier 2800 may include inner shell 2300 fully nested within outer shell 1800. Together inner shell 2300 and outer shell 1800 may be referred to as an item carrier. The item carrier shown has a length L₁.

FIG. 29 shows view 2900 of the item carrier shown in FIG. 28 without wall 2313 of inner shell 2300. View 2900 shows that wall 2205 of outer shell 1800 provides a floor for the chambers within inner shell 2300 accessible via orifices 2503 and 2505.

FIG. 29 also shows that inner shell 2300 may be dimensioned to nest snugly within outer shell 1800. For example, N₁ and N₂ show that in a nested configuration, outer shell side wall 2203 may positioned closely to, or touching, inner shell side wall 2715.

FIG. 30 shows view 3000 of the item carrier shown in FIG. 28 without wall 2205 of outer shell 1800. View 3000 shows that outer shell 1800 includes tapered segments 3001 and 3003 that form a stop for tapered segments 2701 and 2703 of inner shell 2300. View 3000 also shows extension segment 2305 of inner shell 2300 seated in channel 1903 of outer shell 1800. View 3000 shows a mating of 2101 and 2707 that retains inner shell 2300 and outer shell 1800 in a nested configuration.

FIG. 30 also shows that when inner shell 2300 is nested within outer shell 1800, ribs 2309 may leave air gaps between inner shell 2300 and outer shell 1800. Ribs 2309 may also create air gaps between inner shell 2300 and outer shell 1800. Ribs 2309 may protrude into an interior of inner shell 2300 and space any items contained within inner shell 2300 apart from side walls 2715 and 2301.

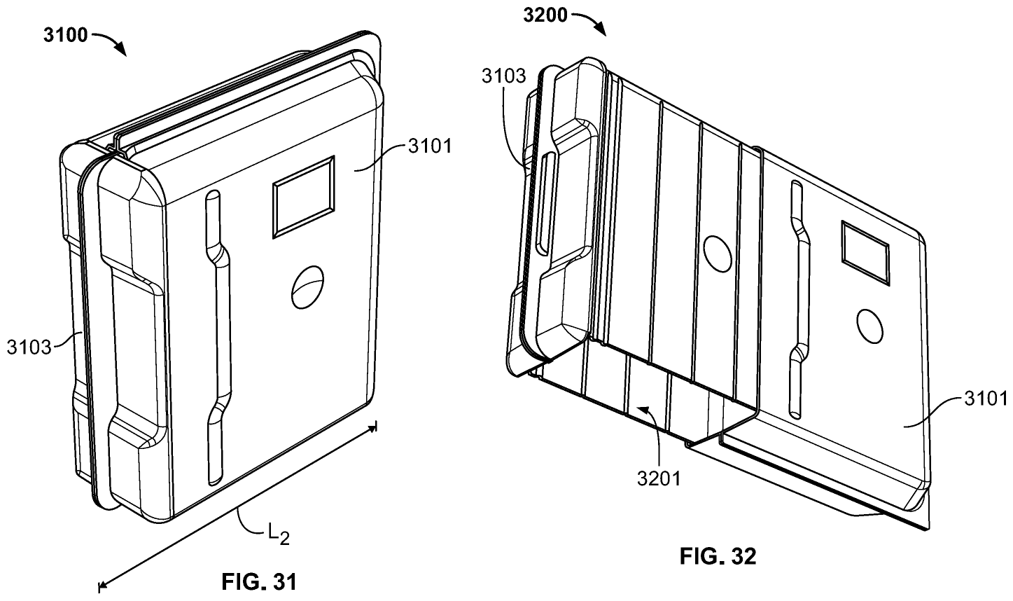

FIG. 31 shows illustrative item carrier 3100. Item carrier 3100 may include one or more features of the item carrier shows in FIG. 28. FIG. 31 shows that item carrier 3100 has length L₂. Length L2 may be shorter than length L₁ (shown in FIG. 28). Item carrier 2800 may be configured to be positioned in channel 423 (shown in FIG. 8) having length 901 (shown in FIG. 9). Item carrier 3100 may be configured to be positioned in channel 425 (shown in FIG. 8) having length 903 (shown in FIG. 9).

FIG. 32 shows view 3200 of inner shell 3103 of item carrier 3100 being partially separated from outer shell 3101 of item carrier 3100. The partial separation exposes orifice 3201 and a storage chambers of item carrier 3100 for holding an item. In some embodiments, item carrier 3100 may only have one chamber. In some embodiments, item carrier 3100 may include dividers for creating two or more storage chambers within item carrier 3100.

FIG. 33 shows an exemplary arrangement 3300 of item carriers 3100 and 2800 on platform 401. In arrangement 3300, all channels on platform 401 are filled with outer extensions of item carriers. All short channels are filled with outer extensions of item carriers 3100. All longer channels are filled with outer extensions of item carriers 2800.

Conduit 407 may include protrusion 3301. Protrusion 3301 may be pressed into a slot on a platform during fabrication. Protrusion 3301 may be permanently affixed to the platform on the top of the platform. A second protrusion may be fixed to a bottom of the platform (not shown). Protrusion 3301 may be positioned directly above the second protrusion along a height of the conduit. During assembly, protrusion 3301 may provide “keying” for the conduits (e.g., conduit 407) which has cut outs (e.g., cut out 418). This may ensure that conduit 407 can only be installed onto platforms in one orientation. When a subsequent platform is placed on top of conduit 407, this subsequent platform can only be installed in the same orientation as the previous platform. Usage of protrusions such as 3301 may thus allow control of the radial position of each shelf so they all match up and are consistent along a height of the storage frame. Consistency between the platforms may result in the radial positions of channels on one platform aligning with the radial positions of channels on the other platforms.

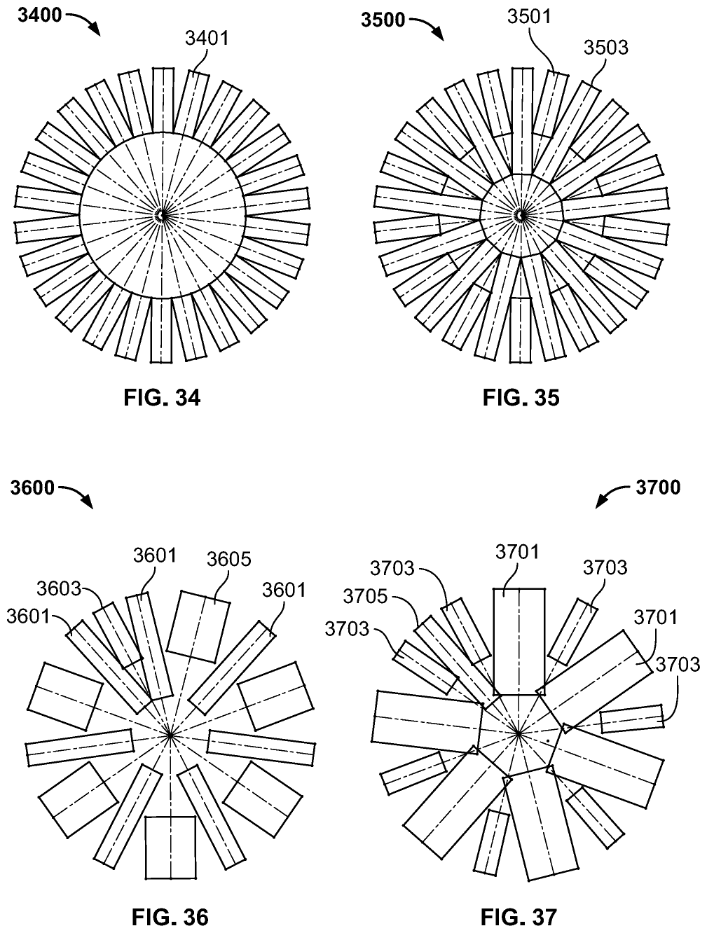

FIG. 34 shows an exemplary arrangement of item carriers on a platform. In FIG. 34, all available channels are filled with item carriers 3401. An exemplary platform may include 26 channels to support 26 item carriers 3401. Exemplary platforms may include any other suitable numbers of channels. Item carrier 3401 may be item carrier 3100. Item carrier 3401 may have one or more features in common with item carrier 3100.

FIG. 35 shows another exemplary arrangement of item carriers on a platform. In FIG. 35, all available channels are filled with item carriers. In FIG. 35, channels are supported by equal numbers of item carriers 3501 and item carriers 3503. Each item carrier 3501 is positioned between two item carriers 3503. Each item carrier 3503 is positioned between two item carriers 3501. An exemplary platform may include 26 channels to support 13 item carriers 3501 and 13 item carriers 3503. Exemplary platforms may include any other suitable numbers of channels.

Item carrier 3501 may be item carrier 3100. Item carrier 3501 may have one or more features in common with item carrier 3100. Item carrier 3503 may be item carrier 2800. Item carrier 3503 may have one or more features in common with item carrier 2800.

FIG. 36 shows another exemplary arrangement of item carriers on a platform. In FIG. 36, some of the channels are filled. Channels that are not filled are covered by a wide bottom of wide item carrier 3605. In FIG. 36, channels are filled with item carriers 3601, 3603 and 3605. Each of item carriers 3601, 3603 and 3605 have different dimensions. The different dimensions of the item carriers may be used to accept different sized items.

The platform for supporting the item carriers illustrated in FIG. 36 may include 26 channels. The platform may include any other suitable number of channels. As illustrated in FIG. 36, wide and short carriers 3605 may positioned about a center of the platform such that their weight is radially distributed as evenly as possible about the center of the platform.

FIG. 37 shows another exemplary arrangement of item carriers on a platform. In FIG. 37, some of the channels are filled. Some of the channels are covered by a wide bottom of wide item carrier 3701. In FIG. 37, channels are filled with item carriers 3701, 3703 and 3705. Each of item carriers 3701, 3703 and 3705 have different dimensions. The different dimensions of the item carriers may be used to accept different sized items.

The platform for supporting the item carriers illustrated in FIG. 37 may include 26 channels. The platform may include any other suitable number of channels. As illustrated in FIG. 37, wide and long item carriers 3705 may positioned about a center of the platform such that their weight is radially distributed as evenly as possible about the center of the platform.

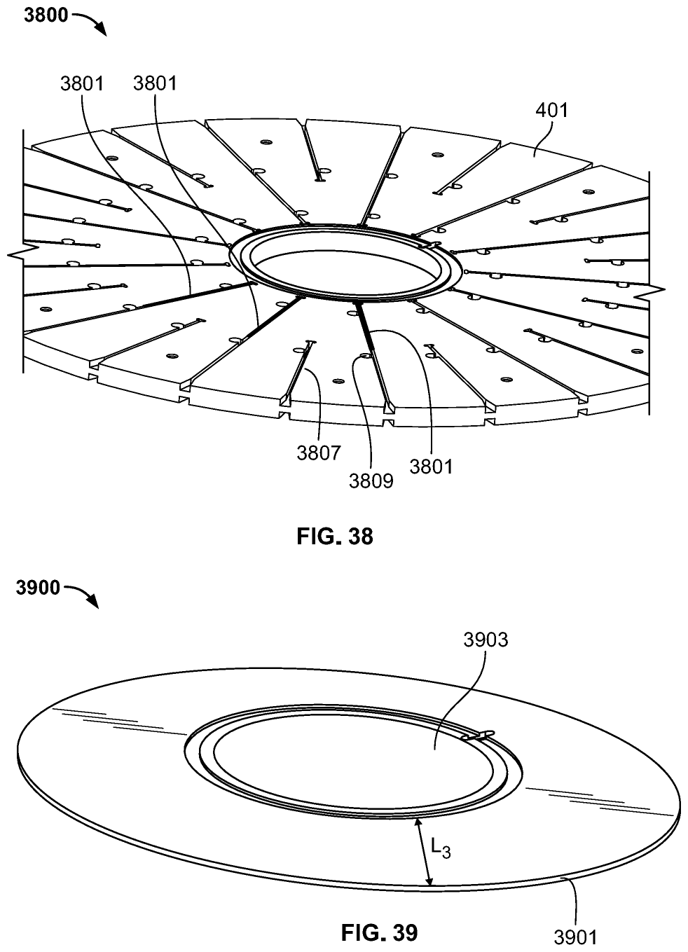

FIG. 38 shows illustrative apparatus 3800. Apparatus 3800 includes stoppers 3801. Stoppers 3801 have been inserted into channels 423 in platform 401. Stoppers 3801 shorten channels 423 such that they have a shorter length 903 of channels 425. Stoppers 3801 fill a segment of channels 423 such that an extension of an item carrier cannot be inserted further into channel 423.

FIG. 39 shows shortening member 3900. Shortening member 3900 has an aperture 3903 that slips over a conduit, such as conduit 407. When shortening member 3900 may be positioned on face 902 of platform 401. When shortening member 3900 lies on face 902, edge 3901 may stop an extension of an item carrier from being inserted further into channel 423. Length L₃ may be uniform around a circumference of shortening member 3900. Length L₃ may be varied to provide different shortening distances for different channels 423 on face 902. A single shortening member 3900 may include varying lengths L₃ about a perimeter of shortening member 3900.

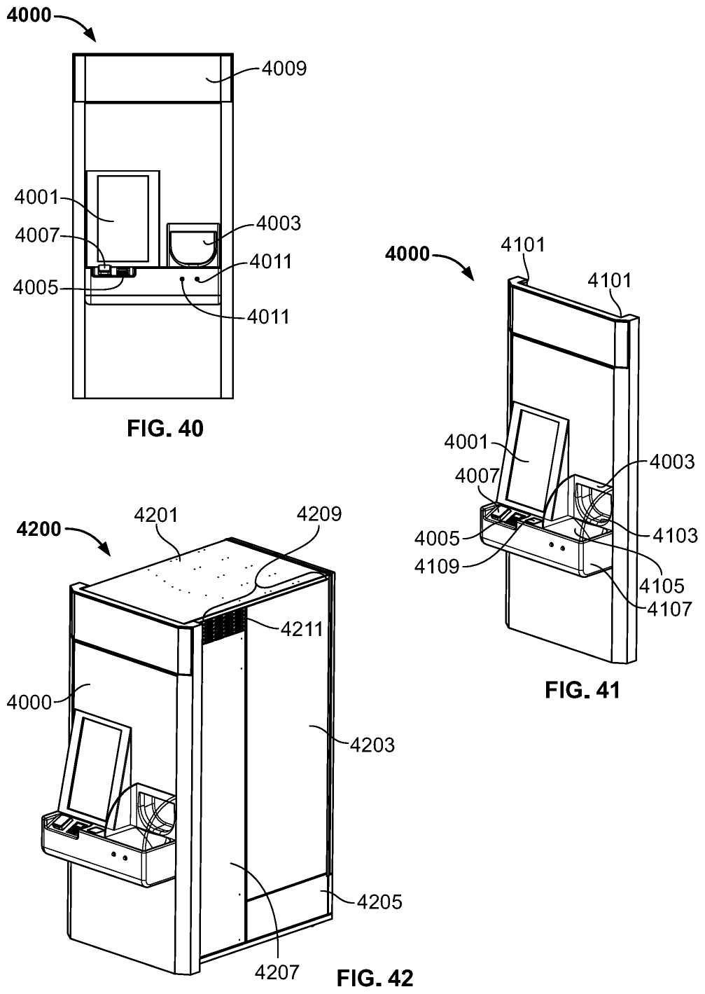

FIG. 40 shows illustrative façade 4000. Façade 4000 may couple to the housing to form part of the housing. Façade 4000 may include branding positioned anywhere on façade 4000. An exemplary position for branding may be top portion 4009 of façade. The branding may include any suitable information, such as information identifying a company whose items are stored within the housing.

Façade 4000 may include customer interface 4001. Customer interface 4001 may interface with a customer and/or a customer's mobile device. Customer interface 4001 may be in communication with remote data center 111 and the vending assembly computing unit. Façade 4000 may include payment processing device and/or card reader 4007 and keypad 4005. Façade 4000 may include vend depot 4003. Vend depot 4003 may receive an item dispensed from the storage frame. The dispensing of an item from an item carrier may include removing the item from the storage cabinet, passing the item through the access cabinet, and dispensing the item into vend depot 4003. A customer may retrieve the item by lifting a door positioned on the vend depot.

Façade 4000 may include retractable bag hooks 4011. A customer may use one or more retractable bag hooks 4011 to hold their bags as they load their items into the bags. FIG. 41 shows a different view of façade 4000 illustrated in FIG. 40. Sides of the housing may fit into corners 4101 of façade 4000. Façade may include barcode scanner 4109 for reading coupons and ID barcodes displayed on mobile devices. Barcode scanner 4109 may support scanning of 1-dimensional and 2-dimensional barcodes.

Vend depot 4003 may include opening 4103. Opening 4103 may pass between the access cabinet and vend depot 4003. Opening 4103 may allow for a dispensed item to pass from access cabinet and into vend depot 4003.

Vend depot 4003 may include door 4105. Door 4105, when opened, may give a customer access to an item positioned in vend depot 4003. Opening door 4105 may simultaneously restrict or seal off access to the access cabinet.

Platform 4107 may be integral to, and extend away from, façade 4000. Platform 4107 may support customer interface 4001, vend port 4003, and other apparatus included in façade 4000.

FIG. 42 shows illustrative housing 4200 for vending an item. Housing 4200 may include roof 4201, façade 4000 (illustrated above at FIGS. 40 and 41) and side 4209. Side 4209 may comprise two or more panels. Side 4209 may include panel 4207. Panel 4207 may enclose a portion of the access cabinet. Side 4209 may include panel 4203. Panel 4203 may enclose a portion of the storage cabinet. When the storage cabinet is temperature controlled, panel 4203 may be insulated. Side 4209 may include panel 4205. Panel 4205 may be positioned below the storage cabinet. Panel 4205 may enclose a portion of the rotation mechanisms. Housing 4200 may include a second side opposite side 4209. The second side may have the same features as side 4209. The second side may have one or more features in common with 4209. Housing 4200 may include vent 4211.

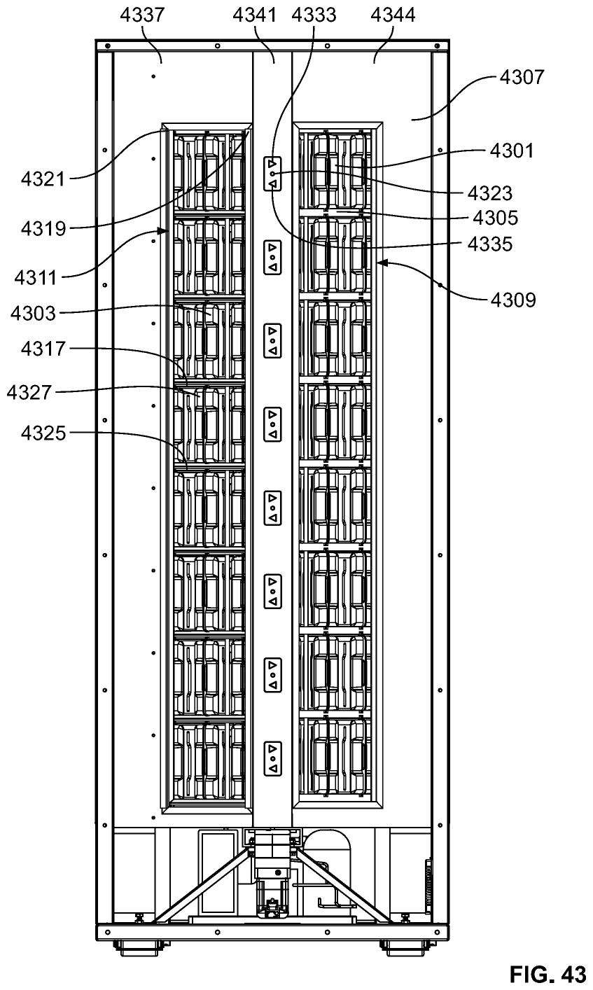

FIG. 43 shows a face of partition 4307 positioned in the access cabinet. Partition 4307 may define first entryway 4309 and second entryway 4311. A door (not shown) may be coupled to partition 4307 such that the door, when closed, covers first entryway 4309. When the storage cabinet is temperature controlled, the door, when closed, may seal first entryway 4309. The door may seal first entryway 4309 so that air cannot pass between the storage cabinet and the access cabinet.

Partition 4307 may be formed from first panel 4337, middle panel 4341, and second panel 4344. First panel 4337, middle panel 4341, and second panel 4344 may be fixed together to form partition 4307.

Partition 4307 may be formed from a single sheet of material.

Partition 4307 may include status displays 4323. Middle panel 4341 may include status displays 4323. Status displays 4323 may extend along, and between, lengths of the first and second entryways. Each status display 4323 may be positioned adjacent item carriers arranged on one of the platforms included in the storage frame inside the storage cabinet. Each status display 4323 may be associated with the one of the platforms. Each status display 4323 may be configured to display information about an item in an item carrier that, at the time of the display, is removable from the platform associated with the status display. The item may be removable from the platform through the first entryway.

Status display 4323 may be associated with platform 4305. Item carrier 4301 may be removable from platform 4305 through first entryway 4309. Thus, when the door is open and the item carriers are in the illustrated configuration, status display 4323 may display information relating to an item within item carrier 4301.

Status displays may display information stored locally on the vending machine in the vending assembly computing unit. Status displays may display information retrieved from remote data center 111.

Partition 4307 may include index buttons 4335 and index buttons 4333. Index buttons 4335, when pressed, may move the storage frame to the left. Index buttons 4333, when pressed, may move the storage frame to the right. After the storage frame is finished rotating, status displays 4323 may update their displayed information to correlate with item(s) in a different item carrier that is now removable from its associated platform.

Status displays 4323 may display the information only when the door is opened, revealing the first entryway.

The second entryway 4311 may include first U-shaped channel 4321 and second U-shaped channel 4319. Edges of the roll-up panel may be seated in channels 4321 and 4319.

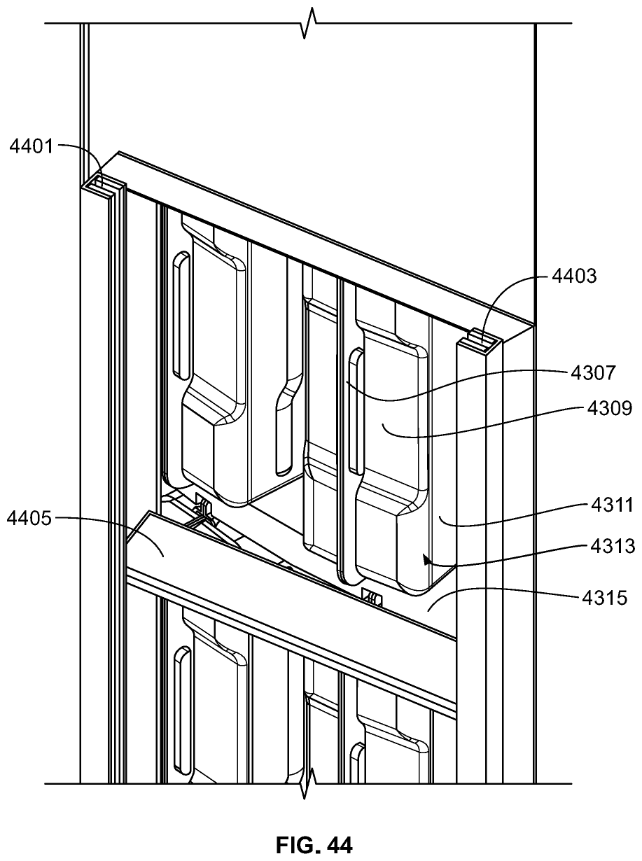

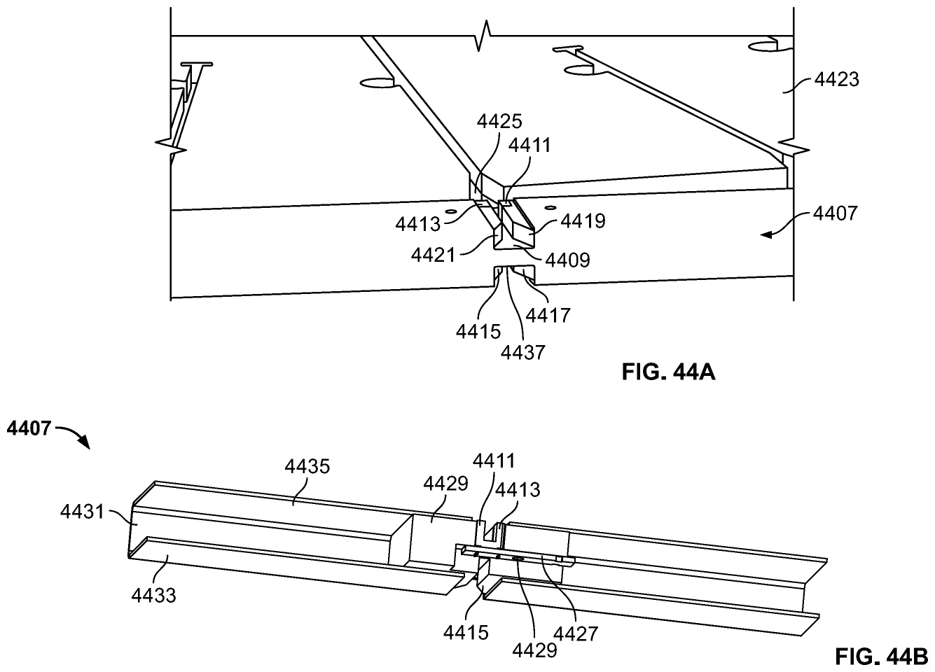

Partition 4307 may include struts 4407 extending across the first entryway (shown in FIG. 44A). Each strut 4407 may be positioned adjacent a platform on the storage frame. Each strut 4407 may be positioned adjacent an outer circumference of a platform on the platforms. Each strut 4407 may include an angled opening aligned with an extension extending along a bottom of an outer shell of an item carrier on the adjacent platform. When an item carrier is withdrawn through the first entryway, the angled opening may provide clearance for the extension so that the entire item carrier, including the inner and outer shell, can be removed through the first entryway.

Partition 4307 may include struts extending across second entryway 4311, such as strut 4317 and strut 4325. Each of the struts may be positioned adjacent a platform on the storage frame. Each strut may be positioned adjacent an outer circumference of a platform on the platforms. Each strut may be positioned such that it is aligned with an extension extending along a bottom of an outer shell of an item carrier on the adjacent platform. When an item carrier is withdrawn through the second entryway, the extension on the bottom of the item carrier's outer shell may abut a strut. This may stop any further motion of the outer shell away from the platform on which the item carrier is seated.

Struts extending across the first entryway, such as struts 4407, may be referred to in the alternative as permissive struts. Struts extending across the second entryway, such as struts 4317 and 4325, may be referred to in the alternative as blocking struts.

Strut 4317 may be positioned such that, when item carrier 4303 is advanced away from the platform on which it is seated, an extension extending along a bottom of item carrier 4303 will abut strut 4317. This abutment may prevent any further motion of an outer shell of item carrier 4303 (which includes the extension) through the second entryway and away from the platform on which it is resting.

Strut 4325 may be positioned such that, when item carrier 4327 is advanced away from the platform on which it is resting, an extension extending along a bottom of item carrier 4327 will abut strut 4325. This abutment may prevent any further motion of an outer shell of item carrier 4327 (which includes the extension) through the second entryway and away from the platform on which it is resting.

FIG. 44 shows U-shaped channel 4401 and U-shaped channel 4403. U-shaped channels 4401 and 4403 may receive edges of the roll-up panel.

FIG. 44 also shows strut 4405. When the gripper clasps on to extension 4307 of item carrier 4313 and starts to pull item carrier 4313 away from platform 4315, an extension on a bottom of outer shell 4311 may abut strut 4405. This abutment may prevent additional movement of outer shell away from platform 4315. However, strut 4405 may provide clearance for inner shell 4309 to advance across strut 4405 and into the access cabinet. Advancement of inner shell 4309 into the access cabinet while restricting movement of outer shell 4311 may allow for dispensing of item I in inner shell 4309 through an orifice defined by a bottom face of inner shell 4309.

FIG. 44A shows illustrative strut 4407. Strut 4407 may extend across a width of first entryway 4309. Strut 4407 may be positioned adjacent platform 4423 of a storage frame. Strut 4407 may be positioned adjacent to, and not come into contact with, platform 4423. Clearance between strut 4407 and platform 4423 may be sized such that when the storage frame is rotated, there is no abutment between the storage frame, or items stored on the storage frame, and strut 4407. Exemplary clearance may be 8 mm, 3 mm, 5 mm, 7 mm, 10 mm, or any other suitable value.

First entryway 4309 may include a plurality of struts 4407. Each strut 4407 included in the plurality may extend across a width of first entryway 4309. Each strut 4407 may extend across the width of first entryway 4309 so that, when a storage frame is positioned in the storage cabinet, each strut is adjacent one of the platforms on the storage frame.

Strut 4407 may include angled entryway 4409. Angled entryway may include first side 4421 and second side 4419. First side 4421 and second side 4419 may together define walls of angled entryway 4409 such that angled entryway 4409 guides an outer extension positioned on a bottom of an item carrier into channel 4425 onto platform 4423. Strut 4407 may include angled entryway 4437. Angled entryway 4437 may include first side 4415 and second side 4417. First side 4415 and second side 4417 may together define walls of angled entryway 4437 such that angled entryway 4437 guides an outer extension positioned on a top of an item carrier onto a channel on a bottom of platform 4423 (not shown).

Strut 4407 may include a through-beam sensor. The through-beam sensor may be an optical sensor, a photoelectric sensor or any other suitable sensor. The through-beam sensor may comprise first element 4413 and second element 4411. First element 4413 may be a transmitter and second element 4411 may be a receiver. First element 4413 may be a receiver and second element 4411 may be a transmitter.

A beam emitted by the through-beam sensor may be broken when an item carrier is removed from platform 4423. The beam may be broken by an outer extension of an item carrier entering angled entryway 4409. The beam of light may be visible light. The beam of light may be infrared light.

When the through-beam sensor detects that an item carrier has been removed, the through-beam sensor may transmit this data to the vending assembly computing unit. A motion controlled encoder may continually map an angle of the storage frame. Knowledge of the angle of the storage frame and the position of the channels on the storage frame may enable the computing unit to know from which channel on platform 4423 the item carrier was removed.

When the through-beam sensor detects that an item carrier has been removed, the vending assembly may store this data locally at the vending assembly on the vending assembly computing unit. The data may also, or instead, be transmitted to the remote data center 111. After the door hinged to the first entryway is closed, an inventory scan may be initiated.

The scan may only scan item carriers located on positions for which the through beam has been tripped. The scan may scan all the item carriers in the storage frame. The scan may read the item carrier data record on each of the item carriers. The data may then be sent to remote data center 111. The data may be stored locally on the vending assembly computing unit.

FIG. 44B shows strut 4407. Strut 4407 may include first elongated member 4435 and second elongated member 4433 spaced apart from first elongated member 4435. Strut 4407 may include third elongated member 4431. Third elongated member 4431 may extend between a first edge of first elongated member 4435 and a second edge of second elongated member 4435. The first, second and third elongated members may together define channel.

Strut 4407 may include block 4429 positioned inside the channel. Block 4429 may include first side 4421 and second side 4419, defining walls of angled entryway 4409. Block 4429 may include first side 4415 and second side 4417, defining walls of angled entryway 4437. Block 4429 may include printed circuit board (“PCB”) chip 4427. PVC chip 4427 may include temperature sensor 4429. Temperature data read by temperature sensor 4429 may be stored locally by the vending assembly computing unit.

When the first entryway includes a plurality of struts 4407, each strut being positioned adjacent a platform on a storage frame, the vending assembly computing unit may be able to track a temperature adjacent each of the platforms via temperature sensors 4409 embedded in struts 4407. Measured temperature data may be used to determine when to rotate the storage frame to reduce or eliminate temperature stratification inside the storage frame.

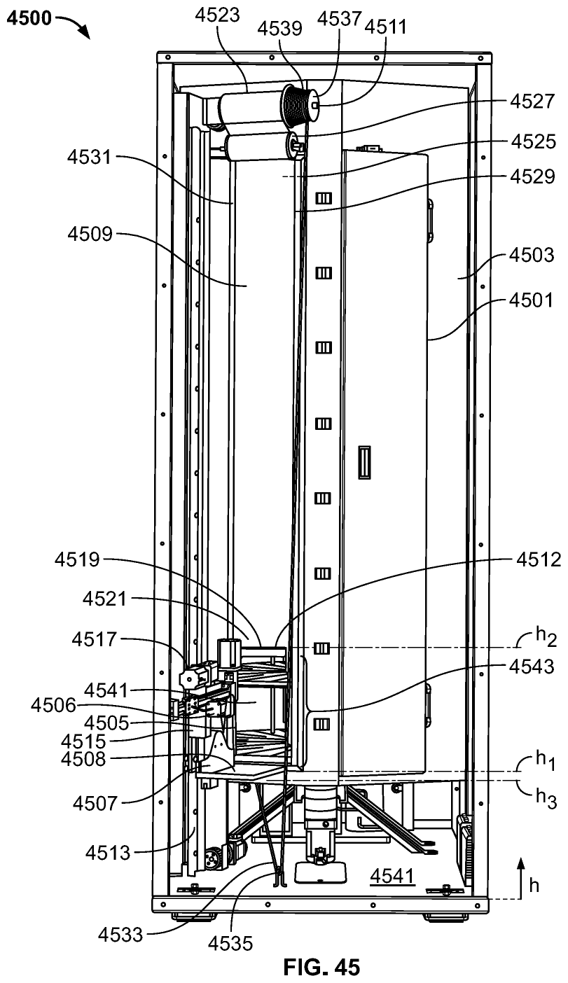

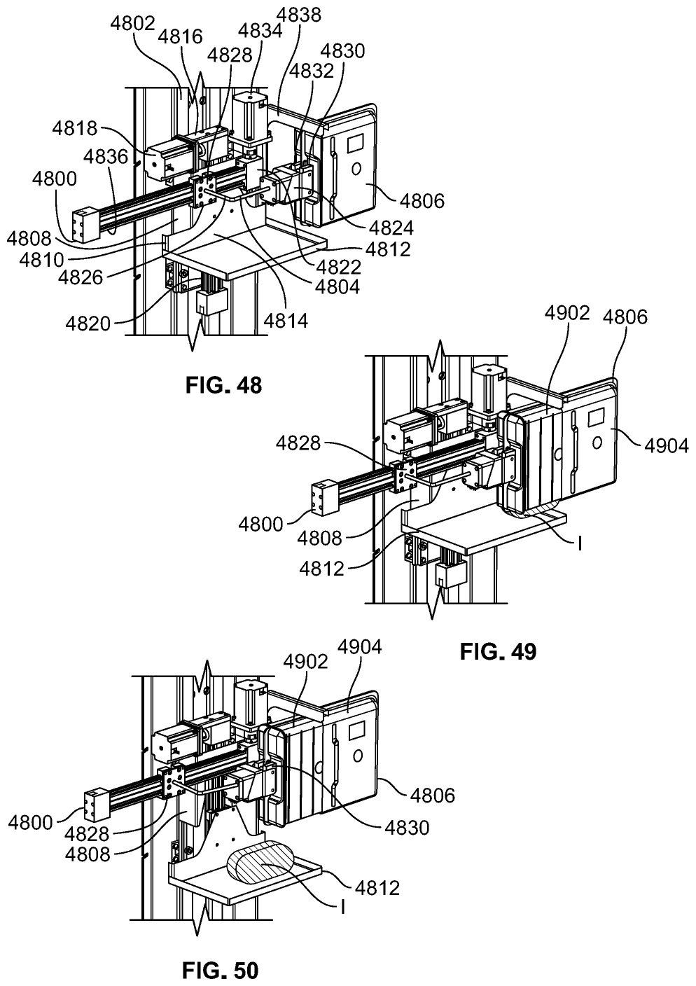

FIG. 45 shows illustrative vending assembly 4500. Vending assembly 4500 may have one or more features in common with one or more of vending assemblies 105, (shown in FIG. 1) 200, 300, and any other vending assembly illustrated and described herein. Vending assembly 4500 is illustrated from the front side with the façade removed. Vending assembly 4500 may include door 4501 for loading item-filled carriers. Vending assembly 4500 may include partition 4503 for maintaining an environment inside the storage cabinet. Partition 4503 may include second entryway 4505 for dispensing items from the insulated enclosure to elevator 4507. Elevator 4507 may include a gripper (not shown) for manipulating an item carrier to release an item onto platform 4508. The gripper may be mounted on controller box 4506. (An elevator in FIGS. 48-50 is illustrated in more detail.)

Roll-up panel 4509 may cover some or all of second entryway 4505 that is not being used for dispensing from carrier station 4541. Roll-up panel 4509 may extend and retract from roller 4511 (right-hand support not shown). Elevator 4507 may be translated up and down along track 4513 by sliding engagement of trolley 4515 with track 4513. Motor 4517 may drive the translation by engagement of a drive wheel or cog with track 4513.

Elevator 4507 may support crosspiece 4519. Roll-up panel 4509 may be attached to crosspiece 4519 at roll-up panel end 4521.

As elevator 4507 translates downward, crosspiece 4519 may draw roll-up panel 4509 down from roll 4523 as roll 4523 rotates counterclockwise (viewed from the right). Roll-up panel 4509 may be held flush against entryway 4505 at the top 4525 of entryway 4505 by guide cylinder 4527. Roll-up panel 4509 may be held flush against entryway 4505 by vertical tracks 4529 and 4531 that run along edges of entryway 4505. Crosspiece 4519 may hold roll-up panel 4509 flush against the edges and may support roll-up panel 4509 in span across the entryway between the edges as roll-up panel end 4521 moves translates or is at rest at a carrier station.

Rigging 4533 may be fastened to elevator 4507. Rigging 4533 may be fastened to roll-up panel end 4521. Rigging 4533 may be redirected to roller 4511 by pulley 4535. Rigging 4533 may be led to roller 4511 on an opposite side of roller 4511 from the side to which roll-up panel 4509 is led. When roller 4511 pays out from roll 4523, roller 4511 takes up on rigging 4533. Rigging 4533 may reduce slack in roll-up panel 4509. Rigging 4533 may maintain tension in roll-up panel 4509. Rigging 4533 may help maintain roll-up panel 4509 in a flat form that conforms to entryway 4529. Rigging 4533 may include along its length a spring (not shown). The spring may help reduce slack. The spring may help maintain tension.

Roller 4511 may include tapered spool 4537, to which rigging 4533 is led. Tapered spool 4537 may be fixed against rotation relative to roller 4511. Tapered spool 4537 may be monolithic with roller 4511. As roller 4511 pays out roll-up panel 4509, roll 4523 will decrease in diameter. Thus, as elevator 4507 moves away from roller 4511, the angular velocity of roller 4511 will increase. Tapered spool 4537 compensates for the increased angular velocity by moving rigging 4533 to a smaller diameter to avoid taking up rigging too quickly and overstressing roll-up panel 4509. Tapered spool 4537 may include helical groove 4539. Helical groove 4539 may be configured to maintain rigging 4533 in a single-layer wrap during payout and takeup. The helix of helical groove 4539 may be configured to move the payout or takeup point of rigging 4533 to a higher or lower diameter to compensate for the changing angular velocity of roller 4511. The diameter at which a center of thickness of the panel separates from the roll during payout or takeup of the roll is a roll “working diameter.” The diameter at which a center of thickness of the rigging separates from the tapered spool during payout or takeup of rigging 4533 is a tapered spool “working diameter.”

As elevator 4507 translates upward, crosspiece 4519 may draw rigging 4533 down from roller 4511 as roll 4523 rotates clockwise (viewed from the right). Roll-up panel 4509 may be held flush against entryway 4505 at the top 4525 of entryway 4505 by guide cylinder 4527. Roll-up panel 4509 may be held flush against entryway 4505 by vertical tracks 4529 and 4531 that run along edges of entryway 4505. Crosspiece 4519 may hold roll-up panel 4509 flush against the edges and may support roll-up panel 4509 in span across the entryway between the edges as roll-up panel end 4521 moves translates or is at rest at a carrier station.

When roller 4511 takes up at roll 4523, roller 4511 pays out rigging 4533. Rigging 4533 may reduce slack in roll-up panel 4509. Rigging 4533 may maintain tension in roll-up panel 4509. Rigging 4533 may help maintain roll-up panel 4509 in a flat form that conforms to entryway 4529.

As roller 4511 takes up roll-up panel 4509, roll 4523 will increase in diameter. Thus, as elevator 4507 moves toward roller 4511, the angular velocity of roller 4511 will decrease. Tapered spool 4537 compensates for the decreased angular velocity by moving rigging 4533 to a larger diameter to avoid losing tension in roll-up panel 4509. Tapered spool 4537 may include helical groove 4539. Helical groove 4539 may be configured to maintain rigging 4533 in a single-layer wrap during payout and takeup. The helix of helical groove 4539 may be configured to move the payout or takeup point of rigging 4533 to a higher or lower diameter to compensate for the changing angular velocity of roller 4511.

In the configuration shown, platform 4508 of elevator 4507 is positioned at height h₁ above floor 4541 of vending assembly 4500. Edge 4512 of crosspiece 4519 is positioned at height h₂ above floor 4510. Open window 4543 is positioned at carrier station 4541. h₁ is higher than h₃, the bottom of partition 4503.

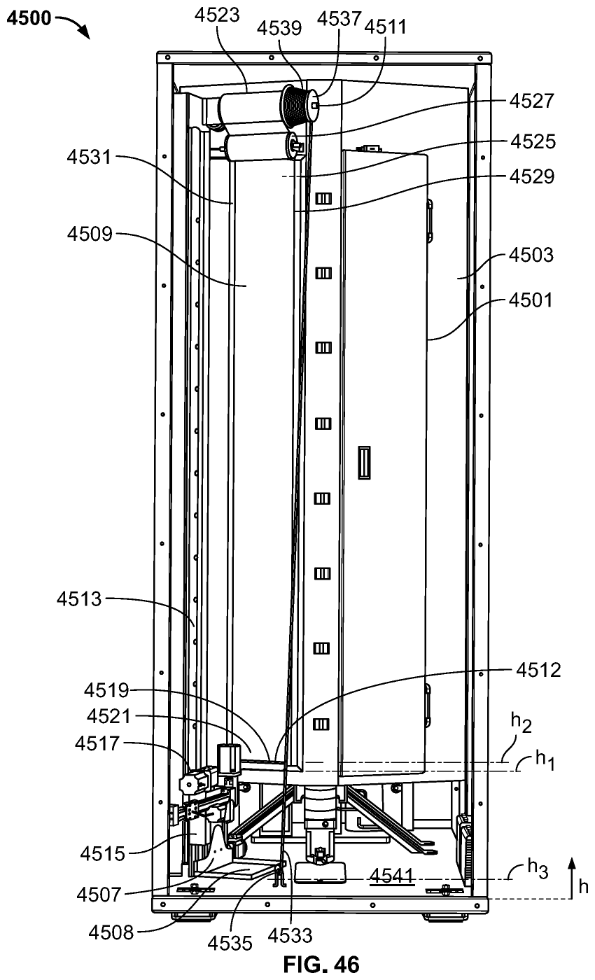

FIG. 46 shows vending assembly 4500 with elevator crosspiece 4519 at h₁ such that roll-up panel 4509 covers all carrier stations, including bottom carrier station 4541.

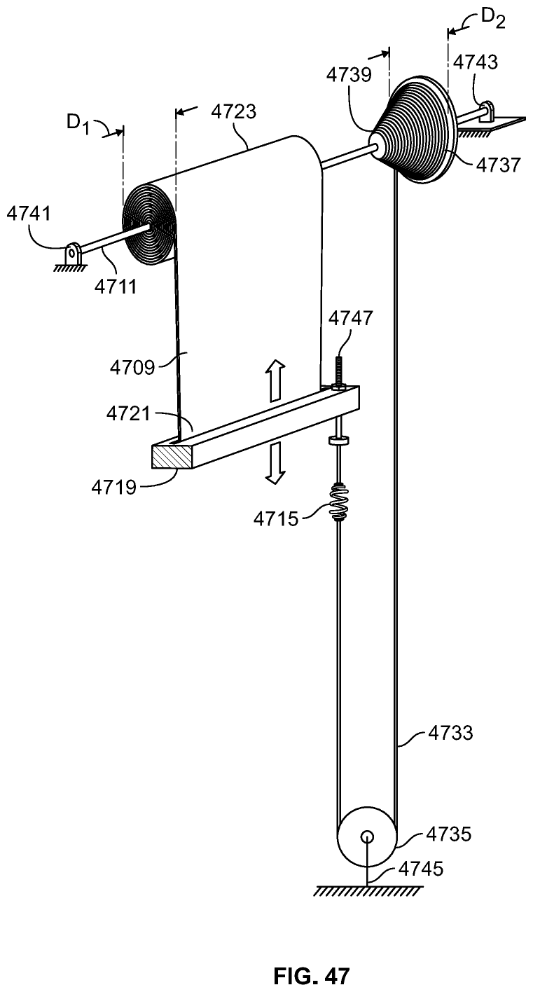

FIG. 47 shows illustrative roll-up panel arrangement 4700. Roll-up panel arrangement 4700 may have one or more features in common with apparatus shown in FIG. 45.

Roll-up panel 4709 may extend and retract from roller 4711 (right-hand support not shown).

Crosspiece 4719 may be fixed to an elevator such as 4507 (shown in FIG. 45). Roll-up panel 4709 may be attached to crosspiece 4719 at roll-up panel end 4721.

As the elevator translates downward, crosspiece 4719 may draw roll-up panel 4709 down from roll 4723 as roll 4723 rotates clockwise (viewed from the left).

Rigging 4733 may be fastened to elevator 4707. Rigging 4733 may be fastened to roll-up panel end 4721. Rigging 4733 may be redirected to roller 4711 by control 4735. Rigging 4733 may be led to roller 4711 on an opposite side of roller 4711 from the side to which roll-up panel 4709 is led. When roller 4711 pays out from roll 4723, roller 4711 takes up on rigging 4733. Rigging 4733 may reduce slack in roll-up panel 4709. Rigging 4733 may maintain tension in roll-up panel 4709. Rigging 4733 may help maintain roll-up panel 4709 in a flat form that conforms to an entryway. Rigging 4733 may include along its length spring 4715. Spring 4715 may help reduce slack. The spring may help maintain tension.

Roller 4711 may include tapered spool 4737, to which rigging 4733 is led. As roller 4711 pays out roll-up panel 4709, roll 4723 will decrease in diameter. Thus, as the elevator moves away from roller 4711, the angular velocity of roller 4711 will increase. Tapered spool 4737 compensates for the increased angular velocity by moving rigging 4733 to a smaller diameter to avoid taking up rigging too quickly, which may overstress roll-up panel 4709. Tapered spool 4737 may include helical groove 4739. Helical groove 4739 may be configured to maintain rigging 4733 in a single-layer wrap during payout and takeup. The helix of helical groove 4739 may be configured to move the payout or takeup point of rigging 4733 to a higher or lower diameter to compensate for the changing angular velocity of roller 4711. Diameter D1 is a working diameter (“roll working diameter”) of the 4723 at which a center of thickness of the panel separates from the roll during payout or takeup of roll 4723. Diameter D2 is a working diameter (“tapered spool working diameter”) at which a center of thickness of the rigging separates from tapered spool 4737 during payout or takeup of rigging 4733 is a tapered spool “working diameter.”

As elevator 4707 translates upward, crosspiece 4719 may draw rigging 4733 down from roller 4711 as roll 4723 rotates counterclockwise (viewed from the left).

When roller 4711 takes up at roll 4723, roller 4711 pays out rigging 4733. Rigging 4733 may reduce slack in roll-up panel 4709. Rigging 4733 may maintain tension in roll-up panel 4709. Rigging 4733 may help maintain roll-up panel 4709 in a flat form that conforms to entryway 4729.

As roller 4711 takes up roll-up panel 4709, roll 4723 will increase in diameter. Thus, as elevator 4707 moves toward from roller 4711, the angular velocity of roller 4711 will decrease. Tapered spool 4737 compensates for the decreased angular velocity by moving rigging 4733 to a larger working diameter to avoid losing tension in roll-up panel 4709. Tapered spool 4737 may include helical groove 4739. Helical groove 4739 may be configured to maintain rigging 4733 in a single-layer wrap during payout and takeup. The helix of helical groove 4739 may be configured to move the payout or takeup point of rigging 4733 to a higher or lower diameter to compensate for the changing angular velocity of roller 4711.

Supports 4741 and 4743 may support roller 4711. Supports 4741 and 4743 may be fixed, above the top platform of the storage frame, to the vending assembly. Support 4745 may support controller 4735. Support 4745 may be fixed, below the bottom platform of the carrousel, to the vending assembly. Supports 4741 and 4743 may be fixed, below the bottom platform of the storage frame, to the vending assembly. Support 4745 may be fixed, above the top platform of the carrousel, to the vending assembly. Roll 4723 and tapered spool 4737 may be provided on separate rollers. Their respective rollers may be mechanically linked by a gear or gears. If the gears cause a difference of rotational direction of roll 4723 and tapered spool 4737, roll 4723 and tapered spool 4737 may be led from the same side.

Fastener 4747 may attach rigging 4733 to crosspiece 4719. Fastener 4747 may be threadedly engaged with crosspiece 4719. Turning fastener 4747 may adjust the tension in the working length. Support 4745 may have an adjustable length. Adjusting the length of support 4745 may adjust the tension in the working length. Support 4745 may be configured to be disposed in different positions. Changing the position of support 4745 may adjust the tension in the working length. Leading rigging 4733 at tapered spool 4737 at a different initial working diameter may adjust the tension in the working length.

FIG. 48 shows illustrative elevator 4800. Elevator 4800 may be slidingly engaged with vertical track 4802. Vertical track 4802, and apparatus coupled to vertical track 4802, may together form a structure that may be mounted into the vending assembly.

Track 4802 may be mounted onto a frame such as partition 4503 (shown in FIG. 45) in a vending assembly such as vending assembly 105 (shown in FIG. 1), vending assembly 200, vending assembly 300, or any other vending assembly described herein. Track 4802 be mounted to a wall of the access cabinet in the vending assembly.

Elevator 4800 may include gripper 4804. Gripper 4804 may engage item carrier 4806. Carrier 4806 may be lodged in the storage frame.

A belt drive motor (not shown) may drive a displacement belt (not shown) that may displace elevator mount 4808 in either direction along track 4802. The motor may be fixed to the vending assembly. The belt may form a captured loop that runs alongside or within the track. A processor in the vending assembly may provide displacement instructions to the motor.

Elevator mount 4808 may support platform unit 4810. Platform unit 4810 may include platform 4812. Platform unit 4810 may include platform bracket 4814. Platform unit 4810 may include linear displacement actuator 4816. Actuator 4816 may include a trolley (not shown; behind bracket 4814). Bracket 4814 may be mounted on the trolley. Actuator 4816 may include electric motor 4818. Actuator 4816 may include vertical track 4820. Motor 4818 may translate the trolley along track 4820. This may displace platform unit 4810 up and down along track 4820 relative to mount 4808. When elevator 4800 is positioned at a carrier station for engagement with an item carrier. Mount 4808 may be held in place at the station. Platform 4812 may thus be moved up and down relative to a carrier lodged in the storage frame at the station.

Elevator mount 4808 may support gripper 4804. Gripper 4804 may include gripper head 4824. Gripper 4824 may include support arm 4826. Support arm 4826 may support gripper head 4824. Elevator mount 4808 may support linear displacement actuator 4822. Actuator 4822 may include trolley 4828. Elevator mount 4808 may support electric motor 4834. Elevator mount 4808 may support horizontal track 4836. Motor 4834 may translate trolley 4828 along track 4836. Trolley 4828 may translate gripper 4804 horizontally toward and away from the storage frame above platform 4810. Gripper head 4824 may include opposing actuatable jaws 4830. Jaws 4830 may clamp onto extension segment 4832 of carrier 4806. Gripper 4804 may displace carrier 4806 horizontally. Gripper 4804 may displace an inner shell of carrier 4806 horizontally.

Elevator mount 4808 may support crosspiece 4838, which may be fixed to an end of a roll-up panel (not shown).

The movements of mount 4808, the trolley in platform unit 4810, trolley 4828, jaws 4830, and the storage frame may be coordinated by a processor local to the vending assembly to perform a dispensing operation on a carrier that is logically mapped to a location in the storage frame. The processor may be part of the vending assembly computing unit. The trolley in platform unit 4810 may have one or more features in common with trolley 4828.

Jaws 4830 are shown engaged with the extension segment.

FIG. 49 shows elevator 4800 with trolley 4828 drawn away from inner shell. Jaws 4830 have drawn carrier inner shell 4902 partially out of carrier outer shell 4904 to uncover an opening in the bottom of inner shell 4902. Item I is partially released from carrier 4806 onto platform 4812. Platform 4812 is in an initial item receipt position relative to mount 4808.

Platform 4812 may be moved to a lower position to allow more of item Ito be released onto platform 4812. Elevator 4800 may include a weight sensor (not shown) to detect when platform 4812 bears a threshold weight of item I. The vending assembly processor may receive output from the weight sensor. The vending assembly processor may order a vertically reciprocating movement for platform 4812 to test whether weight of item I is still borne in part by carrier 4806. The reciprocating movement may cause a measured weight to increase. The processor may initiate the reciprocating movement if lowering platform 4812 results in a decreased weight measurement from the sensor. The processor may continue the reciprocating movement until the threshold weight is reached. The weight sensor may be disposed between mount 4808 and platform 4812. The weight sensor may be disposed on platform 4812. The weight sensor may be integrated into platform 4812.

FIG. 50 shows elevator 4800 with item I fully dispensed. Fully dispensing item I may include trolley 4828 being drawn further away from inner shell than in the previous figure (not shown). Fully dispensing item I may include jaws 4830 drawing carrier inner shell 4902 completely out of carrier outer shell 4904 to fully uncover an opening in the bottom of inner shell 4902.

Fully dispensing item I may include jaws 4830 drawing carrier inner shell 4902 partially out of carrier outer shell 4904.

In FIG. 50, Item I is completely released from carrier 4806 onto platform 4812. Platform 4812 is in a lower position, relative to mount 4808, than the initial item receipt position (shown in FIG. 49). Gripper 4824 may release inner shell 4902.

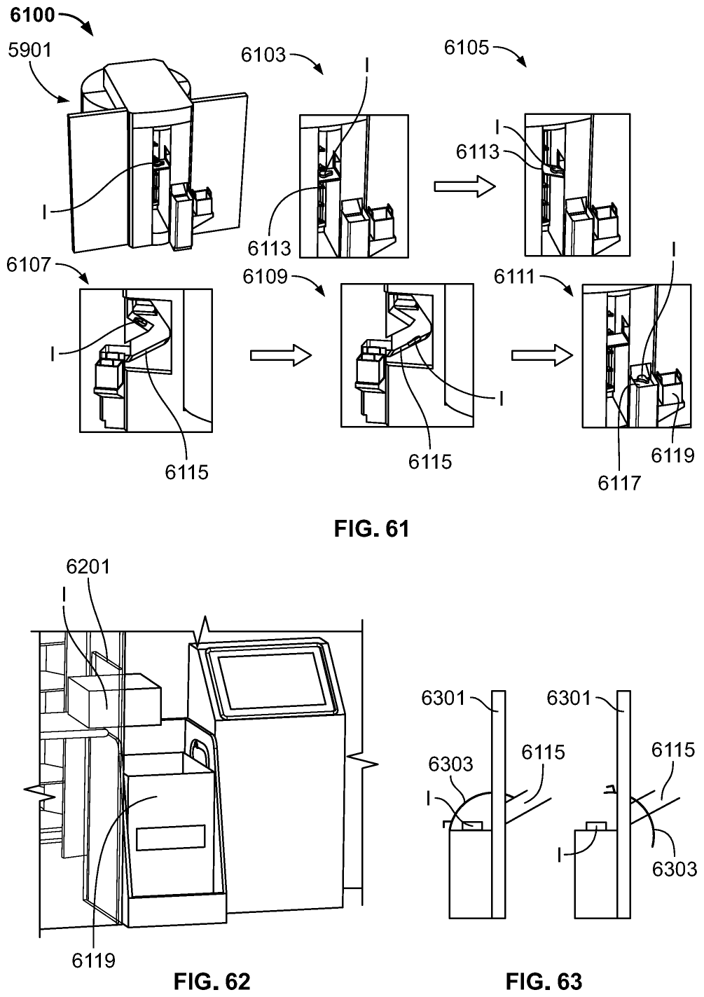

Elevator 4800 may then be translated to the top of a chute included in a delivery port (shown in FIG. 61). At the top of the chute, elevator 4800 may translate platform 4812 past an interfering “tipper” (not shown). The tipper may include a pin. The tipper may include a projection. The tipper may project from the vending assembly into a translation path of platform 4812. Relative motion between the tipper and platform 4812, and interference of the tipper with platform 4812, may cause platform 4812 to pivot about a hinge and deposit item I into the chute. Elevator 4800 may include a 4-bar linkage (not shown) under platform 4812 to allow platform 4812 to pivot in response to the interference. Elevator 4800 may include a tray (not shown) under platform 4812, and hinged to platform 4812 to allow platform 4812 to pivot in response to the interference. Platform 4812 may include a catch (not shown) to provide the interference.

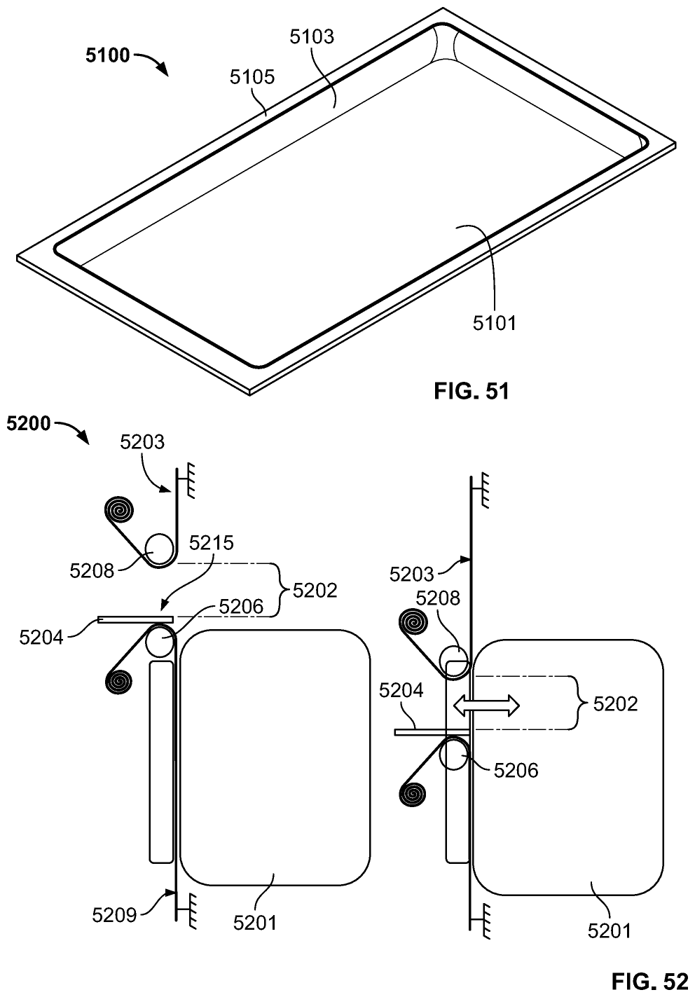

FIG. 51 shows illustrative platform 5100 that may be positioned on platform 4812 to receive an item I. Platform 5100 may include edge 5105, curved portion 5103, and inner compartment 5101. Curved portion 5103 may urge a dispensed item I into curved portion 5103.

FIG. 52 shows schematically illustrative arrangement 5200 for frost management for a frozen environment and/or moisture management for a refrigerated environment such as 5201. Arrangement 5200 may include gap 5202 (shown in one configuration on the left, and a different configuration on the right).

Arrangement 5200 may be used inside an item dispensing assembly, such as the vending assembly. Arrangement 5200 may be used inside any other suitable machine.

The item dispensing assembly may store the items in a refrigerated environment. The item dispensing assembly may store the items in a frozen environment. The item dispensing assembly may store the items in a heated environment.

Arrangement 5200 may include first membrane panel 5203. Arrangement 5200 may include second membrane panel 5209.

Arrangement 5200 may include gap 5202 between panel 5203 and panel 5209. Gap 5202 may be created when an item needs to be dispensed from the storage frame or other storage frame. Arrangement 5200 may be such that it does not have a gap when an item is not being dispensed.

Arrangement 5200 may include item dismount carriage 5204 assembly that defines and/or is positioned within gap 5202 between panel 5203 and panel 5209. Carriage 5204 may have one or more features in common with elevator 4507 (shown in FIG. 45). Carriage 5204 may be configured to travel from a first item storage disc to a second item storage disc. The discs may include platforms in a storage frame. Carriage 5204 may include a hood and a cradle.

When gap 5202 is positioned adjacent an item storage disc from which an item is to be removed, the item dismount mechanism, such as the gripper, may retrieve the item through gap 5202 and transfer the item to a delivery port. The delivery port may be in series with the chute. The delivery port may be inside a frame. The frame may include a first arm, a second arm and an elongated support. The delivery port may include an elevator.

Carriage 5204 may be advanced through gap 5202 prior to removal of an item from the disc.

Carriage 5204 may be continually positioned within gap 5202.

Panel 5203 and panel 5209 may each be a thin, flexible curtain. The curtains may be rolled up at a first end of the curtain and at a second end of the curtain.

Panel 5203 and panel 5209 may be formed from any suitable material.

Arrangement 5200, when not in use, may be kept above the storage frame of the item dispensing assembly. Arrangement 5200, when not in use, may be kept below the item dispensing assembly. Arrangement 5200, when not in use, may be kept adjacent a top portion of the item dispensing assembly. Arrangement 5200, when not in use, may be kept adjacent a bottom portion of the item dispensing assembly.

A first end of the first membrane panel may be mounted above a storage frame in the item dispensing assembly and a first end of the second membrane panel may be mounted below the storage frame in the item dispensing assembly. The second end of the first panel and the second end of the second panel may each be mounted, respectively, on moving structures 5206 and 5208. Positions of moving structures 5206 and 5208 may be controlled by a controller. The controller may be the vending assembly processor. Moving structures 5206 and 5208 may move the second ends of panel 5203 and panel 5209 up and down along a height of the item dispensing assembly. The moving structure may create a gap between the second ends of panel 5203 and panel 5209 to allow dispensing of an item from the item dispensing assembly.

Prior to deployment of arrangement 5200, an insulated door surrounding at least a portion of the storage frame may move to the side. Movement of the insulated door may provide clearance to arrangement 5200 to move along a height of the item dispensing assembly. Panel 5203 and panel 5209 may substantially cover the revealed portion of the storage frame prior to the movement of the insulated door to avoid airflow into, and out of, the storage frame.

A produce cradle and a carrier dismount mechanism may be positioned in gap 5202. Gap 5202 may be positioned adjacent an item storage disc from which an item must be removed. The carrier dismount mechanism may remove the item from the item storage disc, through gap 5202 and into the product cradle.

The item dismount carriage configured to travel from a first item storage disc to a second item storage disc. Arrangement 5200 may include a controller that is configured to control a position of gap 5202 relative to the second item storage disc.

The controller may be configured to control a size of gap 5202. The size of gap 5202 may be constant as arrangement 5200 moves vertically along a height of the item dispensing assembly. The size of gap 5202 may vary as arrangement 5200 extends vertically downwards along the height of the portion of the item dispensing assembly.

Arrangement 5200 may reduce air exchange into and out of the insulated enclosure. Air exchange may be reduced by exposing only a portion of the insulated enclosure to air outside of the item dispensing assembly during dispensing of an item. This is desirable at least because thermal convection currents will be established when the insulated enclosure is opened as a result of the temperature difference between the air inside the insulated enclosure and the air in the access cabinet. Entrance of moisture laden air into the insulated enclosure is not desirable at least because the air will condense inside the insulated enclosure forming liquid, if the air is refrigerated, and forming frost, if the air is frozen.

One or both of panels 5203 and 5209 may have features in common with apparatus shown in FIGS. 45-47.

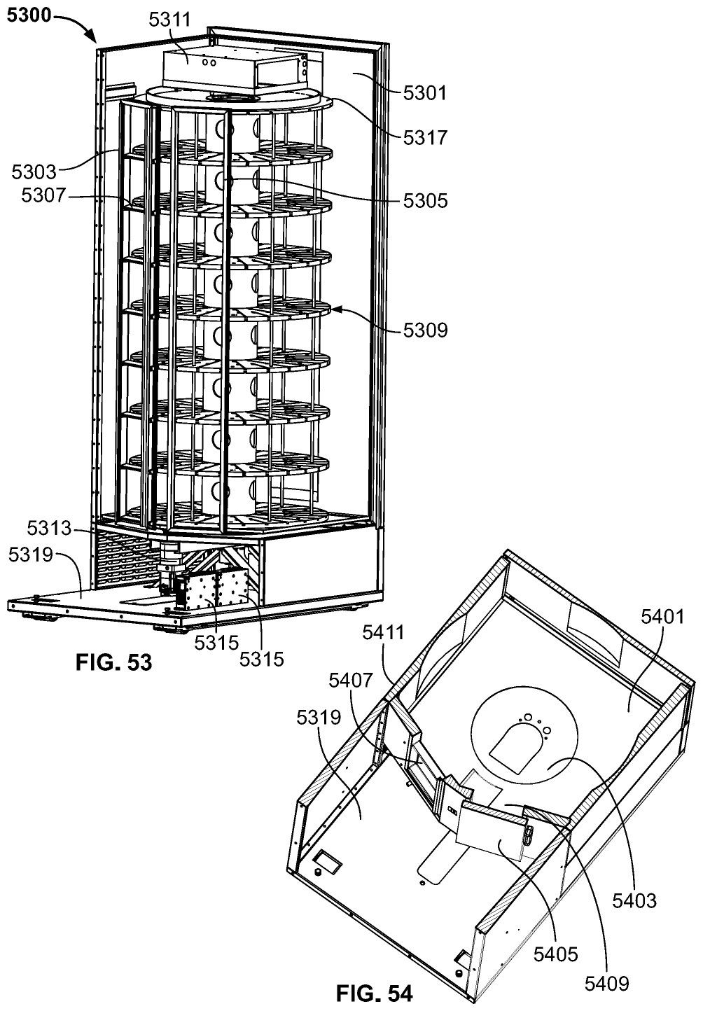

FIG. 53 shows storage frame 5309 positioned in storage cabinet 5301. Plenum 5311 is illustrated above top face 5317 of storage frame 5309. Rotation mechanism 5313 is positioned below storage frame 5309, and motor amplifiers 5315 are positioned on base 5319. In FIG. 53, the first entryway and the second entryway are illustrated. The first entryway may be defined by rectangular frame 5305 extending along a height of storage frame 5309. The second entryway may be defined by rectangular frame 5303 extending along the height of storage frame 5309.

Rectangular frame 5303 may include struts, such as strut 5307 and the U-shaped channels. Each strut may be positioned adjacent an outer circumference of a platform of storage frame 5309 to retain an outer shell of an item carrier (not shown) on the platform while an inner shell of the item carrier is drawn into the access cabinet.

Rectangular frame 5305 may include struts, such as struts 4407 (not shown). Struts 4407 may be positioned adjacent an outer circumference of a platform of storage frame 5309. Struts 4407 may each include an angled opening to provide clearance for an extension of an outer shell of an item carrier. This clearance may allow for removal of the complete item carrier from the storage cabinet.

FIG. 54 shows a sectional view of a bottom portion of the housing (not including the façade) and the partition. The storage cabinet may include bottom 5401. The access cabinet may include bottom 5319. Recess 5403 in bottom 5401 of the storage cabinet may hold plate 607 and a rotation mechanism (illustrated in FIG. 56). After the rotation mechanism has been mounted to bottom 5401 of the storage cabinet, spray foam insulation may be applied to all surrounding areas in bottom 5319 without encroaching on the belt and drive system.

First entryway 5409 is covered by door 5405. Second entryway 5407 includes struts such as strut 5411. First entryway may include struts 4407 (not shown).

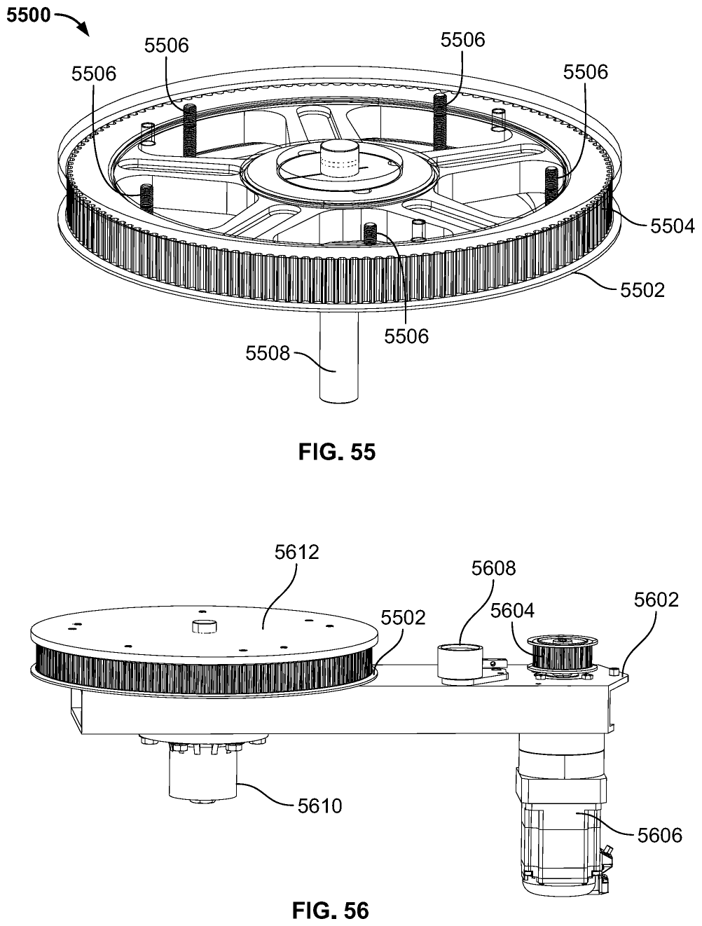

FIG. 55 shows illustrative pulley arrangement 5500 for rotating a storage frame. Pulley arrangement 5500 may include belt pulley 5702. Pulley 5702 may include surface 5704 for receiving torque from a belt (not shown). Pins 5706 may include threaded rod. Pins 5706 may secure the storage frame to pulley 5702. Pulley arrangement 5500 may include shaft 5708 (shown schematically). Shaft 5708 may provide rotational stability to pulley 5702. Shaft 5708 may bear the weight of the storage frame, carriers, and items.

FIG. 56 shows a storage frame rotation mechanism that may include pulley 5702 on bench 5602. Bench 5602 may support drive pulley 5604. Drive motor 5606 may provide torque to drive pulley 5604. Bench 5602 may support tensioning pulley 5608. A drive belt (not shown) that transfers torque from drive pulley 5604 to pulley 5702 may be led around tensioning pulley 5608. Tensioning pulley 5608 may be provided with a sensor to detect a broken belt condition. Shaft 5708 may extend into bearing housing 5610. Plate 5612 may provide support to the storage frame.

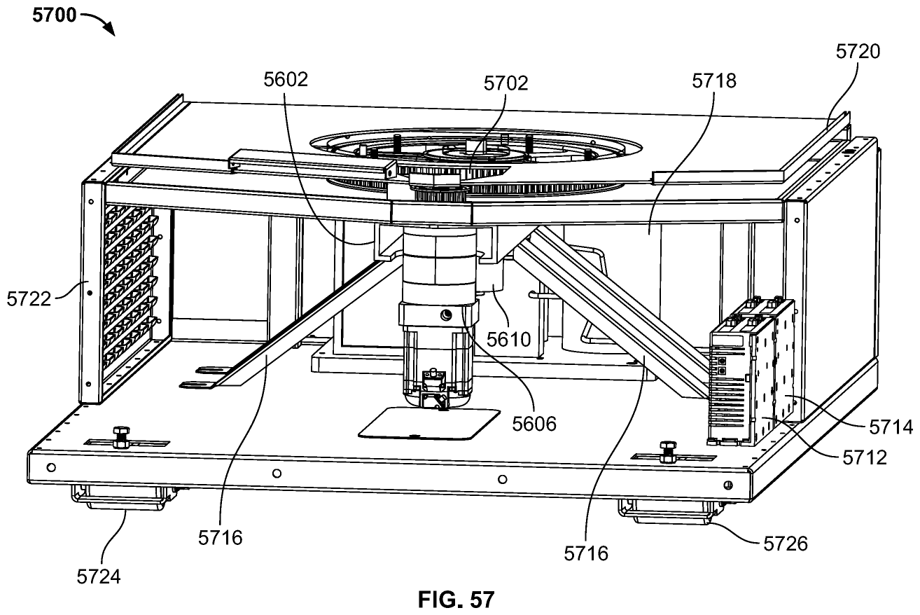

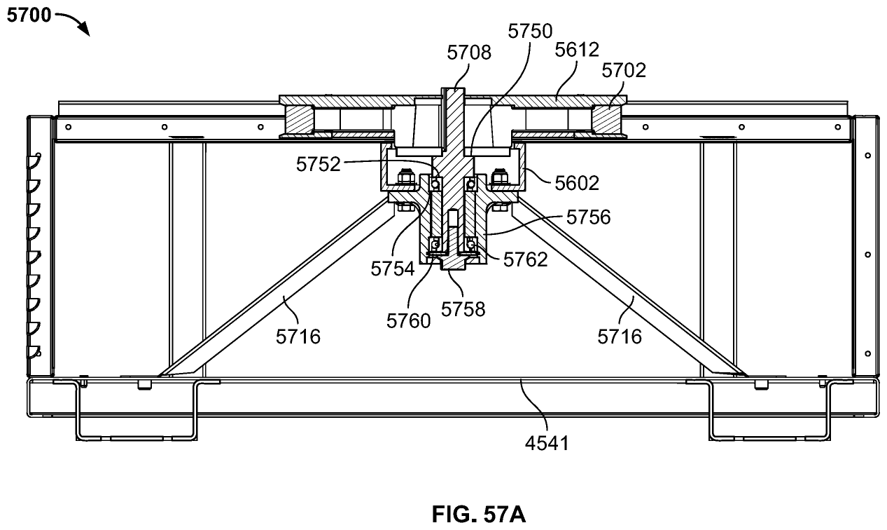

FIG. 57 shows illustrative vending assembly base 5700, in part. The view shown is approximately from the right of bench 5602 as shown in FIG. 56. Base 5700 may include pulley 5702, drive pulley 5604, and other apparatus shown in FIGS. 55 and 56. Angled legs 5716 support bench 5602.

Base 5700 may include thermal pump 5718. Thermal pump 5718 may include a heat source. Thermal pump 5718 may include a heat sink. Thermal pump 5718 is illustrated as a refrigeration system. The refrigeration system may include a refrigerant pump and refrigerant condenser in fluid communication with the evaporator. Thermal pump 5718 may include a controller for communication with the vending machine processor. The processor may provide instructions to the controller to change a rate of refrigerant flow in response to temperature distribution data from the storage frame.

The storage frame may include temperature sensors at different sections of the conduit. Temperature sensors may be on struts 4407. Temperature sensors may be inside the conduit. Temperature sensors may be outside the conduit. Temperature sensors may be on platforms. Temperature sensors may be at any suitable radius of a platform. Temperature sensors may be in an entryway. Temperature sensors may be on struts extending across an entryway.

The vending assembly computing unit may receive temperatures from the temperature sensors. The computing unit may use the temperatures to control one or more factors such as speed of the plenum fan, refrigerant flow rate, storage frame circulating fluid flow rate, refrigerant flow rate, and storage frame rotation rate or direction to reduce undesirable temperature distribution conditions among the carriers.

The computing unit may detect a temperature stratification. For example, cooler temperatures may be detected in lower regions of the storage frame. A threshold stratification may be one or two degrees (F. or C.). Stratification at or near the threshold may trigger a response from the computing unit. The computing unit may be configured to activate control of one or more of the factors to reduce or eliminate the stratification.

As items are loaded or dispensed, the thermal mass distribution of the storage frame may change, even if carriers remain in place after dispensing. The new thermal mass distribution may affect the temperature distribution in the storage frame.

Base 5700 may include enclosure foundation 5720, which may support the enclosure. Base 5700 may include vents such as vent 5722. Base 5700 may include feet such as 5724 and 5726.

Base 5700 may include motor controllers 5712 and 5614. One of the motor controllers may control drive motor 5606. The other may control the elevator motor. Both motor controllers may be controlled by the vending assembly processor.

FIG. 57A shows a partial cross-sectional view of base 5700. Shaft 5708 bears storage frame weight, and weight of any item carriers supported by the storage frame, at shoulder 5750. Flange 5752, which may be conical, of shaft 5708 rests on angle bearing 5754. Angle bearing 5754 rests on bearing housing 5756. Bearing housing 5756 rests on angled legs 5716. Angled legs 5716 rest on vending assembly floor 4541 (shown in FIG. 45).

Compression bolt 5758 stabilizes shaft 5708 at the bottom of bearing housing 5756. Bolt 5758 compresses plate 5760 against angle bearing 5762. Shaft 5708 may rotate relative to bench 5602, bearing housing 5756, legs 5716 and floor 4541.

FIG. 58 shows plenum 5800. Plenum 5800 may include top 5801. Top 5801 may be coupled to a roof of the insulated enclosure. Plenum 5800 may include first opening 5805 and a second opening opposite 5805 (not shown). First opening 5805 and the second opening opposite 5805 may be on sides of plenum 5800. Plenum 5800 may include opening 5803 in a bottom of plenum 5800. Opening 5803 may be positioned above the passageway extending along a longitudinal axis of the storage frame.

A fan positioned in plenum 5800 (not shown) may draw air up from the passageway, through opening 5803 and into plenum 5800. The fan may then push the air out through opening 5805 and an opening opposite opening 5805 (not shown) and down around an exterior of the storage frame.

FIG. 58A shows concentric placement of fixed conduit 5815 and rotating conduit 5817. FIG. 58A shows an illustrative cross-sectional view of plenum 5800 and storage frame 5811. Any of the apparatus described herein including a plenum and a storage frame may include the conduits described below.

A bottom face of plenum 5800 may include fixed conduit 5815. Fixed conduit 5815 may be coupled to plenum 5800. Fixed conduit 5815 may be a rotary coupling conduit. Fixed conduit 5815 may be circular, or any other suitable shape. Fixed conduit 5815 may be fixed in space and may not move.

A bottom face of plenum 5800 may also include fixed conduit 5807. Fixed conduit 5815 and fixed conduit 5807 may be concentric circular ridges, with fixed conduit 5807 positioned inside fixed conduit 5815. Fixed conduit 5807 may be coupled to plenum 5800 such that it is fixed in space and cannot move.

A bottom face of plenum 5800 may not include fixed conduit 5807.

The top face of storage frame 5811 may include rotating conduit 5817. Rotating conduit 5817 may rotate together with storage frame 5811. Rotating conduit 5817 may be circular, or any other suitable shape. When rotating conduit 5817 is circular, rotating conduit 5817 may be concentric with fixed conduit 5815 (and, in some embodiments, fixed conduit 5807). Rotating conduit 5817 may have a smaller radius than fixed conduit 5815. Rotating conduit 5817 may have a larger radius than fixed conduit 5807. Conduits 5815, 5809 and 5807 may be coaxial and define the same mid-point.

Bearings 5809 may be positioned between fixed conduit 5815 and rotating conduit 5817. Bearings 5809 may be positioned between rotating conduit 5817 and fixed conduit 5807.

Bearings 5809 may not be positioned between fixed conduit 5815 and rotating conduit 5817. Bearings 5809 may not be positioned between rotating conduit 5817 and fixed conduit 5807.

A bottom of plenum 5800 may not be in direct contact with storage cabinet 5811. Fixed conduits 5815 and fixed conduit 5807 may not be in directed contact with storage cabinet 5811.

A tortuous path may exist between fixed conduits 5807 and 5815 and rotating conduit 5817. The tortuous path may effectively create a fluid seal when the fan is running. The tortuous path may create a preferred ducting path through passageway 5813, through opening 5803 and out of openings (such as 5805) on sides of plenum 5800 when the fan is running.

The configuration illustrated in FIG. 58A may provide a non-contact configuration between the plenum and the storage frame, with no weight-bearing (between the plenum and the storage frame), low rotational friction and a highly flow restrictive boundary for air-flow leakage through the tortuous path extending between the fixed and rotating conduits.

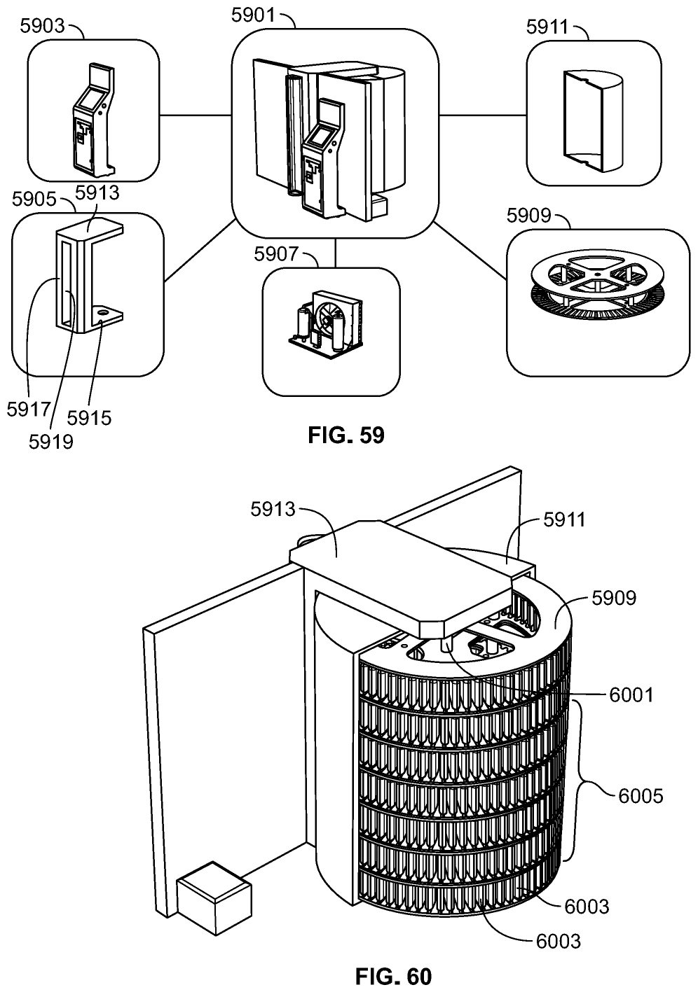

FIG. 59 shows item dispensing assembly 5901. Item dispensing assembly 5901 may be apparatus for dispensing an item. Item dispensing assembly 5901 may include one or more features of apparatus described herein.

Item dispensing assembly 5901 may include a carousel assembly. The carousel assembly may be the storage frame. The carousel assembly may include one or more features of the storage frame. The carousel assembly may store an item, or two or more items. The items may have different sizes and weights. The items may have different prices. The carousel assembly may dispense the items having different sizes, weights and prices. One or more items may be stored in an item container. The item container may be the item carrier.

Item containers supported by the carousel assembly may have the same dimensions. Two or more of the item containers may have different dimensions.

Two or more items stored by item dispensing assembly 5901 may be stored inside the item carrier. Some or all of the items stored by item dispensing assembly 5901 may be stored in one, two, three, five, ten, twenty, thirty, forty, fifty, or any other suitable number of item carriers.

The carousel assembly may include an item storage disc 5909. Item storage disc 5909 may have one or more feature in common with the platform. The carousel assembly include a plurality of item storage discs. The item storage discs may support the items and/or the item containers. The item storage discs may be circular. The item storage discs may be any other suitable shape. Each disc may store two or more items and/or two or more item containers. The item containers may have the same dimensions. Two or more of the item containers may have different dimensions.

The discs may be positioned apart from each other along a central axis of the carousel assembly. The central axis of the carousel assembly may be the longitudinal axis of the carousel assembly. In operation, the item storage discs may rotate about the central axis. The central axis may pass through a midpoint of the discs. The item storage discs may be supported by a frame that, in operation, does not rotate about the axis. The item storage discs may be supported by a frame that, in operation, does rotate about the axis.

An item storage disc may complement a guide feature on the item container. The guide feature may be the channel described herein. A disc may extend in a direction radially away from the central axis.

An item storage disc may include a linear guide. The linear guide may be a channel. The linear guide may complement a guide feature on the item container. The linear guide may extend in a direction radially away from the central axis.

A disc may include a guide support face having a radius. The guide support face may terminate at a location no closer to the axis than the radius. The guide support face and the guide feature may include male/female or female/male interlocking extensions for using in removing the item and/or the item container from the disc.

Item dispensing assembly 5901 may include frame 5905. Frame 5905 may include first arm 5913, second arm 5915, and elongated support 5917 extending from first arm 5913 to second arm 5915. Elongated support 5917 may be vertical. Elongated support 5917 may include an elongated viewing frame 5919. First arm 5913 may be coupled to a top face of the carousel assembly. Second arm 5915 may be coupled to a bottom face of the carousel assembly. An axial member may extend through the discs along the central axis. The axial member may be coupled to first arm 5913 and/or second arm 5915.

The carousel assembly may be supported between first arm 5913 and second arm 5915. The carousel assembly may have a diameter of 6 feet, 5.5 feet, 5 feet, 4.5 feet, 5 feet, or any other suitable diameter. The carousel assembly may have a diameter of 35 inches, 37 inches, 33 inches, 38 inches, or any other suitable diameter.

The carousel may stack onto a drive hub that is located on a bottom of the frame. A sliding collar may secure a top of the carousel to a top of the frame.

The assembly may include housing 5911 positioned about the carousel assembly. Housing 5911 may surround the carousel assembly. Housing 5911 may be insulated. Housing 5911 may assist in maintaining a refrigerated or frozen environment within the carousel assembly. Housing 5911 may be coupled to frame 5905. Housing 5911 may be configured to be coupled to elongated support 5917. Elongated support 5917 may extend vertically along the carousel assembly. Housing 5911 and frame 5905, together, may surround the carousel assembly. Housing 5911 and frame 5905, together, may completely surround the carousel assembly to create an environment in which air enclosed within, and surrounding, the carousel assembly cannot leak out of the assembly.

Housing 5911 may be composed of one, two or more segments. The segments may be configured to be positioned about, and to surround, the carousel. Housing 5911 may be coupled to frame 5905. Housing 5911 may be coupled to frame 5095 using a collar and/or a through pin. The collar may be a clamping collar for compression. The through-pin may be used for alignment.

The assembly may include user control 5903 configured to receive from a user a signal. The signal may include a request to dispense an item stored in the carousel. User control 5903 may be included in a kiosk.

Item dispensing assembly 5901 may be a modular assembly. Frame 5905, carousel assembly, housing 5911, user control 5903 and refrigeration unit 5907 included item dispensing assembly 5901 5901 may be assembled together at a deployment site. The carousel may be assembled from a plurality of stackable item storage discs. Item dispensing assembly 5901, when disassembled, may fit through a doorway having a width of up to 20 in., 28 in., 30 in., 32 in., 38 in., 40 in., or any other suitable doorway width.

An item may be delivered from the assembly into a receptacle using a push/pull mechanism, chute, conveyor, elevator, or any other suitable mechanism. The item may be delivered in a tamper-proof manner.

FIG. 60 shows carousel assembly 6005 coupled to first arm 5913 and positioned in enclosure 5911. Carousel assembly 6005 includes multiple item storage discs 5909. Carousel assembly 6005 may be rotated by central member 6001. Carousel assembly 6005 may support a plurality of item carriers 6003.

FIG. 61 shows illustrative apparatus and methods 6100 for dispensing item I from item dispensing assembly 5901 through a delivery port. The delivery port may be integral to frame 5905. The delivery port may be integral to the elongated support 5917. The delivery port may be included in the housing and may be integral to the façade.

The delivery port may include a first elongated member and a second elongated member spaced apart from the first elongated member to form a channel. The delivery port may guide item I retrieved from within the carousel assembly to receptacle 6119 from which a customer can retrieve item I. A chute within the delivery port may guide the item. Item I may be retrieved from the carousel assembly and placed in the delivery port using an item dismount carriage assembly.

A face of the second elongated member may define a wall of the channel and an intermediate delivery port at the opening of a chute. The chute may pass through the second elongated member to the delivery port in the second elongated member. The chute may be shaped to ensure that foreign objects, such as a limb or a physical device, cannot be advanced through the chute into item dispensing assembly 5901. The delivery port may be outside the channel. The delivery port may include a receptacle outside of the channel and accessible by the customer. The delivery port may move an item into the receptacle, receptacle being separate from the delivery port.

An item may be delivered from the assembly into a receptacle using a push/pull mechanism, chute, conveyor, elevator, or any other suitable mechanism. The item may be delivered in a tamper-proof manner.

At step 6103 an item I may be dispensed from the carousel assembly and positioned on platform 6113. At step 6105 platform 6113 may tilt. At step 6107 item I may be angled toward tortuous path 6116. Step 6107 may illustrate step 6105 at a different angle. At step 6109, item I may be advancing along tortuous path 5115. At step 6911, item I may be received in a bottom portion of delivery port 6117. Item I may be ready to be advanced through the delivery port and into receptacle 6119.

FIG. 62 shows item I being advanced through opening 6201 in a delivery port and into receptacle 6119.

FIG. 63 shows interlocking door 6303. Item dispensing assembly 5901 may include interlocking door 6303. Interlocking door 6303 may be part of structure 6301. Structure 6301 may be the façade. Structure 6301 may be frame 5905.

Interlocking door 6303 may surround a portion of tortuous path 6115 and/or receptacle 6309. Interlocking door 6303 may include a first position and a second position. Interlocking door 6303, in the first position, may cover receptacle 6309 and allow item Ito travel through tortuous path 6115 and into receptacle 6309. Interlocking door 6303, in the second position, may simultaneously block tortuous path 6116 from dispensing any more items I and allow customer access to access receptacle 6309 and any items I therein.

An item I may be delivered from the assembly into the receptacle using a push/pull mechanism, chute, conveyor, elevator, or any other suitable mechanism. The item may be delivered in a tamper-proof manner.

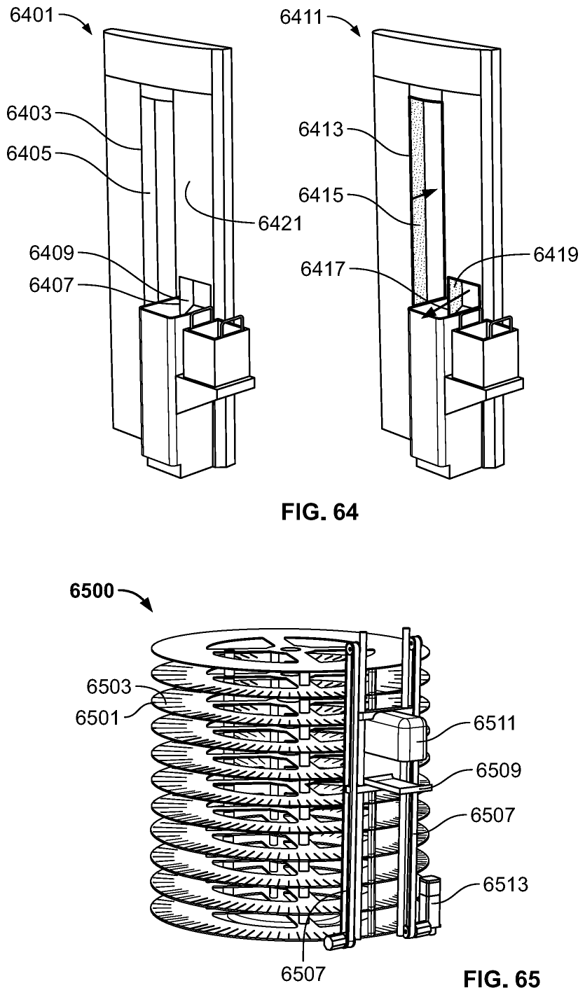

FIG. 64 shows a front portion 6401 of a vending assembly. Front portion 6401 may be a front portion of frame 5905. Front portion 6401 may be a front portion of the housing, such as a front portion of the façade.

Front portion 6401 may include first side 6403, inner thickness 6404 of first side 6403, second side 6421, and inner thickness of second side 6421 (not shown). Front portion 6401 may include dispensing port 6407 and a dispensing station cut-out 6409.

Front portion 6411 may include front portion 6401 and a skin. The skin may be represented by the dotted portions on front portion 6411. The skin may include an elongated monolithic cover. The cover may be configured to engage the front portion at one or more locations. The cover may define one or more of an elongated viewing port such as inner thickness 6404 and an inner thickness of the second side (not shown), dispensing port 6407 and/or a dispensing station cut-out 6409. The skin may be removably coupled to the front portion. The front portion may define a first face and a second face opposite the first face along a central axis of the front portion. The second face may, in operation, be positioned adjacent the carousel assembly. The first face may, in operation, be viewable to a customer. The skin may include a set of mechanical features that couple to the second face. The skin may include a set of mechanical features that couple to the first face.

FIG. 65 shows apparatus 6500 includes a carousel assembly and an item dismount carriage assembly including hood 6511, cradle 6509 and track 6507. Hood 6511 and cradle 6509 may travel along track 6507. Track 6507 may extend along a height of the carousel. Hood 6511 and cradle 6509 may be each have independent vertical motion along track 6507. Hood 6511 and cradle may travel along track 6507 from an item storage disc to a delivery port. The delivery port may be integral to a frame of item dispensing assembly 5901. The delivery port may guide an item to a receptacle accessible to a customer.

Cradle 6509 may be shaped to support an item dispensed from disc 6501 and removed from an item container. Disc 6501 may include guide feature 6503. Cradle 6509 may be shaped to support an item container. The item may be held in an item carrier. Hood 6511 may be shaped to surround the item and/or item carrier supported within cradle 6509.

The item dismount carriage assembly may include a controller. The controller may control movement of hood 6511 and cradle 6509 along the track. The controller may be configured to change a distance, along track 6507, between hood 6511 and cradle 6509. The controller may be configured to cause cradle 6509 to rotate to shed an item. The controller may be configured to control rotation of cradle 6509. Rotation of cradle 6509 may effectuate the removal of an item from within cradle 6509. The track may include power source 6513.

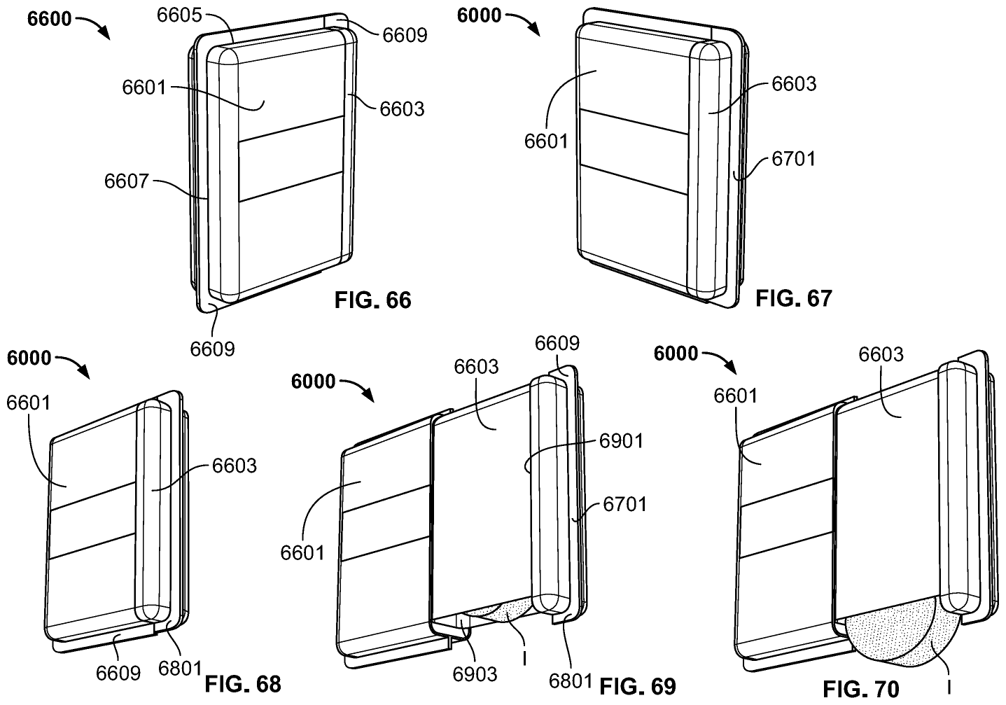

FIG. 66 shows an illustrative item carrier 6600. Item carrier 6600 may have features of any item carriers described herein. Item carrier 6600 may be positioned on the item storage disk of item dispensing assembly 5901. Item carrier 6600 may be positioned on the platform of the storage frame.

An item stored by item dispensing assembly 5901 may be stored inside item carrier 6600. Two or more items stored by item dispensing assembly 5901 may be stored inside item carrier 6600. Some or all of the items stored by item dispensing assembly 5901 may be stored in one, two, three, five, ten, twenty, thirty, forty, fifty, or any other suitable number of item carriers.

Item carrier 6600 may include cover 6601 defining a first opening. Cover 6601 may be the outer shell. Cover 6601 may have one or more features in common with the outer shell. Item carrier 6600 may include container 6603. Container 6603 may be the inner shell. Container 6603 may have one or more features in common with the inner shell. Container 6603 may define a second opening and slidable through the first opening in a first direction to envelop an item I and, in a second direction to release the item I through the second opening.

Cover 6601 may include the guide feature configured to follow the guide support face. The guide feature may include extension 6605, extension 6607 and extension 6609.

Container 6603 may include the guide feature configured to follow the guide support face. The guide feature may include extension 6609.

Container 6603 may be configured to release an item I in a state in which container 6603 is directly engaged with cover 6601. Container 6603 may be configured to release item I in a state in which container 6603 is not engaged with cover 6601.

The dimensions of item carrier 6600 may be optimized based on the item(s) to be stored within item carrier 6600.

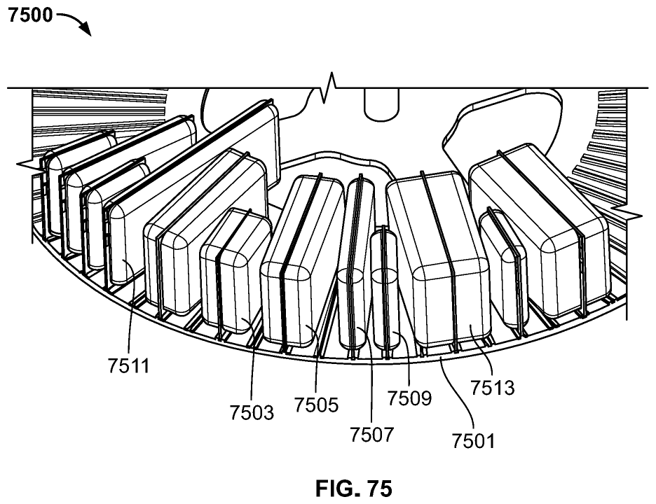

Item carrier 6600 may have a first set of dimensions. Larger item carriers may include dimensions that are a multiple of the first set of dimensions, such as twice as large as the first set of dimensions, three times as large, four times as large, or any other suitable multiple of the first set of dimensions. FIG. 75, below, illustrates exemplary different dimensions of item carrier 6600.

Each item carrier may include one or more feature to facilitate release and/or rejection of item(s) I stored within item carrier 6600. Exemplary features include physical features, container 6603 material, and active features such as a spring.

FIG. 67 shows a different view of item carrier 6000. Container 6603 may include extension 6701.

FIG. 68 shows another view of item carrier 6000. Container 6603 may include extension 6801.

FIG. 69 shows item carrier 6000 with container 6603 withdrawn from cover 6601 to reveal opening 6903 of container 6603 and item I positioned inside container 6603. Container 6603 may include flange 6901.

FIG. 70 shows item I being dispensed through opening 6903 of container 6603.

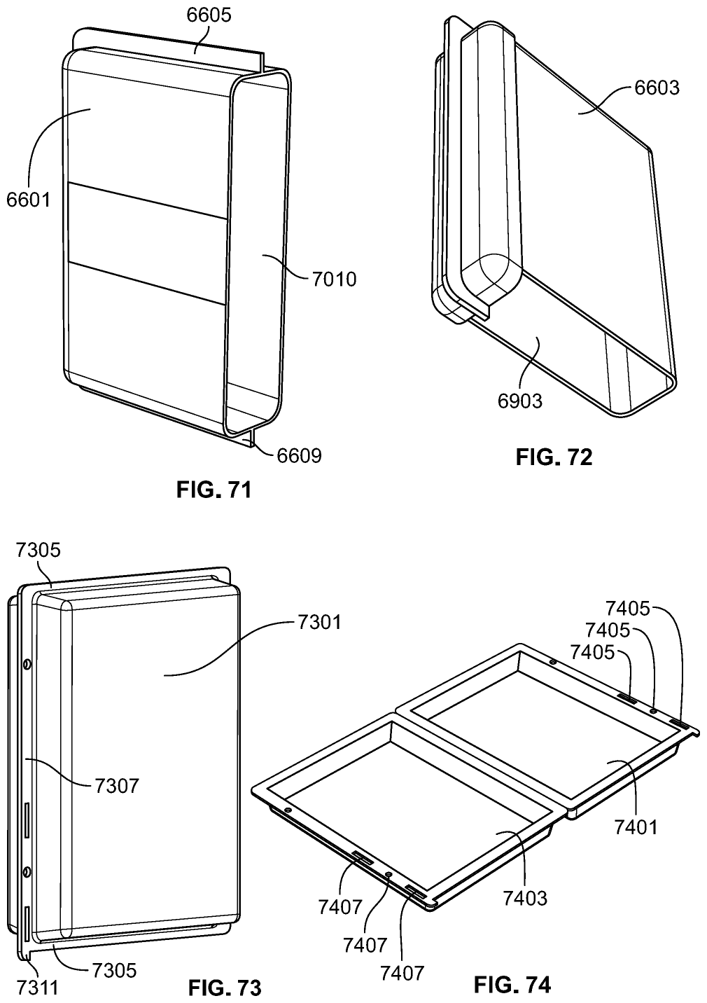

FIG. 71 shows cover 6601. Cover 6601 may include opening 7010. Container 6603 may be shaped to be positioned within opening 7010.

FIG. 72 shows container 6603.

FIG. 73 shows illustrative item carrier 7301 that may be positioned on an item storage disc. Item carrier 7301 may include extensions 7305, 7307 and 7305. Item carrier 7301 may additionally include flange 7311.

FIG. 74 shows item carrier 7301 opened. Item carrier, when opened, may define compartment 7401 and compartment 7403. Item carrier may additionally include recesses/protrusions 7407 and corresponding protrusions/recesses 7405.

FIG. 75 shows an illustrative disc 7501 with different sized item carriers positioned on item storage disc 7501. Exemplary item carriers positioned on disc 7501 include item carrier 7509, item carrier 7507 and item carrier 7511. Item carriers 7509, 7507 and 7511 have the same widths but different lengths. Additional exemplary item carriers positioned on disc 7501 include item carrier 7503 and item carrier 7505. Item carriers 7503 and 7505 have the same widths but different lengths. Another exemplary item carrier includes item carrier 7515, which has a width greater than the aforementioned item carriers.

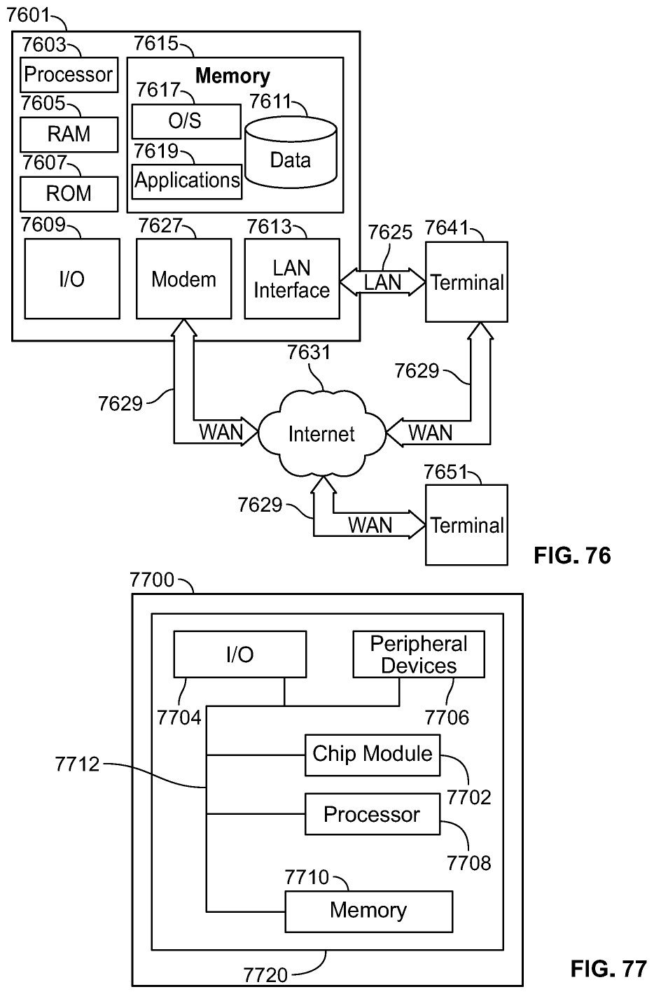

FIG. 76 is a block diagram that illustrates a computing server 7601 (alternatively referred to herein as a “server or computer”) that may be used in accordance with the principles of the invention. The computer server 7601 may have a processor 7603 for controlling overall operation of the server and its associated components, including RAM 7605, ROM 7607, input/output (“I/O”) module 7609, and memory 7615.

I/O module 7609 may include a microphone, keypad, touchscreen and/or stylus through which a user of server 7601 may provide input, and may also include one or more of a speaker for providing audio output and a video display device for providing textual, audiovisual and/or graphical output. Software may be stored within memory 7615 and/or other storage (not shown) to provide instructions to processor 7603 for enabling server 7601 to perform various functions. For example, memory 7615 may store software used by server 7601, such as an operating system 7617, application programs 7619, and an associated database 7611. Alternatively, some or all of computer executable instructions of server 7601 may be embodied in hardware or firmware (not shown).

Server 7601 may operate in a networked environment supporting connections to one or more remote computers, such as terminals 7641 and 7651. Terminals 7641 and 7651 may be personal computers or servers that include many or all of the elements described above relative to server 7601. The network connections depicted in FIG. 76 include a local area network (LAN) 7625 and a wide area network (WAN) 7629, but may also include other networks.

When used in a LAN networking environment, server 7601 is connected to LAN 7625 through a network interface or adapter 7613.

When used in a WAN networking environment, server 7601 may include a modem 7627 or other means for establishing communications over WAN 7629, such as Internet 7631. Internet 7631 may be included in network N (shown in FIG. 1).

It will be appreciated that the network connections shown are illustrative and other means of establishing a communications link between the computers may be used. The existence of any of various well-known protocols such as TCP/IP, Ethernet, FTP, HTTP and the like is presumed, and the system may be operated in a client-server configuration to permit a user to retrieve web pages from a web-based server. Any of various conventional web browsers may be used to display and manipulate data on web pages.

Additionally, application program 7619, which may be used by server 7601, may include computer executable instructions for inventory management, inventory mapping, item tracking, item ordering and data record merging applications.

Computing server 7601 and/or terminals 7641 or 7651 may also be mobile terminals including various other components, such as a battery, speaker, and antennas (not shown). Terminal 7651and/or terminal 7641 may be portable devices such as a laptop, tablet, smartphone or any other suitable device for receiving, storing, transmitting and/or displaying relevant information.

Any information described above in connection with database 7611, and any other suitable information, may be stored in memory 7615. One or more of applications 7619 may include one or more algorithms and/or perform any other suitable tasks.

The apparatus and methods may be operational with numerous other general purpose or special purpose computing system environments or configurations. Examples of well-known computing systems, environments, and/or configurations that may be suitable for use with the apparatus and methods include, but are not limited to, personal computers, server computers, hand-held or laptop devices, tablets, mobile phones and/or other personal digital assistants (“PDAs”), multiprocessor systems, microprocessor-based systems, set top boxes, programmable consumer electronics, network PCs, minicomputers, mainframe computers, distributed computing environments that include any of the above systems or devices, and the like.

The apparatus and methods may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

FIG. 77 shows an illustrative apparatus 7700 that may be configured in accordance with the principles of the invention.

Apparatus 7700 may be a computing machine. Apparatus 7700 may include one or more features of the apparatus that is shown in FIG. 76.

Apparatus 7700 may include chip module 7702, which may include one or more integrated circuits, and which may include logic configured to perform any other suitable logical operations.

Apparatus 7700 may include one or more of the following components: I/O circuitry 7704, which may include a transmitter device and a receiver device and may interface with fiber optic cable, coaxial cable, telephone lines, wireless devices, PHY layer hardware, an keypad/display control device or any other suitable encoded media or devices; peripheral devices 7706, which may include counter timers, real-time timers, power-on reset generators or any other suitable peripheral devices; logical processing device 7708, which may compute item data record elements, customer order information, inventory weight distribution, efficient shifting of mechanisms for desirable dispensing manners, and perform other methods described herein; and machine-readable memory 7710.

Machine-readable memory 7710 may be configured to store data records in machine-readable data structures.

Components 7702, 7704, 7706, 7708 and 7710 may be coupled together by a system bus or other interconnections 7712 and may be present on one or more circuit boards such as 7720. In some embodiments, the components may be integrated into a single chip.

The chip may be silicon-based.

When some or all of the apparatus shown in FIGS. 76 and 77 are present in remote data center 111, the features may perform different functions.

Table 13 lists illustrative remote data center functions.

TABLE 13
Illustrative remote data center functions.
Illustrative remote data center functions
Maintain database of health of vending assemblies
in plurality of vending assemblies
Maintain database of item inventory of vending
assemblies in plurality of vending assemblies
Maintain database of item data records for display
to user on website, kiosk
Receive order from user
Build order from carrier IDs based on association
of user order elements with corresponding carrier
ID's of carriers that are present on a user-selected
vending assembly
Transmit order instruction to vending assembly
Transmit order instruction having no item data
record elements to vending assembly
Transmit inventory information for restocking
Other suitable functions

When some or all of the features shown in FIGS. 76 and 77 are present in the vending assembly computing unit, the features may perform different categories of functions.

Table 14 lists illustrative computing unit function categories.

TABLE 14
Illustrative computing unit function categories.
Illustrative computing unit function categories
State- and variable-sensing
Environmental Management
Inventory Management
Computation
Communication
Other suitable categories

Table 15 lists illustrative state- and variable-sensing functions.

TABLE 15
Illustrative state- and variable-sensing functions.
Illustrative state- and variable-sensing functions
Detect carrier motion
Sense temperature
Sense humidity
Detect frosting
Detect angular position of storage frame
Illustrative state- and variable-sensing functions
Detect elevation of elevator
Detect horizontal position of gripper
Detect vertical position of platform
Detect airflow in central conduit
Sense current and voltage in motors
Detect open/closed state of door
Sense weight of item on platform
Detect presence of item at vend depot
Sense acceleration of storage frame
Sense acceleration of elevator
Read carrier data record
Other suitable sensing and detecting functions

Table 16 lists illustrative environmental management functions.

TABLE 16
Illustrative environmental management functions.
Illustrative environmental management functions
Control plenum fan speed
Control refrigerant pressure
Control heater power
Initiate storage frame rotation scheme for forced convection
Other suitable environmental management functions

Table 17 lists illustrative inventory management functions.

TABLE 17
Illustrative inventory management functions.
Illustrative environmental management functions
Scan storage frame for carrier IDs
Monitor through-beam sensors for carrier load
and dispense events
Other suitable inventory management functions

Table 18 lists illustrative computation functions.

TABLE 18
Illustrative computation functions.
Illustrative computation functions
Compute dispense pathway of storage frame
(rotation) and elevator (vertical translation)
Compute item date information
Comput item status
Compute temperature distribution variances
Compute period, speed, direction of rotation
of storage pathway for reducing temperature
distribution variances
Compute platform motions for receiving item
Other suitable computation functions

Table 19 lists illustrative communication functions.

TABLE 19
Illustrative communication functions.
Illustrative communication functions
With remote data center
Receive item data record element from remote data center
Transmit item inventory to remote data center
Receive instruction from remote data center to dispense item

### Within Vending Assembly

Provide instructions to robotic controllers (e.g., translate elevator, translate platform relative to elevator, translate gripper, actuate jaws, rotate storage frame)

Update item status display

### Other Suitable Communication Functions

All ranges and parameters disclosed herein are understood to encompass any and all subranges subsumed therein, and every number between the endpoints. For example, a stated range of “1 to 10” should be considered to include any and all subranges between (and inclusive of) the minimum value of 1 and the maximum value of 10; that is, all subranges beginning with a minimum value of 1 or more (e.g. 1 to 6.1), and ending with a maximum value of 10 or less (e.g. 2.3 to 9.4, 3 to 8, 4 to 7), and finally to each number 1, 2, 3, 4, 5, 6, 7, 8, 9, and 10 contained within the range.

Thus, apparatus and methods for dispensing an item have been provided. Persons skilled in the art will appreciate that the present invention can be practiced by other than the described examples, which are presented for purposes of illustration rather than of limitation. The present invention is limited only by the claims that follow.

1. An apparatus comprising:
an inner shell defining an inner orifice plane; and
an outer shell:
configured to receive the inner shell; and
defining an outer orifice plane;
wherein the inner shell is configured to be nested within the outer shell such that the inner orifice plane is substantially perpendicular to the outer orifice plane.

2. The apparatus of claim 1, the outer shell comprising an outer extension that protrudes from an exterior of the outer shell.

3. The apparatus of claim 2 wherein the outer extension protrudes from an exterior of three sides of the outer shell.

4. The apparatus of claim 2 wherein the outer extension is configured to mate with a platform channel.

5. The apparatus of claim 1 wherein the outer shell defines an outer channel.

6. The apparatus of claim 5 wherein the outer channel supports an outer extension.

7. The apparatus of claim 5 wherein, the outer channel is accessible from an interior of the outer shell.

8. The apparatus of claim 7, the outer shell comprising a guide segment that is configured to direct an inner extension protruding from the inner shell into the outer channel.

9. The apparatus of claim 8 wherein the guide segment comprises:
a mouth that is wider than the outer channel;
an exit that is the same width as the outer channel; and
a tapered section that transitions between the mouth and the exit.

10. The apparatus of claim 5 wherein the outer channel comprises:
a first length that extends along a first side of the outer shell; and
a second length that extends along a second side of the outer shell.

11. The apparatus of claim 10 wherein the first side is perpendicular to the second side.

12. The apparatus of claim 5 wherein the inner shell comprises an inner extension that protrudes from at least one side of the inner shell.

13. The apparatus of claim 12 wherein the inner extension is configured to mate with the outer channel.

14. The apparatus of claim 12 wherein the inner extension protrudes from at least two sides of the inner shell.

15. The apparatus of claim 1 wherein:
the outer shell comprises five walls; and
the inner shell comprises five walls.

16. The apparatus of claim 1 wherein the outer shell defines a length and a width and comprises an outer tapered section:
having a mouth equal to the width; and
extending along the length to an outer channel.

17. The apparatus of claim 16 wherein the mouth defines a mouth plane that is parallel to the outer orifice plane.

18. The apparatus of claim 16, the inner shell comprises an inner tapered section that is configured to mate with the outer tapered section when the inner shell is nested within the outer shell.

19. The apparatus of claim 1 wherein the outer shell comprises:
a first wall and a second wall that define a height of the outer shell; and
a third wall and a fourth wall that define a default width of the outer shell.

20. The apparatus of claim 19 wherein the first and second walls are each configured to flex and adjust the default width.

21.-317. (canceled)
